(19) United States
(12) Patent Application Publication
(10) Pub. No.: US 2008/0218671 A1
(43) Pub. Date: Sep. 11, 2008

(54) TRANSPARENT PROTECTIVE FILM, OPTICAL COMPENSATION FILM, POLARIZING PLATE, AND LIQUID CRYSTAL DISPLAY DEVICE

(75) Inventor: Kazuhiro NAKAMURA, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/042,496

(22) Filed: Mar. 5, 2008

(30) Foreign Application Priority Data
Mar. 8, 2007 (JP) 2007-059054

(51) Int. Cl. G02F 1/1335; B32B 7/02

(52) U.S. Cl. 349/117; 428/212

(57) ABSTRACT

To provides a transparent protective film, an optical compensation film, a polarizing plate, and a liquid crystal display device in which the variation of Rth in response to variations in humidity of the environment in which they are used is sufficiently small. The protective film in accordance with the present invention is a transparent protective film that satisfies the following Formulas (I) to (III) at a relative humidity of 60% RH; Formula (I): 0≦Re₍₆₃₀₎≦10; Formula (II): |Rth₍₆₃₀|≦20; and Formula (III): ΔRth/d×80,000≦20.

### BACKGROUND OF THE INVENTION

1. Field of the Invention

The present invention relates to a transparent protective film and an optical compensation film for a polarizing plate that excel in stability of optical properties against variations in humidity, and also to a polarizing plate and a liquid crystal display device using the same.

2. Description of the Related Art

Due to their strength, toughness, and fire resistance, cellulose acylate films have been used for support material for photography and a variety of optical materials. In particular, in recent years, such films have been widely used as optical transparent films for liquid crystal display devices.

For example, because cellulose acylate films have high optical transparency and optical isotropy, they are excellent as optical materials for devices handling light polarization, such as liquid crystal display devices, and such films have been used as protective films for polarizers and as support bodies for optical compensation films that can improve a display viewed from an inclined direction (viewing angle compensation).

In a polarizing plate that is a structural element of a liquid crystal display device, a protective film that protects a polarizer is formed by pasting on at least one side of the polarizer.

A typical polarizer is obtained by dyeing a stretched poly(vinyl alcohol) (PVA) film with iodine or a dichroic colorant.

Cellulose acylate films that can be directly pasted onto PVA have been widely used as the protective films, and among such films, triacetyl cellulose films have been often used. It is important that the protective film excel in optical isotropy, and optical properties of the protective film greatly affect the properties of the polarizing plate.

In recently developed liquid crystal display devices, there is a stronger demand for improved viewing angle characteristic, and transparent films such as the protective films or support bodies for optical compensation films need to have better optical isotropy.

For the film to be optically isotropic, the retardation value represented by a product of the optical film birefringence and thickness has to be small. In particular, in order to improve the display from the inclined direction, not only the retardation (Re) in the front surface direction, but also the retardation (Rth) in the film thickness direction has to be reduced. More specifically, when optical properties of a transparent film are evaluated, the Re measured from the front surface of the film has to be small and the Re should not change even when measured at different angles.

A cellulose acylate film with a reduced Re of the front surface has been developed, but a cellulose acylate film with a small variation in Re caused by the angle, that is, with a small Rth has been difficult to produce.

Accordingly, an optical transparent film with a small dependence of Re on the angle that is produced by using a polycarbonate film or a thermoplastic cycloolefin film instead of the cellulose acylate film has been suggested (see, for example, Japanese Patent Applications Laid-Open (JP-A) Nos. 2001-318233 and 2002-328233).

However, when such transparent films are used as protective films, because the films are hydrophobic they are difficult to bond to PVA. Yet another problem to be resolved is that the optical properties are not uniform over the entire plane of the film.

To resolve these problems, it is essential that a cellulose acylate film, which is perfectly suitable for bonding to PVA, be further improved by decreasing its optical anisotropy.

More specifically, an optical transparent film is needed that is optically isotropic and in which the front Re of the cellulose acylate film is substantially zero and the angular dependence of retardation is also small, that is, the Rth is also substantially zero.

Cellulose acylate in which an additive such that has a plurality of aromatic rings and sulfonamide groups is added to a cellulose acylate resin having a degree of acyl substitution of 2.50 to 3.00 has been disclosed as an effective means for resolving the above-described problems (see JP-A Nos. 2001-247717 and 2006-30937; Plastic Material Lecture, Vol. 17, Nikkan Kogyo Shimbun, Ltd.; “Cellulose Resin”, p. 121 (1970)).

A cellulose ester film has also been disclosed in which an oligomer such as an acrylate with a weight-average molecular weight of 500 or more to less than 10,000 is added to a cellulose ester selected from those in which an acyl group is selected from among an acetyl group, a propionyl group, and a butyryl group, this film having a degree of substitution of acyl groups of 2.50 to 2.98 (see JP-A No. 2003-12859).

The advantage of all these films is that they excel in optical anisotropy in the inclined direction because the thickness-direction retardation (Rth) can be greatly reduced with respect to that of the conventional cellulose ester film.

However, the problem associated with the above-described conventional technology is that the thickness-direction retardation (Rth) varies significantly in response to variations in ambient humidity. As a result, when the film is applied to a liquid crystal display device, the viewing angle characteristic such as color or contrast varies in response to variations in ambient humidity.

### BRIEF SUMMARY OF THE INVENTION

The present invention resolves the above-described problems inherent to the related art and attains the below-described object. Thus, it is an object of the present invention to provide a transparent protective film, an optical compensation film, and a polarizing plate in which the variation of Rth in response to variations in humidity of the environment in which the film is used is sufficiently small.

Yet another object is to provide a liquid crystal display device which has small optical anisotropy (Re, Rth) and is substantially optically isotropic and in which the variation of the viewing angle characteristic of color or contrast in response to variations in humidity of the environment in which the liquid crystal display device is used is sufficiently small.

The inventors have conducted a comprehensive study aimed at the resolution of the above-described problems and have gained the following knowledge. Thus, optical anisotropy can be sufficiently reduced, Re can be reduced to zero, Rth can be brought close to zero, and the variation of Rth in response to variations in ambient humidity can be greatly reduced with respect to that of the related art by using a compound that inhibits the alignment of cellulose acylate in the film in the in-plane direction and film thickness direction and a compound that inhibits the variation of thickness-direction retardation (Rth) in response to variations in ambient humidity.

The present invention is based on this knowledge gained by the inventors and uses the following means for resolving the above-described problems.

The protective film in accordance with the present invention satisfies the following Formulas (I) to (III) at a relative humidity of 60% RH:

0≦Re₍₆₃₀₎≦10 Formula (I)

|Rth₍₆₃₀|≦20 Formula (II)

ΔRth/d×80,000≦20 Formula (III).

where Re(λ) is a front retardation value (units: nm) at a wavelength λnm that is defined as Re(λ)=(nx−ny)×d; Rth(λ) is a thickness-direction retardation value (units: nm) at a wavelength λ nm that is defined as Rth(λ)={(nx+ny)/2−nz}×d; nx is a refractive index in a slow axis direction within a film plane; ny is a refractive index in a fast axis direction within the film plane; nz is a refractive index in the thickness direction of the film; d is the film thickness (units: nm); and ΔRth is a value obtained by subtracting Rth at a wavelength of 550 nm that is measured by controlling humidity for 24 h at a relative humidity of 80% from Rth at a wavelength of 550 nm that is measured by controlling humidity for 24 h at a relative humidity of 10%.

The polarizing plate in accordance with the present invention includes a polarizer; and at least one of a transparent protective film and an optical compensation film, the optical compensation film having a transparent support body and an optically anisotropic layer containing a disk-like compound subjected to hybrid alignment, the optical compensation film being laminated on at least one surface of the transparent support body, wherein the transparent protective film and transparent support body satisfy the Formulas (I) to (III) above at a relative humidity of 60% RH.

The liquid crystal display device in accordance with the present invention includes a liquid crystal cell; and a polarizing plate disposed on at least one surface of the liquid crystal cell, wherein the polarizer comprises at least one of a transparent protective film and an optical compensation film, the optical compensation film having a transparent support body and an optically anisotropic layer containing a disk-like compound subjected to hybrid alignment, the optical compensation film being laminated on at least one surface of the transparent support body, wherein the transparent protective film and transparent support body satisfy the Formulas (I) to (III) above at a relative humidity of 60% RH.

### DETAILED DESCRIPTION OF THE INVENTION

The transparent protective film, optical compensation film, polarizing plate, and liquid crystal display device of the present invention will be described below in greater detail.

In the description below, “45°”, “parallel”, and “perpendicular” mean a range of less than “precise angle ±5°”. The difference with the precise angle is preferably less than 4°, more preferably less than 3°. Concerning the angle, “+” means a clockwise direction, and “−” means a counterclockwise direction. Further, “slow axis” means a direction in which a refractive index assumes a maximum. “Visible light region” means a region from 380 nm to 780 nm. The measurement wavelength of refractive index is a value in a visible light region (λ=550 nm), unless specifically stated otherwise.

In the description below, “polarizing plate” is used in the meaning including both a long polarizing plate and a polarizing plate cut to a size to be incorporated in a liquid crystal device. The term “cut” as used herein includes both “punching” and “cutting”.

In the description below, “polarizing film” and “polarizing plate” are discriminated from each other, but “polarizing plate” is assumed to mean a laminate in which a transparent protective film that protects a polarizing film is provided on at least one surface of the “polarizing film.”

In the description below, “molecule symmetry axis” indicates a symmetry axis when a molecule has a rotational symmetry axis, but does not require the molecule to be rotationally symmetrical in the strict meaning thereof.

Generally, in disk-like liquid crystal compounds, a molecule symmetry axis matches an axis perpendicular to the disk surface that passes through the center of the disk surface, and in columnar liquid crystal compounds, the molecule symmetry axis matches the long axis of the molecule.

In the description below, Re(λ) denotes an in-plane retardation value at a wavelength λ, and Rth(λ) denotes a thickness-direction retardation value.

### (Transparent Protective Film and Optical Compensation Film)

The transparent protective film in accordance with the present invention is defined as a film having at least a transparent support body and essentially imparted with no optical compensation function.

On the other hand, the optical compensation film in accordance with the present invention is defined as a film using the transparent protective film in accordance with the present invention and essentially imparted with an optical compensation function (for example, a film that contains an additive demonstrating Re, Rth, or demonstrates Re, Rth upon stretching, or further laminated with an optically anisotropic layer). The optical compensation film in accordance with the present invention preferably also includes the function of the transparent protective film as a protective function of a polarizing plate.

### <Transparent Support Body>

The transparent support body constituting the transparent protective film and optical compensation film in accordance with the present invention contains at least a transparent resin material (referred to hereinbelow as “transparent resin”) and the below-described specific additive (compound A), and if necessary, may additionally contain a retardation control agent, a plasticizer, and the like.

The specific compound as referred to herein is a compound that is added to inhibit the alignment of cellulose acylate contained in the film in the in-plane and thickness directions and a compound A that inhibits the variation of thickness-direction retardation (Rth) in response to variations in ambient humidity.

The transparent support body constituting the transparent protective film and optical compensation film in accordance with the present invention preferably has a light transmittance of 80% or more.

### <<Transparent Resin>>

Cellulose acylates are suitable as transparent resins for forming the transparent support body. Optical anisotropy is obtained by stretching the transparent resin.

Examples of cellulose serving as a starting material for the cellulose acylate used in accordance with the present invention include raw cotton linter, kenaf, and wood pulp (broadleaf tree pulp, needle-leaved tree pulp), and cellulose acylate obtained from any starting material cellulose can be used. In some cases, a mixture thereof may be used.

In accordance with the present invention, cellulose acylate is produced by esterification from cellulose, but the aforementioned especially preferred kinds of cellulose cannot be used as they are, and the linter, kenaf, and pulp are subjected to purification.

As for detailed descriptions of these types of starting material cellulose, cellulose described, for example, in Plastic Material Lecture (17), Cellulose Resin (Marusawa, Uda, Nikkan Kogyo Shimbun, Ltd., published in 1970) and Kokai Giho No. 2001-1745 (p. 7-8) by Japan Institute of Invention and Innovation can be used, and the cellulose acylate film in accordance with the present invention is not particularly limited.

In accordance with the present invention, the cellulose acylate is a fatty acid ester of cellulose. Lower fatty acid esters of cellulose are especially preferred.

The lower fatty acid means a fatty acid with the number of carbon atoms of 6 or less. The number of carbon atoms is preferably 2 (cellulose acetate), 3 (cellulose propionate) or 4 (cellulose butyrate).

Cellulose acetate is preferred as cellulose acylate, and examples thereof include diacetyl cellulose and triacetyl cellulose.

Further, it is preferred that a mixed fatty acid ester such as cellulose acetate propionate or cellulose acetate butyrate be used, and cellulose acetate propionate is especially preferred.

From the standpoint of solubility, it is preferred that the degree of substitution of hydroxyl groups in cellulose in the cellulose acylate used in accordance with the present invention satisfy Formulas (1) and (2) below.

In Formulas (1) and (2), “SA” represents the degree of substitution of acetyl groups that substitute hydrogen atoms of hydroxyl groups of cellulose and “SB” represents the degree of substitution of acyl groups with 3 to 22 carbon atoms that substitute hydrogen atoms of hydroxyl groups of cellulose. It is especially preferred that the “SB” represent the degree of substitution of acyl groups 3 to 6 carbon atoms.

2.0≦SA+SB≦3.0 Formula (1)

0≦SA≦3.0 Formula (2)

Generally, the total degree of substitution is not uniformly distributed by 1/3 between hydroxyl groups in 2, 3, and 6 positions of cellulose acylate, and the degree of substitution of hydroxyl groups in the 6 position tends to be smaller.

In accordance with the present invention, it is preferred that the degree of substitution of hydroxyl groups in the 6 position of cellulose acylate be about the same as, or higher than that in the 2, 3 positions.

The degree of substitution of the hydroxyl groups in the 6 position with the acyl groups preferably constitutes 30% or more to 40% or less, more preferably 31% or more, even more preferably 32% or more of the total degree of substitution.

Further, the hydroxyl groups in the 6 position may be substituted not only with the acetyl groups, but also with a propionyl group, a butyroyl group, a valeroyl group, a benzoyl group, or an acryloyl group, which are acyl groups with 3 or more carbon atoms. Measurements of the degree of substitution in each position can be performed by NMR or the like.

Cellulose triacetate with a degree of substitution with acetyl groups of 2.0 to 3.0 or cellulose acetate propionate with a total degree of substitution with acyl groups of 2.0 to 2.7, a degree of substitution with acetyl groups of 1.0 to 2.0, and a degree of substitution with propionyl groups of 0.5 to 1.5 are preferred as the transparent resin for use in the transparent support body in accordance with the present invention.

The viscosity-average degree of polymerization (DP) of cellulose acylate is preferably 250 or more, more preferably 290 or more.

It is also preferred that the transparent support body have a small polydispersity index (Mw/Mn) as measured by gel permeation chromatography (GPC) and a narrow molecular weight distribution.

Here, Mw denotes a weight-average molecular weight, and Mn denotes a number average molecular weight.

The specific Mw/Mn value is preferably 1.0 to 5.0, more preferably 1.0 to 3.0, and even more preferably 1.0 to 1.7.

### <<Compound A>>

The transparent support body in accordance with the present invention contains compound A for reducing the variation of Re and Rth in response to variations in ambient humidity.

The compound A preferably has in a molecule at least a plurality of functional groups selected from hydroxyl groups, amino groups, thiol groups, and carboxyl groups, more preferably has a plurality of different functional groups in a molecule, and even more preferably has a hydroxyl group and a carboxyl group.

The compound A preferably contains one or two aromatic rings as a mother lo nucleus, and a value obtained by dividing the number of functional groups contained in a molecule by the molecular weight of the additive is preferably 0.01 or more.

These features supposedly act to bond the compound A (hydrogen bond) to a site where the cellulose acylate resin and water molecules interact (hydrogen bonds) and inhibit the variation of charge distribution caused by the desorption of water molecules.

Specific examples of compound A are given by the below-described compounds (A-1) to (A-17), but these examples are not limiting.

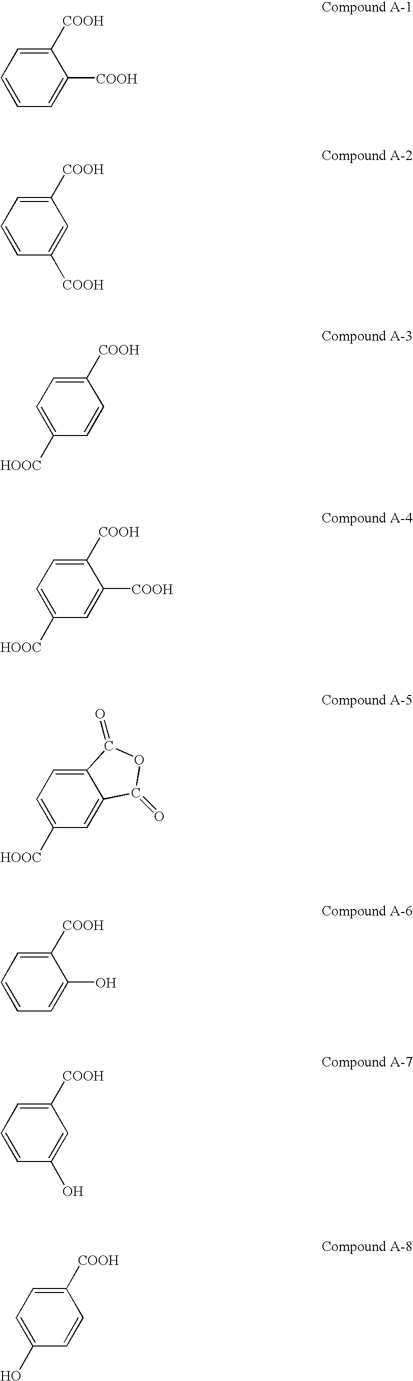

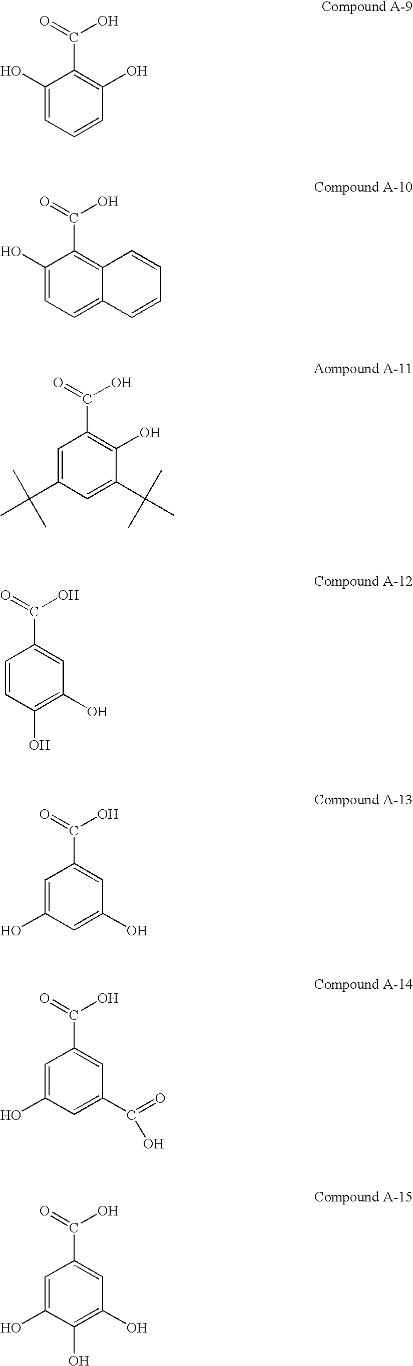

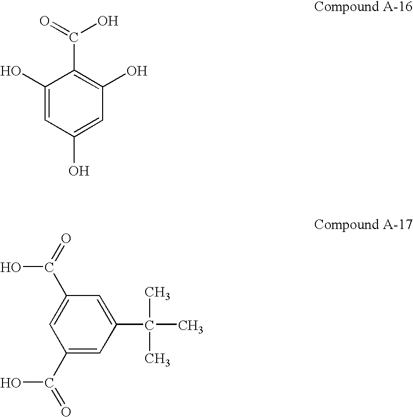

### [Compound A Having Two Aromatic Rings]

A process for manufacturing a transparent support body sometimes includes a step of heating for a long time (from several minutes to about 60 min) at a comparative high temperature (about 120° C. to 140° C.), and at this time, the process is contaminated if the additive is sublimated. It is accordingly preferred that in such cases the additive contain two aromatic rings to increase the molecular weight and improve volatility.

Further, the effect of reducing the variation of Re, Rth in response to variations in humidity is ensured when one aromatic ring contains one or less hydroxyl group, the other aromatic ring contains three or less carboxyl groups, and the total number of hydroxyl groups and carboxyl groups is 2 to 6.

Where two or more hydroxyl groups are contained in one aromatic ring and where the total number of hydroxyl groups and carboxyl groups serving as functional groups is 7 or more, visible light in a short-wavelength region is absorbed and the film is colored.

Where four or more carboxyl groups are contained in one aromatic ring, the opacity and optical properties of the film are changed when the film is subjected to saponification by immersion into an alkali solution in the process of pasting onto a polarizer.

The two aromatic rings are preferably joined by any of the structures represented by the following General Formulas (I) to (VII).

In the General Formulas (I) to (VII) below, R₁ to R₆ represent any of a hydrogen atom, an alkyl group excluding an aromatic ring, a hydroxyl group, an amino group, a thiol group, and a carboxyl group.

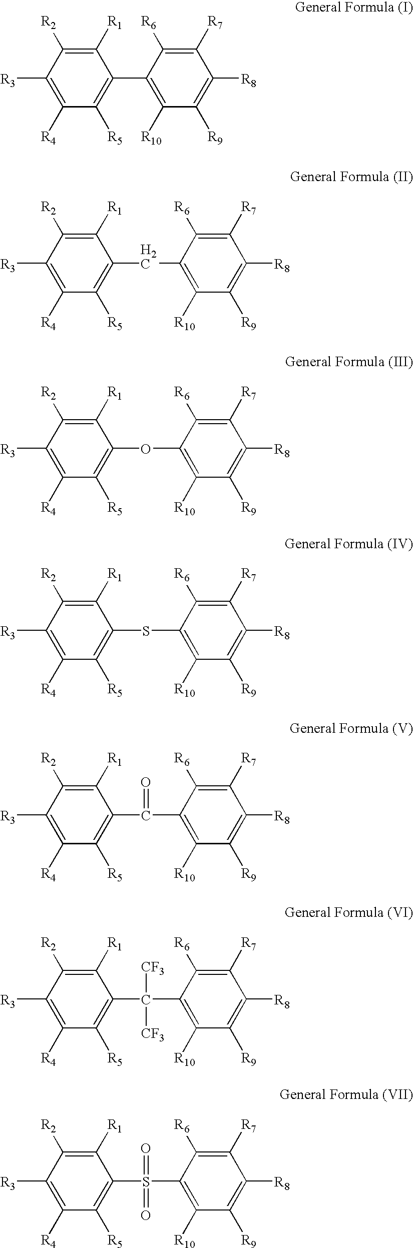

The molecular weight of the compound A is preferably 180 or more to 500 or less. Where the molecular weight is less than 180, volatility is insufficient, and where the molecular weight is 500 or more, its solubility in solvents and compatibility with the cellulose acylate resin are degraded.

Specific examples of compound A are given by the below-described compounds (A-18) to (A-42), but these examples are not limiting

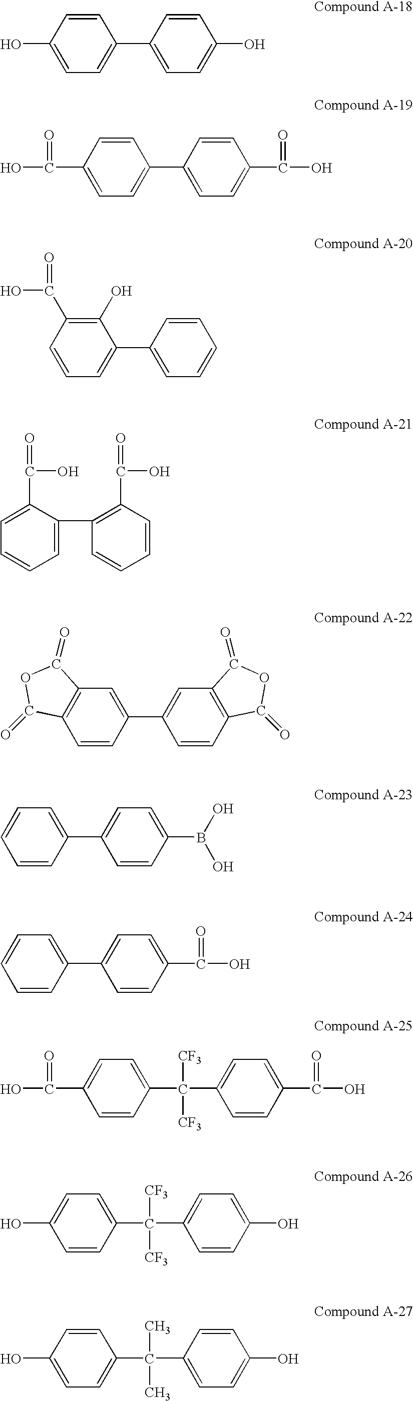

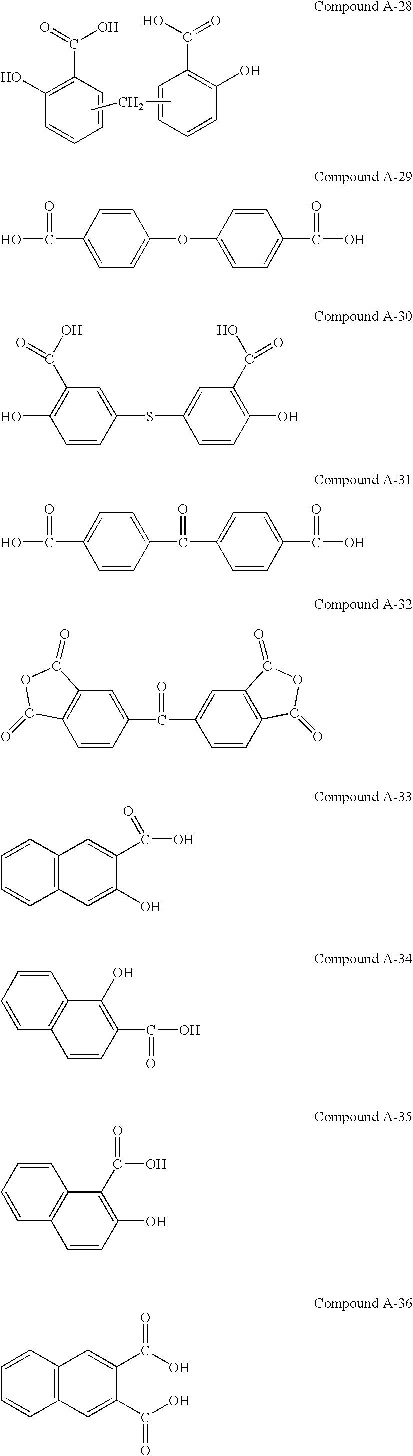

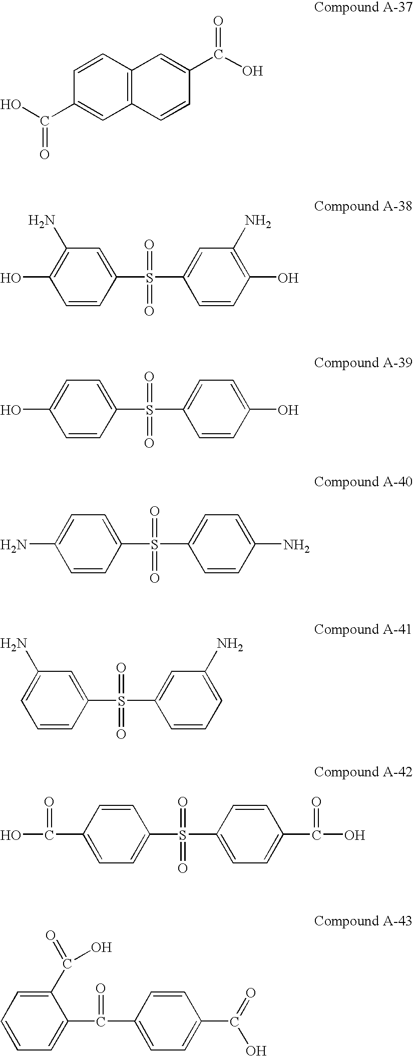

### <<Alignment Inhibiting Additive>>

It is preferred that the transparent support body constituting the optical compensation film in accordance with the present invention contain in addition to the compound A a compound B used for inhibiting the alignment of the transparent support body in the in-plane direction and film thickness direction. This compound B serves as an alignment inhibiting additive.

The compound B is preferably a compound (sometimes referred to hereinbelow as compound B) selected from at least any one of (1) a polymer obtained by polymerizing an ethylenically unsaturated monomer with a weight-average molecular weight of 500 or more to less than 10,000 and (2) a compound that reduces Re(λ) and Rth(λ) and has an octanol-water partition coefficient (value of Log P) of 0 to 7.

An acryl polymer described in JP-A No. 2006-30937 is preferably used as the additive of clause (1) above, and a compound having a sulfonamide or amide structure described in JP-A No. 2006-30937 is preferably used as the additive of clause (2) above.

The above-described compound A sometimes has a retardation control function, and in such cases, the amount of the two additives is preferably adjusted.

### <<Plasticizer>>

A conventional well-known plasticizer may be added to the transparent support body to improve mechanical properties of the film and increase the drying speed.

Examples of suitable plasticizers include phosphoric acid esters and carboxylic acid esters. For example, compounds described in Kokai Giho No. 01-1745 (p. 16) by Japan Institute of Invention and Innovation can be used.

Examples of carboxylic acids constituting the carboxylic acid esters include aliphatic carboxylic acids, hydroxycarboxylic acids (citric acid, malic acid, and the like), and aromatic carboxylic acids (phthalic acid and the like).

Compounds obtained by etherification of alkanol polyols and carboxylic acids that are described in JP-A Nos. 11-124445 and 2001-247717 are also preferred as other compounds to be applied as the plasticizers.

The amount of the plasticizer added is preferably 0.05 parts by mass to 25 parts by mass, more preferably 1 part by mass to 20 parts by mass per 100 parts by mass of cellulose acylate.

When the effect of the additive is reduced by combined use with the compound A, the adjustment is preferably made by reducing the amount of the plasticizer added. In many cases, the compound A functions as a plasticizer, and it is not always necessary to add a plasticizer in addition to the compound A.

### <<Fine Particles>>

In accordance with the present invention, fine particles are preferably added to the cellulose acylate composition (transparent support body) in order to maintain good curing inhibition ability, conveying ability, and scratch resistance of the film.

No particular limitation is placed on the fine particles to be added, provided that they are from a material demonstrating the above-described functions, and the Mohs hardness of the fine particles is preferably 2 to 10.

The fine particles may be those of inorganic compounds or organic compounds. The preferred examples of fine particles of inorganic compounds include silicon-containing compounds, silicon dioxide, titanium oxide, zinc oxide, aluminum oxide barium oxide, zirconium oxide, strontium oxide, antimony oxide, tin oxide, antimony tin oxide, calcium oxide, talc, clay, calcined kaolin, calcined calcium silicate, hydrated calcium silicate, aluminum silicate, magnesium silicate, and calcium phosphate. Among them, silicon-containing inorganic compounds and zirconium oxides are preferred, and silicon dioxide is even more preferred because it can reduce the turbidity of the transparent support body.

Employing inorganic fine particles that are subjected to surface treatment as fine particles of the inorganic compound that is added is preferred because of their good dispersivity in cellulose acylate.

A method described in JP-A No. 54-57562 can be employed for treating the surface of fine particles of the inorganic compounds. Further, for example, fine particles of inorganic compounds described in JP-A No. 2001-151936 can be used.

The preferred specific examples of fine particles of inorganic compounds include polymers such as crosslinked polystyrene, silicone resins, fluororesins, and acrylic resins. Among them, silicone resins are preferred, and among silicone resins, those having a three-dimensional network are even more preferred.

The average particle size of primary particles of the above-described fine particles (also referred to hereinbelow as “particle size”) is preferably 0.001 μm to 1 μm, more preferably 0.005 μm to 0.4 μm, and even more preferably 0.005 μm to 0.1 μm. Where the particle size is within these ranges, the haze can be reduced and surface roughness of the produced film can be reduced, without degrading the mechanical properties of the film.

The amount of fine particles added to cellulose acylate is preferably 0.01 parts by mass to 0.3 parts by mass, more preferably 0.05 parts by mass to 0.2 parts by mass per 100 parts by mass of cellulose acylate.

### <<Other Additives>>

In addition, a UV absorber, a deterioration preventing agent, a peeling agent, and an antistatic agent may be further added to the transparent support body in accordance with the present invention.

Examples of suitable UV absorbers include hydroxybenzophenone compounds, benzotriazole compounds, salicylic acid ester compounds, and cyanoacrylate compounds.

Examples of deterioration preventing agents include antioxidants, peroxide decomposition agents, radical inhibitors, metal deactivating agents, acid trapping agents, and photostabilizers such as hindered amines.

The materials described in the aforementioned Kokai Giho No. 01-1745 (p. 17-22) by Japan Institute of Invention and Innovation are preferably used as the UV absorbers, deterioration preventing agents, peeling agents, and antistatic agents.

### <Method for Manufacturing Transparent Support Body>

In the manufacture of the transparent support body in accordance with the present invention, a cellulose acylate film is preferably manufactured by a solvent casting method, and the film is manufactured by using a solution (dope) obtained by dissolving cellulose acylate in an organic solvent.

Well-known conventional organic solvents can be used in such manufacturing process. For example, those with a solubility parameter (SP value) within a range of from 17 to 22 are preferred.

The solubility parameter δ as used herein can be calculated by the following Formula (3)

δ=(E/V)^{1/2} Formula (3).

In Formula (3), E is a cohesion energy (mole evaporation energy) and V is a molecular volume.

The dissolution parameter is described, for example, in J. Brandrup, E. H et al. “Polymer Handbook (4th Edition), VII/671-VII/714”.

Examples of such organic solvents include chlorides of lower aliphatic hydrocarbons, lower aliphatic alcohols, ketones having 3 to 12 carbon atoms, esters having 3 to 12 carbon atoms, ethers having 3 to 12 carbon atoms, aliphatic hydrocarbons having 5 to 8 carbon atoms, and aromatic hydrocarbons having 6 to 12 carbon atoms.

The ethers, ketones, and esters may have a cyclic structure.

Compounds having two or more functional groups of ethers, ketones, and esters (that is, —O—, —CO—, and —COO—) can be also used as organic solvent.

The organic solvents may also have other functional groups such as alcoholic hydroxyl groups.

In the case of an organic solvent having functional groups of two or more kinds, the number of carbon atoms thereof may be within a stipulated range for the compounds having any functional groups.

Examples of specific compounds are described, for example, in Kokai Giho No. 01-1745 (p. 12-16) by Japan Institute of Invention and Innovation.

In particular, in accordance with the present invention, it is preferred that the solvent be a mixture of organic solvents of two or more kinds, and a mixed solvent containing solvents of three or more different kinds is especially preferred.

In such mixed solvents containing solvents of three or more different kinds, the first solvent is preferably selected from ketones having 3 to 4 carbon atoms, esters having 3 to 4 carbon atoms, and mixtures thereof, the second solvent is preferably selected from ketones having 5 to 7 carbon atoms or esters of acetoacetic acid, and the third solvent is preferably selected from alcohols with a boiling point of 30° C. to 170° C. or hydrocarbons with a boiling point of 30° C. to 170° C.

In particular, from the standpoint of cellulose acylate solubility, it is especially preferred that the solvents be used at the following mixing ratio: acetic acid esters 20 wt. % to 90 wt. %, ketones 5 wt. % to 60 wt. %, and alcohols 5 wt. % to 30 wt. %.

Halogen-free organic solvents that contain no halogenated hydrocarbons are especially preferred.

Technologically, halogenated hydrocarbons such as methylene chloride can be used without problems, but from the standpoint of global environment and working environment, it is preferred that the organic solvent contain substantially no halogenated hydrocarbon.

The expression “contain substantially no” as used herein means that the content ratio of a halogenated hydrocarbon in the organic solvent is less than 5 wt. % (preferably less than 2 wt. %). Further, it is preferred that absolutely no halogenated hydrocarbon such as methylene chloride be detected from the manufactured transparent support body.

Specific examples of organic solvents that can be used in accordance with the present invention include those described in Par. Nos. [0021] to [0025] of JP-A No. 2002-146043 and Par. Nos. [0016] to [0021] of JP-A No. 2002-146045.

In terms of improving the transparency of the film and accelerating the dissolution, it is preferred that, in addition to the organic solvent in accordance with the present invention, a fluoroalcohol or methylene chloride be contained in the dope used in accordance with the present invention at a ratio of 10 wt. % or less, more preferably 5 wt. % or less of the total amount of the organic solvent in accordance with the present invention.

Examples of suitable fluoroalcohols include compounds described in Par. No. [0020] of JP-A No. 08-143709 and Par. No. [0037] of JP-A No. 11-60807. These fluoroalcohols may be used individually or in combinations of two or more thereof.

When the cellulose acylate solution in accordance with the present invention is prepared, the vessel is preferably filled with an inactive gas such as nitrogen gas.

The viscosity of the cellulose acylate solution immediately before film formation may be any within a range enabling the flow casting in the film manufacturing process. Usually, it is preferred that the solution be prepared to have a viscosity within a range of 10 ps sec to 2,000 ps sec, more preferably 30 ps sec to 400 ps sec.

When the cellulose acylate solution (dope) in accordance with the present invention is prepared, no specific limitation is placed on the dissolution method, and a normal-temperature dissolution method may be used, or the dissolution may be performed under cooling or at a high temperature, or a combination of these methods may be used.

Examples of methods for preparing cellulose acylate solutions are described in JP-A Nos. 05-163301, 61-106628, 58-127737, 09-95544, 10-95854, 10-45950, 2000-53784, 11-322946, 11-322947, 02-276830, 2000-273239, 11-71463, 04-259511, 2000-273184, 11-323017, and 11-302388.

These methods for dissolving cellulose acylate in organic solvents can be applied appropriately within the scope of the present invention.

The dope solutions of cellulose acylate are usually subjected to solution concentration and filtration; these processes are likewise described in detail in Kokai Giho No. 01-1745 by Japan Institute of Invention and Innovation. When the dissolution is performed at a high temperature, it is almost always done at a temperature of equal to or higher than the boiling point of the organic solvent used, and in this state the solution in a pressurized state is used.

A method for manufacturing a transparent support body using the cellulose acylate solution in accordance with the present invention will be described below.

The conventional well-known methods for manufacturing a film by solution casting and apparatus for manufacturing a film by solution casting that are called a drum method and a band method employed for manufacturing transparent support bodies can be used as methods and equipment for manufacturing the transparent support body.

The film fabrication by the band method will be explained below by way of an example. The prepared dope (cellulose acylate solution) is supplied from a dissolution tank into a storage tank and held therein to remove bubbles contained in the dope.

It is important that foreign matter be removed from the prepared dope by accurate filtration. More specifically, it is preferred that the filter used for filtration have pores with a diameter as small as possible within a range in which components contained in the dope solution are not removed.

A filter with an absolute filtration accuracy of 0.1 μm to 100 μm can be used for the filtration, and it is preferred that a filter with an absolute filtration accuracy of 0.1 μm to 25 μm be used.

Here, the filter preferably has a thickness of 0.1 mm to 10 mm, more preferably 0.2 mm to 2 mm. In this case, the filtration is performed preferably under a filtration pressure of 1.47 MPa or less, more preferably 0.98 MPa or less, and even more preferably 0.20 MPa or less.

In order to perform accurate filtration, it is preferred that the filtration be performed several times, while successively reducing the pore size of the filter used.

The type of filtration material for performing the accurate filtration is not particularly limited, provided that it can demonstrate the above-described performance. Examples of suitable filtration materials include those of a filament type, a felt type, and a mesh type.

The type of filtration material for accurately filtering the dispersed matter is not particularly limited, provided that it can demonstrate the above-described performance and produces no adverse effect on the coating solution. Examples of suitable materials include stainless steel, polyethylene, polypropylene, and Nylon.

The prepared dope is pumped into a pressurization-type die via a pressurization-type metering gear pump that can pump liquids in amounts metered with high accuracy, for example, by the revolution speed, and the dope is uniformly lo cast from a slit of the pressurization-type die onto a metal support body of a cast portion that moves in an endless manner. In a peeling point in which the metal support body almost completes the cycle, the un-dried dope film (also called a web) is peeled off from the metal support body.

Both ends of the web obtained are clamped with clips, and the web is conveyed with a tenter, while the width thereof is being maintained, and dried. Then, the web is conveyed with a group of rolls of a drying apparatus to complete drying and coiled to a predetermined length with a coiling machine. The combination of the tenter and a drying apparatus having a group of rolls can be changed according to the object.

Each step of this process (classified into casting (including co-casting), metal support body, drying, peeling, stretching, and the like) is described in Kokai Giho No. 01-1745 (p. 25-30) by Japan Institute of Invention and Innovation.

In the flow casting process, one cellulose acylate solution may be cast as a monolayer, or two or more cellulose acylate solutions may be co-cast simultaneously and/or consecutively.

Further, in the flow casting process, the film is preferably subjected to uniaxial stretching in which the film is stretched in one direction such as flow casting direction (longitudinal direction) or biaxial stretching in which the film is stretched in the flow casting direction and another direction (lateral direction).

The surface of the metal support body used in the casting process preferably has an arithmetic average roughness (Ra) of 0.015 μm or less and a ten-point average roughness (Rz) of 0.05 μm or less. It is more preferred that the arithmetic average roughness (Ra) be 0.001 μm to 0.01 μm and the ten-point average roughness (Rz) be 0.001 μm to 0.02 μm. It is even more preferred that the (Ra)/(Rz) ratio be 0.15 or more.

By thus setting the surface roughness of the metal support body within the predetermined range it is possible to control the surface state of the manufactured cellulose acylate film within the below-described preferred range.

The cellulose acylate solution in accordance with the present invention may be cast simultaneously with other functional layers (for example, an adhesive layer, a dye layer, an antistatic layer, an antihalation layer, a UV absorption layer, and a polarizing layer).

### <Properties of the Transparent Support Body>

### <<Surface State>>

The surface of the transparent support body used in accordance with the present invention preferably has an arithmetic average roughness (Ra) of surface peaks and valleys (based on JIS B0601-1994) of the film of 0.0001 μm to 0.05 μm and a maximum height (Ry) of 0.0002 μm to 0.2 μm.

The shape of peaks and valleys on the film surface can be evaluated by atomic force microscopy (AFM).

By setting the surface state of the transparent support body in accordance with the present invention within the above-described range of sizes of peaks and valleys makes it possible to perform stable and uniform processing of the entire surface of the transparent support body when the surface of the transparent support body is coated, as described hereinbelow, to impart adhesivity, and also can eliminate optical defects caused by treatment unevenness or coating unevenness.

The dynamic friction coefficient of the transparent support body used in accordance with the present invention is preferably 0.4 or less, especially preferably 0.3 or less. Where the dynamic friction coefficient is high, there is a strong friction between the transparent support body and the conveying rolls. As a result, powdering can easily occur from the transparent support body, a large amount of foreign matter can adhere to the transparent support body, and the occurrence frequency of point defects or coating streaks of the optical compensation film exceeds the allowed limit.

The dynamic friction coefficient can be measured by a steel ball method using a steel ball with a diameter of 5 mm.

The surface resistivity of the transparent support body used in accordance with the present invention is preferably equal to or less than 1.2×10¹² Ω/□, more preferably equal to or less than 1.0×10¹² Ω/□, and especially preferably equal to or less than 0.8×10¹² Ω/□. By setting the surface resistivity within the range in accordance with the present invention makes it possible to inhibit the adhesion of foreign matter to the transparent support body or optical compensation film and reduce point defects and coating streaks of the optical compensation film.

### <<Mechanical Properties of Transparent Support Body>>

### [Tear Strength]

The tear strength of the transparent support body is preferably 3 g to 50 g at 30° C. and 85% RH (relative humidity).

### [Scratch Strength]

The scratch strength is preferably 1 g or more, more preferably 5 g or more, and even more preferably 10 g or more.

With the scratch strength within these ranges, scratch resistance and handling ability of the surface of the transparent support body can be maintained without any problem.

The scratch strength can be evaluated by using a sapphire needle with a cone apex angle of 90 degrees and a distal end radius of 0.25 m, scratching the surface of the transparent support body, and applying a load (g) that enables visual verification of the scratching trace.

### <<Hygroscopic Expansion Coefficient of Transparent Support Body>>

The hygroscopic expansion coefficient of the transparent support body for use in the optical compensation film in accordance with the present invention is preferably equal to or less than 30×10⁻⁵/% RH. The hygroscopic expansion coefficient is more preferably equal to or less than 15×10⁻⁵/% RH and even more preferably equal to or less than 10×10⁻⁵/% RH.

The lower is the hygroscopic expansion coefficient, the better, but usually it is equal to or more than 1.0×10⁻⁵/% RH. The hygroscopic expansion coefficient indicates the variation of sample length when the relative humidity changes at a constant temperature.

By adjusting the hygroscopic expansion coefficient, it is possible to increase the frame-shaped transmittance, that is, to prevent the light leak caused by distortions, while maintaining the optical compensation function of the optical compensation film.

A method for measuring the hygroscopic expansion coefficient in the present embodiment will be described below.

A sample with a width of 5 mm and a length of 20 mm is cut out from the prepared transparent support body, the end at one side is fixed, and the sample is suspended under an atmosphere with a temperature of 25° C. and a relative humidity of 20% RH (R₀). A weight of 0.5 g is suspended from the other end, and the length (L₀) is measured after 10 min. The humidity is then changed to 80% RH (R₁), at the same temperature of 25° C., and the length (L₁) is measured. The hygroscopic expansion coefficient is calculated by the following formula. The measurements are performed on 10 samples of the same material and the average value is taken.

Hygroscopic expansion coefficient [/% RH]={(L₁−L₀)/L₀}/(R₁−R₀).

In order to reduce the variation in size caused by moisture absorption by the prepared transparent support body, it is preferred that fine particles or a compound having a hydrophobic group be added. The appropriate materials selected from among the plasticizers or deterioration preventing agents having a hydrophobic group such as an aliphatic group or an aromatic group in a molecule are especially preferred as compounds having a hydrophobic group. The amount of these compounds to be added is preferably within a range of 0.01 wt. % to 10 wt. % based on the prepared solution (dope).

### <<Residual Amount of Solvent in Transparent Support Body>>

Reducing the residual amount of solvent in the transparent support body used in accordance with the present invention to 1.5% or less makes it possible to inhibit curling. It is even more preferred that the residual amount of solvent be 1.0% or less.

This is apparently because the decrease in free volume owing to the decrease in the residual amount of solvent during film formation by the above-described solvent casting method becomes a main factor in terms of the effect produced.

More specifically, the drying is preferably carried out under conditions such that the residual amount of solvent in the transparent support body becomes within a range of 0.01 wt. % to 1.5 wt. %, more preferably within a range of 0.01 wt. % to 1.0 wt. %.

In accordance with the present invention, the residual amount of solvent is a value represented by the following formula as a ratio of the volatile fraction to the solid fraction. In the formula below, W is the weight of the sample soft film and W₀ is the weight of the sample after drying the sample soft field with the weight W for 2 h at a temperature of 110° C.

Residual amount of solvent (wt. %)=((W−W₀)W₀)×100.

### <Moisture Permeability of Transparent Protective Film and Optical Compensation Film>

The moisture permeability of the transparent protective film and optical compensation film in accordance with the present invention is 100 g/m²·24 h to 2,000 g/m²·24 h under B conditions (temperature 40° C., humidity 90% RH) according to JIS standard JIS Z0208.

It is well known that where the moisture permeability is above 150 g/m²·24 h, the absolute value representing the dependence of the Re value and Rth value of the transparent support body on humidity strongly tends to surpass 0.5 nm/% RH, which is considered undesirable, but in the cellulose acylate film having the compound A in accordance with the present invention, the dependence of the Re value and Rth value on humidity can be reduced despite a high moisture permeability.

Methods described in “Physical Properties of Polymer II” (Polymer Experimental Lecture 4, Kyoritsu Shuppan Co., Ltd.), p. 285-294: Measurement of Vapor Transmittance (a mass method, a temperature measurement method, a vapor pressure method, an adsorption amount method) can be applied to measure the moisture permeability.

### <Moisture Content of Optical Compensation Film>

Because the moisture content of the transparent support body constituting the transparent protective film and optical compensation film in accordance with the present invention does not degrade the adhesion to water-soluble polymers such as poly(vinyl alcohol), the moisture content is preferably 0.3 g/m² to 12 g/m² at 30° C. and 85% RH, regardless of the film thickness. The moisture content of the cellulose acylate film containing the compound A in accordance with the present invention is higher that that for the film containing no such compound, but the results are different from the conventional knowledge in that the dependence on humidity is improved.

### <Optical Anisotropy of Transparent Support Body>

A specific feature of the transparent support body used in the optical compensation film in accordance with the present invention is that the transparent support body has practically no optical anisotropy. The retardation value Re (in-plane retardation value) and retardation value Rth (thickness-direction retardation) that represent the degree of optical anisotropy are defined by the following formulas.

Re=(nx−ny)×d.

Rth={(nx+ny)/2−nz}×d.

In the formulas, nx is a refractive index in the slow axis direction within the plane of the transparent support body; ny is a refractive index in the fast axis direction within the plane of the transparent support body; nz is a refractive index in the thickness direction of the transparent support body; d is the thickness of the transparent support body.

When the slow axis is taken as an inclined axis (axis of rotation) (when there is no slow axis, any direction in the plane of the film is taken as an axis of rotation), the retardation values are measured from any two inclined directions, and the Re value and Rth value are calculated based on the measured values, the assumed value of average refractive index, and the inputted film thickness value, then, calculations are performed by using the formulas presented above, but Re(λ) can be also measured by using KOBRA 21ADH or WR (manufactured by Oji Scientific Instruments Co., Ltd.) and causing the light with a wavelength λ nm to fall in the normal direction, this being another suitable calculation method.

When the film to be measured is represented by uniaxial or biaxial refractive index ellipsoid, Rth(λ) is calculated by the following method.

Thus, when Rth(λ) is found, Re(λ) is measured in a total of six points by causing the light with a wavelength λ nm to fall from each inclined direction in 10°-steps from the normal direction to that at 50° to the normal direction to the film in which the in-plane slow axis (determined by KOBRA 21ADH or WR) is taken as an inclined axis (axis of rotation) (when there is no slow axis, any direction in the plane of the film is taken as an axis of rotation), and KOBRA 21ADH or WR perform calculations based on the measured retardation value, the assumed value of average refractive index, and the inputted film thickness value.

In this process, in the case of a film in which an in-plane slow axis from the normal direction is taken as an axis of rotation and the direction in which the retardation value becomes zero is at a certain inclination angle, the retardation value at an inclination angle larger than this inclination angle changes the sign thereof to negative and is then compounded by the KOBRA 21ADH or WR.

When the film that is to be measured cannot be represented by a uniaxial or biaxial refractive index ellipsoid, that is, in the case of films without the so-called optic axis, the Rth(λ) is calculated by the following method.

Thus, when Rth(λ) is found, Re(λ) is measured in 11 points by causing the light with a wavelength λ nm to fall from each inclined direction in 10°-steps from −50° to +50° with respect to the normal direction to the film in which the in-plane slow axis (determined by KOBRA 21ADH or WR) is taken as an inclined axis (axis of rotation), and KOBRA 21ADH or WR perform calculations based on the measured retardation value, the assumed value of average refractive index, and the inputted film thickness value.

In the above-described measurements, catalogue values of various optical films in Polymer Handbook (JOHN WILEY AND SONS, INC.) can be used as the assumed value of average refractive index. When the value of average refractive index is not known, it can be measured with an Abbe refractometer. The values of average refractive index of main optical films are presented below: cellulose acylate (1.48), cycloolefin polymer (1.52), polycarbonate (1.59), poly(methyl methacrylate) (1.49), polystyrene (1.59). By inputting the assumed values of average refractive index and the film thickness, KOBRA 21ADH or WR calculates nx, ny, nz. Then, Nz=(nx−nz)/(nx−ny) is further calculated from the calculated nx, ny, nz.

In accordance with the present invention, the retardation value Re₍₆₃₀₎ at a wavelength of 630 nm of the transparent protective film is preferably 0 nm to 10 nm, more preferably 0 nm to 5 nm, as shown in Formulas (I) to (II) below.

The retardation value Rth₍₆₃₀₎ at a wavelength of 630 nm of the transparent protective film is preferably −20 nm to 20 nm.

By using the transparent protective film satisfying the above-described conditions as a transparent protective film for a polarizing plate, it is possible to reduce substantially the dependence of display properties on the viewing angle when the polarizing plate is applied to a liquid crystal display device.

The above-described properties can be realized by adding the compound B in a preferred combination to the above-described transparent protective film.

0≦Re₍₆₃₀₎≦10 Formula (I)

|Rth₍₆₃₀₎|≦20 Formula (II)

### <Dependence of Optical Properties of Transparent Protective Film and Optical Compensation Film on Humidity>

The transparent protective film and optical compensation film in accordance with the present invention feature small variation of optical properties thereof in response to variations in ambient humidity.

In particular, it is preferred that the thickness-direction retardation (Rth) satisfy Formula (III) below. In Formula (III), d is the film thickness (units: nm) and ΔRth is a value obtained by subtracting Rth₍₅₅₀₎ that is measured by controlling humidity for 24 h at a relative humidity of 80% from Rth₍₅₅₀₎ that is measured by controlling humidity for 24 h at a relative humidity of 10%.

ΔRth/d×80,000≦20 Formula (III).

Where the above-described conditions are satisfied, by using the transparent protective film or optical compensation film as the protective film for a polarizing plate, it is possible to reduce substantially the variation of display properties in response to variant in ambient humidity when the polarizing plate is applied to a liquid crystal display device.

Formulas (I) and (II) above are indicators that show how the variation of Rh of the film in response to variations in humidity can be reduced when the film thickness is fixed to 80 μm that is preferred for practical use, that is, how the film is suitable for processing a polarizing plate and handling.

Therefore, based on these indicators, it is even more preferred that the transparent protective film in accordance with the present invention satisfy the following Formula (IV)

ΔRth/d×80,000≦8 Formula (IV).

In order to realize the above-described properties, the above-described compound A is added in the preferred combination to the transparent protective film.

### <<Method for Evaluating Optical Anisotropy>>

The in-plane retardation Re and thickness-direction Rth of the transparent protective film in accordance with the present invention are measured by the following method.

A 30 mm×40 mm sample is set for 2 h at 25° C. and 60% RH to adjust the moisture content, and the Re(λ) is measured by causing the light with a wavelength λ nm to fall in the direction normal to the film in an automatic birefringence meter KOBRA 21ADH (manufactured by Oji Scientific Instruments Co., Ltd.).

Further, Rth(λ) is found by inputting the assumed value 1.48 of the average refractive index and the film thickness based on the retardation values measured in a total of three directions: the aforementioned Re(λ), the retardation value measured by causing the light with a wavelength λ nm to fall from the direction inclined at +40° to the direction normal to the film by taking the in-plane slow axis as an inclined axis, and the retardation value measured by causing the light with a wavelength λ nm to fall from the direction inclined at −40° to the direction normal to the film by taking the in-plane slow axis as an inclined axis.

<Method for Imparting Transparent Support Body with Adhesivity>

The display properties of a liquid crystal display device of a TN mode or an OCB mode can be also improved by further orienting, fixing, and forming an optical compensation layer composed of a liquid crystal substance on an alignment film in the transparent protective film of the optical compensation film in accordance with the present invention. In this case, when the alignment film is provided by a coating process, it is preferred that the surface of the transparent protective film be imparted with adhesivity and subjected to surface treatment that ensures uniform coating of the coating solution for the alignment film.

A method of providing an undercoat layer of the alignment film can be used as the surface treatment method.

A monolayer method of forming a single layer of an undercoat layer or a resin layer such as gelatin containing both hydrophobic groups and hydrophilic groups, this method being described, for example, in JP-A No. 07-333433, can be used for providing the undercoat layer of the alignment film.

The so-called double-layer method by which a layer (referred to hereinbelow as an undercoat first layer) that tightly adheres to a polymer film is provided as a first layer and then a hydrophilic resin layer (referred to hereinbelow as an undercoat second layer) such as gelatin that that tightly adheres to the alignment film is coated as the second layer can be also used. The double-layer method is described, for example, in JP-A No. 11-248940.

### <<Surface Treatment of Transparent Support Body>>

Because the transparent protective film in accordance with the present invention is a thin-layer film, it is preferred that the surface of the transparent protective film be directly subjected to hydrophilization treatment.

Examples of suitable surface treatments include a corona discharge treatment, a glow discharge treatment, a flame treatment, a UV irradiation treatment, an ozone treatment, an acid treatment, and an alkali saponification treatment. The alkali saponification treatment is preferred.

### [Alkali Saponification Treatment]

The alkali saponification treatment is performed by treating the transparent protective film with an alkali solution by dipping, spraying, or coating, and the saponification by coating is preferred.

### —Alkali Solution—

In accordance with the present invention, the alkali solution used for alkali saponification treatment preferably has pH of 11 or more, more preferably 12 to 14.

Examples of alkali agents for use in the alkali solution include sodium hydroxide, potassium hydroxide, and lithium hydroxide as inorganic alkali agents.

Examples of suitable organic alkali agents include diethanolamine, triethanolamine, DBU (1,8-diazobicyclo[5,4,0]-7-undecene), DBN (1,5-diazobicyclo[4,3,0]-5-nonene), tetramethylammonium hydroxide, tetraethylammonium hydroxide, tetrapropylammonium hydroxide, tetrabutylammonium hydroxide, and triethylbutylammonium hydroxide.

These alkali agents may be used individually or in combinations of two or more thereof, and may be added partially in the form of a salt such as obtained by halogenation.

Among these alkali agents, sodium hydroxide and potassium hydroxide are preferred because they enable the adjustment of pH within a wide pH range by regulating the amount thereof.

The concentration of the alkali solution is determined according to the type of the alkali agent used, reaction temperature, and reaction time, but the preferred content of the alkali agents in the alkali solution is 0.1 mol/Kg to 5 mol/Kg, more preferably 0.5 mol/Kg to 3 mol/Kg.

A solvent for the alkali solution in accordance with the present invention preferably contains a mixed solution of water and a water-soluble organic solvent.

Any organic solvent can be used provided that it is an organic solvent miscible with water. Organic solvents with a boiling point of 120° C. or less are preferred, and organic solvents with a boiling point of 100° C. or less are especially preferred.

Among them, the especially preferred organic solvents have an inorganic/organic value (I/O value) of 0.5 or more and a solubility parameter within a range of 16 mJ/m³ to 40 mJ/m³.

It is more preferred that the I/O value be 0.6 to 10 and the solubility parameter be 18 mJ/m³ to 31 mJ/m³.

Where the inorganic property is stronger than in this range of I/O value or where the solubility parameter is below the aforementioned range, the alkali saponification rate decreases and surface uniformity of the degree of saponification is insufficient.

On the other hand, where the organic property is stronger than in this range of I/O value or where the solubility parameter is above the aforementioned range, the saponification rate is high, but haze easily occurs and surface uniformity is likewise insufficient.

Further, where organic solvents, in particular organic solvents with the organic properties and solubility within the above-described ranges, are used in combination with the below-described surfactants or compatibility-improving agents, a high saponification rate is maintained and the uniformity of degree of saponification over the entire surface is improved.

Organic solvents demonstrating the preferred physical properties are described, for example, in “New Edition Solvent Pocketbook” edited by the Society of Synthetic Organic Chemistry, Japan (published by Ohm KK in 1994). The inorganic/organic values (I/O values) of organic solvents are described, for example, in Yoshio KODA “Organic Conceptual Diagram” (published by Sankyo Shuppan KK in 1983), p. 1 to 31.

Specific examples include monohydric aliphatic alcohols (methanol, ethanol, propanol, isopropanol, butanol, pentanol, and the like), dihydric aliphatic alcohols (ethylene glycol, propylene glycol, and the like), alicyclic alkanols (cyclohexanol, methylcyclohexanol, methoxycyclohexanol, cyclohexylmethanol, cyclohexylethanol, cyclohexylpropanol, and the like), phenylalkanols (benzyl alcohol, phenyl ethanol, phenyl propanol, phenoxyethanol, methoxybenzyl alcohol, benzyloxyethanol, and the like), heterocyclic alkanols (furfuryl alcohol, tetrahydrofurfuryl alcohol, and the like), monoethers of glycol compounds (methyl cellosolve, ethyl cellosolve, propyl cellosolve, butyl cellosolve, hexyl cellosolve, methyl carbitol, ethyl carbitol, propyl carbitol, butyl carbitol, methyltriglycol, ethoxytriglycol, propylene glycol monomethyl ether, propylene glycol monoethyl ether, propylene glycol monopropyl ether and the like), ketones (acetone, methyl ethyl ketone, methyl isobutyl ketone, and the like), amides (N,N-dimethylformamide, dimethylformamide, N-methyl-2-pyrrolidone, 1,3-dimethylimidazolidinone, and the like), sulfoxides (dimethylsulfoxide and the like), and ethers (tetrahydrofuran, pyran, dioxane, trioxane, dimethyl cellosolve, diethyl cellosolve, dipropyl cellosolve, methyl ethyl cellosolve, dimethyl carbitol, diethyl carbitol, methyl ethyl carbitol, and the like). The organic solvents may be used individually or in mixtures of two or more thereof.

When the organic solvents are used individually or in mixtures of two or more thereof, it is preferred that at least one organic solvent have high solubility in water. The solubility of the organic solvent in water is preferably 50 wt. % or more and it is even more preferred that the organic solvent freely mix with water. As a result, an alkali solution can be prepared that has a sufficient ability to dissolve the alkali agents, salts of fatty acids that are byproducts of saponification treatment, and salts of carbonic acid that are produced by absorption of carbon dioxide present in the air.

The ratio of the organic solvent in the solvent used is determined according to the type of the solvent, miscibility (solubility) with waster, reaction temperature, and reaction time.

The mixing ratio (mass ratio) of water and the organic solvent is preferably 3/97 to 85/15, more preferably 5/95 to 60/40, and even more preferably 15/85 to 40/60. With the mixing ratio within these ranges, the entire surface of the transparent protective film can be easily saponified uniformly without degrading the optical properties of the acylate film.

An organic solvent (for example, a fluoroalcohol) that differs from the organic solvents with the above-described preferred I/O value may be also used in combination with the below described dissolution enhancers such as surfactants and compatibility-improving agents, as the organic solvent contained in the alkali solution used in accordance with the present invention. The content ratio of such solvent is preferably 0.1% to 5% of the entire weight of the liquid used.

The alkali solution used in accordance with the present invention preferably contains a surfactant. By adding a surfactant, it is possible to decrease the surface tension, facilitate coating, improve the uniformity of the coated film and prevent the occurrence of cissing, and also prevent the haze that easily occurs when an organic solvent is present and further improve the uniformity of saponification reaction.

These effects are especially prominent when the below-described compatibility-improving agents are also present.

Surfactants that can be used are not particularly limited and may be anionic surfactants, cationic surfactants, amphoteric surfactants, nonionic surfactants, and fluorine-containing surfactants.

Specific examples include well-known compounds described, for example in Tokiyuki YOSHIDA “Surfactant Handbook” (new edition)” (published by Kogaku Tosho KK in 1987), “Function Creation, Material development, and Application Technique of Surfactant”, First Edition (published by Gijutsu Kyoiku Shuppan in 2000).

Among these surfactants, quaternary ammonium salts are preferred as cationic surfactants, various polyalkylene glycol derivatives and various polyethylene glycol oxide derivatives such as polyethylene glycol adducts are preferred as nonionic surfactants, and betaine-type compounds are preferred as amphoteric surfactants.

From the standpoint of increasing the effect of the invention, it is preferred that a nonionic surfactant and an anionic surfactant, or a nonionic surfactant and a cationic surfactant be also present in the alkali solution.

The amount of these surfactants that are added to the alkali solution is preferably 0.001 wt. % to 10 wt. %, more preferably 0.01 wt. % to 5 wt. %.

The alkali solution used in accordance with the present invention preferably also contains a compatibility-improving agent. In accordance with the present invention, “a compatibility-improving agent” is a hydrophilic compound that has a solubility in water of 50 g or more per 100 g of the compatibility-improving agent at a temperature of 25° C. The solubility of the compatibility-improving agent in water is preferably 80 g or more, even more preferably 100 g or more per 100 g of the compatibility-improving agent. Where the compatibility-improving agent is a liquid compound, the compound preferably has a boiling point of 100° C. or more, more preferably 120° C. or more.

The compatibility-improving agent acts to prevent the drying of the alkali solution that adhere to the wall surface, for example, of a tank storing the alkali solution, to inhibit sticking, and to hold the alkali solution with good stability. Further, this agent also acts to prevent a thin film of the coated alkali solution from drying within the interval after the alkali solution has been coated and held for a predetermined time on the surface of the transparent support body and also to prevent the precipitation of solids that makes it difficult to wash the solid matter out in the water washing process. The compatibility-improving agent also prevents phase separation of water and organic solvent that constitute the solvent.

By using the surfactant, organic solvent, and the above-described compatibility-improving agent together, it is possible to obtain a small haze and a uniform degree of saponification over the entire surface with good stability on the treated transparent support body even in the case where long-term continuous saponification is performed.

No specific limitation is placed on the compatibility-improving agents, provided that the above-described conditions are satisfied, and the preferred examples thereof include water-soluble polymers containing repeating units having a hydroxyl group and/or an amido group, such as polyol compounds and sugars.

The polyol compounds used can be low-molecular compounds, oligomers compounds, and high-molecular compounds. Specific examples of polyol compounds are presented below.

Examples of aliphatic polyols include alkanediols having 2 to 8 carbon atoms and alkanes having 3 to 18 carbon atoms and containing three or more hydroxyl groups.

Examples of alkanediols having 2 to 8 carbon atoms include ethylene glycol, propylene glycol, butanediol, pentanediol, hexanediol, glycerin monomethyl ether, glycerin monoethyl ether, cyclohexane diol, cyclohexane dimethanol, diethylene glycol, and dipropylene glycol.

Examples of alkanes having 3 to 18 carbon atoms and containing three or more hydroxyl groups include glycerin, trimethylolethane, trimethylolpropane, trimethylolbutane, hexanetriol, pentaerythritol, diglycerin, dipentaerythritol, and inositol.

Examples of polyalkyleneoxypolyols may be obtained by bonding together the above-described identical alkylenediols or different alkylenediols, but polyalkyleneoxypolyols obtained by bonding together the identical alkylenediols are preferred.

In any case, the number of bonds is preferably 3 to 100, more preferably 3 to 50. Specific examples include polyethylene glycol, polypropylene glycol, and poly(oxyethylene-oxypropylene).

Examples of sugars include water-soluble compounds described, for example, in “Natural Polymer”, Chapter 2 edited by the Society of Polymer Science, Polymer Experiment Editorial Board (published by Kyoritsu Shuppan KK in 1984) and Yoshihira ODA et al. “Modern Industrial Chemistry 22, Natural Products Industrial Chemistry II” (published by Asakura Shoten in 1967). Among them, sugars that have no free aldehyde groups or ketone groups and demonstrate no reducing ability are preferred.

Sugars are generally classified into monosaccharides such as glucose, sucrose, and trehalose having identical reducing groups bonded to each other, glucosides in which a reducing group of a sugar is bonded to a non-sugar, and sugar alcohols obtained by hydrogenation and reduction of sugars, and the compound of any of these groups can be advantageously used in accordance with the present invention.

Examples of suitable sugars include succarose, trehalose, alkyl glucosides, phenol glucoside, mustard oil glucoside, D, L-arabit, ribit, xylit, D, L-sorbit, D, L-mannit, D, L-idit, D, L-talit, dulicit, allodulicit, and reduced thick malt syrup.

These sugars can be used individually or in combinations of two or more thereof.

Examples of the water-soluble polymers containing hydroxyl groups and/or amido groups and having repeating units include natural gums (for example, gum arabic gum, gua gum, and gum tragacanth), poly(vinyl pyrrolidone), dihydroxypropyl acrylate polymer, and adducts of celluloses or chitosans and epoxy compounds (ethylene oxide or propylene oxide).

Among them, polyol compounds such as alkylene polyols, polyalkylene oxypolyols, and sugar alcohols are preferred.

The content of the compatibility-improving agent is preferably 0.5 wt. % to 25 wt. %, more preferably 1 wt. % to 20 wt. % based on the alkali solution.

The alkali solution used in accordance with the present invention may also contain other additives. Examples of well-known other additives include antifoaming agents, alkali solution stabilizers, pH buffers, preservatives, and bactericidal agents.

### —Alkali Saponification Method—

Surface treatment of the transparent support body that uses the above-described alkali solution may be performed by any well-known conventional method. The preferred methods include dipping into the alkali solution and coating of the alkali solution. The coating method is especially preferred when only one surface of the transparent support body is to be saponified uniformly without unevenness.

Well-known conventional coating methods can be employed for coating. For example, a die coater (an extrusion coater, a slide coater, a slit coater), a roll coater (a direct rotation roll coater, a reverse rotation roll coater, a gravure coater), a rod coater, and a blade coater can be used advantageously.

The saponification treatment is preferably carried out at a treatment temperature within a range that does not exceed 120° C. so as to cause no deformation of the transparent support body that is being treated or modification of the treatment solution.

The treatment temperature is preferably within a range of from 10° C. to 100° C., more preferably from 20° C. to about 80° C.

The saponification time is appropriately regulated and determined based on the alkali solution type and treatment temperature, but the preferred saponification time is within a range of from 1 sec to 60 sec.

The alkali saponification treatment is preferably implemented by a process including a step of saponifying the transparent support body with the alkali solution at the surface temperature thereof of at least equal to 10° C. or higher, a step of maintaining the temperature of the transparent support body at least at 10° C. or higher, and a step of washing the alkali solution from the transparent support body.

The treatment of saponifying the surface of the transparent support body with the alkali solution at the predetermined temperature can be carried out by regulating the temperature of the transparent support body surface to the predetermined temperature in advance, that is, prior to coating, by regulating the temperature of the alkali solution to the predetermined temperature, or by a combination of these steps. Among them, a combination with a step in which the temperature of the transparent support body surface is regulated to the predetermined temperature in advance, that is, prior to coating, is preferred.

In order to inhibit deterioration of the alkali solution by carbon dioxide and extend the service life of the solution in the reaction process of the saponification treatment, it is preferred that the treatment step be performed by introducing an inactive gas (nitrogen gas, argon gas, and the like) in a semi-sealed or sealed structure.

Upon completion of the saponification reaction, the alkali solution and the reaction products of the saponification treatment are preferably washed out and removed from the surface of the transparent support body by washing with water, neutralizing, and washing with waster.

The contact angle of the transparent support body with water after the surface treatment is preferably 20° C. to 55° C., more preferably 25° C. to 45° C.

Further, the surface energy is preferably 55 mN/m or more, more preferably 55 mN/m to 75 mN/m.

The surface energy of the transparent support body can be determined by a contact angle method, a swelling heat method, and an adsorption method, as described in “Basic and Application of Wetting” (published by Realize Inc. on Dec. 10, 1989). Among these methods, the contact angle method is preferred.

The contact angle method is a method by which two solutions with known surface energy are dropped on the transparent support body, of the angles formed by the tangent line drawn to a liquid droplet and the surface of the transparent support body in the intersection point of the surface of the liquid droplet and the surface of the transparent support body, the angle including the liquid droplet is defined as a contact angle, and the surface energy of the transparent support body is found by calculations.

### <Alignment Film>

The alignment film in accordance with the present invention is preferably an alignment film formed by coating a coating liquid of an organic compound (preferably, a polymer). From the standpoint of the strength of the alignment film itself and adhesion thereof to an optical anisotropic layer serving as an underlayer or an overlayer, a cured polymer film is preferred. The alignment film is provided to regulate the alignment direction of molecules of a liquid crystal compound provided thereon. The well-known conventional methods such as rubbing, application of a magnetic field or an electric field, and light irradiation can be used as the methods for regulating the alignment.

The alignment film employed in accordance with the present invention can be adapted to the type of the display mode of the liquid crystal cell.

In the display mode in which a large number of rod-like liquid crystal molecules located inside a liquid crystal cell are oriented substantially vertically, such an OCB mode and a HAN mode, the alignment film has a function of aligning the liquid crystal molecules of the optically anisotropic layer substantially horizontally.

On the other hand, in the display mode in which a large number of rod-like liquid crystal molecules located inside a liquid crystal cell are oriented substantially horizontally, such as STN mode, the alignment film has a function of aligning the liquid crystal molecules of the optically anisotropic layer substantially vertically.

Further, in the display mode in which a large number of rod-like liquid crystal molecules located inside a liquid crystal cell are oriented substantially obliquely, such an TN mode, the alignment film has a function of aligning the liquid crystal molecules of the optically anisotropic layer substantially obliquely.

Specific types of polymers that can be used for the alignment film in accordance with the present invention are described in publications relating to optical compensation films using discotic liquid crystal molecules corresponding to a variety of the above-described display modes.

The polymer for use in the alignment film can be a self-crosslinkable copolymer or a copolymer that is crosslinked with a crosslinking agent. Further, a plurality of combinations of such polymers can be also used.

Examples of such polymers include compounds described, for example in Par. No. [0022] of JP-A No. 08-338913. Among them, water soluble polymers (for example, poly(N-methylolacrylamide), carboxymethyl cellulose, gelatin, poly(vinyl alcohol), and modified poly(vinyl alcohol)) are preferred. Among them, gelatin, poly(vinyl alcohol), and modified poly(vinyl alcohol) are more preferred, and poly(vinyl alcohol) and modified poly(vinyl alcohol) are especially preferred.

The degree of saponification of poly(vinyl alcohol) is preferably 70 mol % to 100 mol %, more preferably 80 mol % to 100 mol %, and especially preferably 85 mol % to 95 mol %. The degree of polymerization of poly(vinyl alcohol) is preferably 100 to 3,000.

The modification group of the modified poly(vinyl alcohol) can be introduced by copolymerization modification, chain transfer modification, or block polymerization modification.

Examples of the modification groups include hydrophilic groups (carboxylic acid group, sulfonic acid group, phosphonic acid group, amino group, ammonium group, amido group, thiol group, and the like), hydrocarbon groups having 10 to 100 carbon atoms, hydrocarbon groups substituted with a fluorine atom, thioether groups, polymerizable groups (unsaturated polymerizable groups, epoxy group, aziridinyl group, and the like) and alkoxysilyl groups (trialkoxy, dialkoxy, and monoalkoxy).

Specific examples of these modified poly(vinyl alcohol) compounds include those described in Par. No. [0074] of JP-A No. 2000-56310, Par. Nos. [0022] to [0145] of JP-A No. 2000-155216, and Par. Nos. [0018] to [0022] of JP-A No. 2002-62426.

Examples of crosslinking agents of the polymers (preferably water-soluble polymers, and more preferably poly(vinyl alcohol) or modified poly(vinyl alcohol)) for use in the alignment film include aldehydes, N-methylol compounds, dioxane derivatives, compounds acting by activating a carboxyl group, active vinyl compounds, active halogen compounds, isoxazole, and dialdehyde starch. Crosslinking agents of two or more kinds may be used together. Specific examples include compounds described, for example, in Par. Nos. [0023] to [0024] of JP-A No. 2002-62426. Among them, aldehydes with high reaction activity, in particular glutaraldehyde are preferred.

The amount of crosslinking agent to be added is preferably 0.1 wt. % to 20 wt. %, more preferably 0.5 wt. % to 15 wt. % based on the polymer.

The amount of unreacted crosslinking agent remaining in the alignment film is preferably 1.0 wt. % or less, more preferably 0.5 wt. % or less. Where the crosslinking agent remains in the alignment film in an amount above 1.0 wt. %, sufficient durability cannot be obtained. Where such alignment film is used in a liquid crystal display device, reticulation sometimes occur when the device is used for a long time or allowed to stay for a long time in an atmosphere with a high temperature and high humidity.

The alignment film is basically a cured film that can be formed by coating a transparent support body with a coating liquid containing the polymer that is a composition for forming an alignment film, the crosslinking agent, and a specific carboxylic acid, drying by heating (crosslinking) and then carrying out the alignment treatment.

As described above, the crosslinking reaction may be carried out in any interval after coating on the transparent support body. When a water-soluble polymer such as poly(vinyl alcohol) is used as a composition for forming an alignment film, the coating liquid preferably has a mixed solvent containing an organic solvent (for example, methanol) demonstrating antifoaming action and water. The proportions of components in the mixed solvent is preferably such that water:methanol=0:100 to 99:1, more preferably 0:100 to 91:9 on a mass basis. As a result, the appearance of bubbles is inhibited and the number of defects in the alignment film and then in the surface of the optical anisotropic layer is greatly reduced.

The alignment film is preferably formed by a spin coating method, a dip coating method, a curtain coating method, a die coating method (extrusion coating method, slide coating method, slit coating method, or the like) a rod coating method, or a roll coating method. The rod coating method and die coating method are especially preferred.

The film thickness after drying is preferably 0.1 μm to 10 μm, and drying can be carried out under heating at a temperature of 20° C. to 110° C. In order to attain sufficient crosslinking, it is preferred that the drying temperature be 60° C. to 100° C., more preferably 80° C. to 100° C. The drying can be carried out for 1 min to 36 h, preferably 1 min to 30 min.

When a coating liquid for an optically anisotropic layer is coated after the coating liquid composition containing the composition for forming the alignment film in accordance with the present invention is coated on the transparent support body, dried, and oriented with an alignment means, it is preferred that the surface of the alignment film be maintained within a range of pH 2.0 to pH 6.9, more preferably within a range of pH 2.5 to pH 5.0.

When the coating liquid for an optically anisotropic layer is coated, the coating is preferably carried out so that the variation range ΔpH of pH of the alignment film surface in the width direction of the coated film is within a range of ±0.30. It is even more preferred that the coating be carried out to obtain the ΔpH within a range of ±0.15.

The pH value of the alignment film surface is measured by allowing a sample coated with the alignment film to stay for 1 day under stationary conditions in an environment with a temperature of 25° C. and a humidity of 65% RH, then pouring 10 mL of pure water under a nitrogen atmosphere, and rapidly reading the pH value with a pH meter.

Coating with the aforementioned rod coating method makes it possible to specify the pH value of the surface of the alignment film in accordance with the present invention and to control the ΔpH in the film width direction. Another effective means is to regulate appropriately the drying temperature of the alignment film surface and the flow rate and flow direction when a drying flow is employed.

### <Rubbing Treatment>

The rubbing treatment is preformed by rubbing the alignment film surface several times in a predetermined direction with paper or cloth. In this case, a cloth in which fibers of uniform length and thickness are uniformly napped is preferably used.

In accordance with the present invention, the rubbing treatment is performed by pasting the cloth onto a roll, disposing the roll at any angle to the conveying direction of the transparent support body provided with the alignment film, bringing the distal ends of the fibers of the napped cloth into contact with the alignment film, and rotating the roll at a speed of 100 rpm to 100,000 rpm, while feeding the transparent support body at a ratio of 1 m/min to 100 m/min.

The angle between the roll and the conveying direction (longitudinal direction) of the transparent support body can be adjusted to any value. The angle within a range of 45° to 90° is preferred. It is even more preferred that the adjusted angle be controlled within a range of ±5°.

In the rubbing treatment of the alignment film in accordance with the present invention, the temperature and humidity are preferably controlled to constant values to perform the rubbing in a uniform and stable alignment state. More specifically, it is preferred that the temperature be controlled to 20° C. to 28° C., the humidity be controlled to 35% RH or more to less than 60% RH. In particular, in the preferred rubbing mode, the humidity is within a range of 35% RH to 50% RH.

When the alignment film surface is rubbed with a rubbing cloth, electrostatic charges appear due to friction between the rubbing cloth and the alignment film and the generated electrostatic charged charge the alignment film surfaces, thereby causing the adhesion of the floating dust contained in the air to the alignment film surface. Where dust adheres to the alignment film surface, the alignment state of liquid crystal created by the alignment film becomes uneven or viewing ability is worsened, for example, by spot-like optical defects.

The preferred measures against electrostatic charges include removing electrostatic charges with an antistatic device employing irradiation with soft X rays or an ion bar that generates ions of a polarity opposite that of the electrostatic charges on the alignment film or by removing a fine powder generated by rubbing or dust that adhered to the film by an ultrasonic dust removal device, the two processes being carried out before or after the alignment film has been rubbed. These methods are described, for example, in JP-A Nos. 07-333613 and 11-305233.

Further, when a long roll is continuously treated, it is preferred that the surface potential be detected to determine whether the charge potential of the rubbing cloth exceeds |1| KV, and that the electricity be removed from the rubbing cloth to prevent the amount of charge from exceeding this value. The charge potential of the rubbing cloth is preferably equal to or less than |0.5| KV, more preferably 0 KV to |0.2| KV. The sign of the electric charges is determined by the combination of the alignment film and rubbing material.

As a wet method, it is also possible to apply a wet-type dust removal method (dust removal after rubbing) described in JP-A No. 2001-38306 by which the running web subjected to rubbing is wiped with an elastic body wetted with a liquid, preferably with a solvent that causes no swelling of the alignment film, such as fluorinate, hexane, and toluene, and then the surface that has been continuously wiped with the elastic body is sprayed with a liquid, preferably the solvent that has been heretofore used.

With the above-described methods, the distortion of alignment and optical defects caused by adhesion of foreign matter or the like can be reduced or eliminated.

### <Optically Anisotropic Layer>

An optical compensation film that has an optically anisotropic layer is preferably used to cancel birefringence of a liquid crystal cell composed of nematic liquid crystals that demonstrate bend alignment or hybrid alignment. The configuration and principles of the optically anisotropic layer are described in detail in Japanese Patent (JP-B) No. 3118197.

For the birefringence occurring in a liquid crystal cell to be cancelled by the optical compensation film having an optically anisotropic layer, it is preferred that the rubbing direction of the nematic liquid crystals in the liquid crystal cell be parallel to the direction obtained by directly projecting the direction in which the retardation of the optically anisotropic layer of the optical compensation film assumes a minimum value onto the sheet surface.

Rod-shaped liquid crystal compounds and disk-like liquid crystal compound (also called discotic liquid crystal compounds) can be used as the liquid crystal compounds employed in the optically anisotropic layer.

Azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles are preferably used as the rod-shaped liquid crystal compounds.

These low-molecular liquid crystal compounds preferably have polymerizable groups in a molecule (for example, those described in Par. No. [0016] of JP-A No. 2000-304932).

Not only the above-described low-molecular liquid crystal compounds, but also high-molecular liquid crystal compounds can be used.

High-molecular liquid crystal compounds are polymers having a side chain equivalent to the above-described low-molecular liquid crystal compound. The optical compensation film using a high-molecular liquid crystal compound is described in JP-A No. 05-53016.

A discotic liquid crystal compound is preferred as the liquid crystal compound. Further, it is preferred that the inclination of the plane of a disk-like structural unit of the discotic liquid crystal compound with respect to the surface of the transparent support body, and also an angle formed by the plane of a disk-like structural unit and the surface of the transparent support body vary in the depth direction of the optically anisotropic layer.

Such optically anisotropic layer can be formed by fixing the alignment of liquid crystal molecules by providing an alignment film on the transparent support body, laminating a layer composed of a liquid crystal compound on the alignment film, and then, for example, polymerizing the discotic liquid crystal compound.

Examples of the discotic liquid crystal compounds are described in various publications (for example, C. Destrade et al., Mol. Cryst. Liq. Cryst., Vol. 71, page 111 (1981); Quarterly Chemical Reviews No. 22, Chemistry of Liquid Crystal, Chapter 5, Chapter 10, Sec. 2 (1994) edited by the Chemical Society of Japan; B. Kohne et al., Angew. Chem. Soc. Chem. Comm., page 1794 (1985); and J. Zhang et al., J. Am. Chem. Soc, Vol. 116, page 2655 (1994)). The polymerization of discotic liquid crystals is described in JP-A No. 08-27284.

A polymerizable group has to be bonded as a substituent to the disk-like core of a disk-like structural unit of the discotic liquid crystal compound to fix the discotic liquid crystal compound by polymerization. A discotic liquid crystal compound in which a disk-like structural unit and a polymerizable group are bonded via a linking group is preferred, because the alignment state can be maintained even during the polymerization reaction.

The polymerizable group is preferably selected from radical polymerizable groups and cation polymerizable groups, and an ethylenic unsaturated lo polymerizable group (acryloyloxy group, methacryloyloxy group, and the like) and an epoxy group are most preferred. Such compounds are described for example in Par. Nos. [0151] to [0168] of JP-A No. 2000-155216.

In order to ensure optical compensation of liquid crystal cells with a twist alignment of rod-like liquid crystal molecules, such as in an STN mode, it is preferred that the discotic liquid crystal molecules be also twist oriented. Where an asymmetric carbon atom is introduced in the aforementioned linking group, the discotic liquid crystal molecule can be spirally twist oriented. Such spiral twist alignment of the discotic liquid crystal molecules can be also ensured by adding a compound (chiral agent) containing an asymmetric carbon atom and having optical activity.

The discotic liquid crystal compounds of two or more kinds may be employed together. For example, a polymerizable discotic liquid crystal compound such as described above and a non-polymerizable discotic liquid crystal compound can be used together.

The non-polymerizable discotic liquid crystal compound is preferably a compound in which a polymerizable group of a polymerizable discotic liquid crystal compound is changed to a hydrogen atom or an alkyl group. Thus, a compound described in JP-B No. 2640083 can be used as the non-polymerizable discotic liquid crystal compound.

### <Other Additives to Optically Anisotropic Layer>>

In the optically anisotropic layer, a plasticizer, a surfactant, a polymerizable monomer, and the like can be used together with the above-described liquid crystal compound, thereby making it possible to improve the uniformity of coated film, strength of the film, and alignment ability of liquid crystal compound. These additives are preferably compatible with the liquid crystal compound, cause no variation in the inclination angle of liquid crystal molecules (for example, the inclination angle of the plate of the disk-like structural unit with respect to the surface of the transparent support body in the case of discotic liquid crystal compounds), and do not hinder alignment.

The polymerizable monomers can be radical polymerizable or cation polymerizable compound. The preferred among them are polyfunctional radical polymerizable monomers, and the preferred polymerizable monomers are copolymerizable with the above described liquid crystal compounds having polymerizable groups. Examples of suitable polymerizable monomers are described in Par. Nos. [0018] to [0020] of JP-A No. 2002-296423. These compounds are generally added in an amount within a range of 1 wt. % to 50 wt. %, preferably within a range of 5 wt. % to 30 wt. % with respect to discotic liquid crystal molecules.

Examples of suitable surfactants include well-known conventional compounds, and fluorine-containing compounds are especially preferred. Specific examples are described, for example, in Par. Nos. [0028] to [0056] of JP-A 2001-330725.

The polymers used together with the discotic liquid crystal compound preferably induce changes of the inclination angle in the discotic liquid crystal molecule.

Cellulose acylate is an example of such polymer. The preferred examples of cellulose acylate are described in Par. No. [0178] of JP A No. 2000-155216.

The amount of polymer that is added is preferably within a range of 0.1 wt. % to 10 wt. %, more preferably within a range of 0.1 wt. % to 8 wt. % with respect to the liquid crystal molecules, so that the alignment of liquid crystal molecules is not inhibited.

The discotic nematic liquid crystal phase—solid phase transition temperature of the discotic liquid crystal compound is preferably within a range of from 70° C. to 300° C., more preferably 70° C. to 170° C.

### <<Composition of Optically Anisotropic Layer>>

The optically anisotropic layer is formed by coating a coating liquid containing the liquid crystal compound and also the below-described polymerization initiator and any additive (for example, a plasticizer, a monomer, a surfactant, cellulose acylate, a 1,3,5-triazine compound, a chiral agent) on the alignment film.

Organic solvents are preferably employed as solvents to be used in preparing the coating liquid. Examples of suitable organic solvents include amides (for example, N,N-dimethylformamide, N-methyl-2-pyrrolidone, 1,3-dimethylimidazolidinone), sulfoxides (for example, dimethylsulfoxide), heterocyclic compounds (for example, pyridine), hydrocarbons (for example, toluene, hexane), alkyl halides (for example, chloroform, dichloromethane), esters (for example, methyl acetate, butyl acetate), ketones (for example, acetone, methyl ethyl ketone, cyclohexanone), and ethers (for example, tetrahydrofuran and 1,2-dimethoxyethane). Alkyl halides and ketones are preferred. Organic solvent of two or more kinds may be used together.

The process of coating the coating liquid can be implemented by a well-known method (for example, an extrusion coating method, a direct gravure coating method, a reverse gravure coating method, a die coating method, and a wire coating method).

### [Fixation of Alignment State of Liquid Crystal Molecules]

It is preferred that liquid crystal molecules be aligned substantially uniformly, and it is more preferred that they be fixed in the state of substantially uniform alignment. It is even more preferred that the alignment of liquid crystal molecules be fixed by a polymerization reaction. Examples of suitable polymerization reactions include a thermal polymerization reaction using a thermal polymerization initiator and a photopolymerization reaction using a photopolymerization initiator. Among these reactions, photopolymerization reaction is preferred.

Examples of suitable photopolymerization initiators include a-carbonyl compounds (described in U.S. Pat. Nos. 2,367,661 and 2,367,670) , acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimers and p-aminophenyl ketone (described in U.S. Pat. No. 3,549,367), acridine and phenazine compounds (described in JP-A No. 60-105667 and U.S. Pat. No. 4,239,850) and oxadiazole compounds (described in U.S. Pat. No. 4,212,970).

The amount of the photopolymerization initiator used is preferably 0.01 wt. % to 20 wt. %, more preferably 0.5 wt. % to 5 wt. % based on the solids of the coating liquid.

Ultraviolet radiation is preferably used as light radiation for polymerizing the discotic liquid crystal molecules.

The irradiation energy is preferably 20 mJ/cm² to 5000 mJ/cm², more preferably 100 mJ/cm² to 800 mJ/cm².

In order to enhance the photopolymerization reaction, the light irradiation may be performed under heating. In the case of radical photopolymerization induced by light irradiation, the polymerization can be carried out in the air or an inactive gas, and an atmosphere with a concentration of oxygen reduced to a minimum is preferred to shorten the induction period of polymerization of radical-polymerizable monomers or to increase sufficiently the polymerization ratio.

The thickness of the optically anisotropic layer is preferably 0.5 μm to 100 μm, more preferably 0.5 μm to 30 μm, and even more preferably 0.5 μm to 5 μm. Depending on the mode of the liquid crystal cell, the thickness of the optically anisotropic layer can be increased (3 μm to 10 μm) to obtain high optical anisotropy.

As described hereinabove, the alignment state of liquid crystal molecules in the optically anisotropic layer is determined according to the type of the display mode of the liquid crystal cell. More specifically, the alignment state of liquid crystal molecules can be controlled by the kind of liquid crystal molecules, kind of alignment film, and usage of an additive located inside the optically anisotropic layer (for example, a plasticizer, a binder, or a surfactant).

### <Slow Axis Angle of Optical Compensation Film>

The optical compensation film in accordance with the present invention has in-plane anisotropy, and this optical anisotropy can be demonstrated by stretching a transparent support body or a transparent support body to which a retardation control agent has been added in advance, or by coating an alignment film on a transparent support body, rubbing, and then aligning the liquid crystals.

In this case, the angle (slow axis angle) formed by the direction with the largest refractive index in the plane (slow axis direction) and the longitudinal direction (conveying direction) of the optical compensation film in the form of a long roll can be controlled to any value from 0° to 90° by varying the stretching angle or rubbing angle.

Further, the spread of the slow axis angle in the plane is preferably 3° or less, more preferably 2° or less, and even more preferably 1° or less with respect to the average value of the slow axis angle.

### <Surface Treatment of Optical Compensation Film>

In accordance with the present invention, adhesion between the optical compensation film and polarizing film is improved by performing surface treatment of the optical compensation film on the surface thereof that is on the side of the polarizing film. Examples of suitable surface treatment include a corona discharge treatment, a glow discharge treatment, a flame treatment, a UV irradiation treatment, an acid treatment, and an alkali saponification treatment.

The contents of the treatment methods such as corona discharge treatment, glow discharge treatment, flame treatment, UV irradiation treatment, and acid treatment is described, for example, in Kokai Giho No. 01-1745 by Japan Institute of Invention and Innovation. In accordance with the present invention, the alkali saponification treatment is preferred, and the contents thereof is identical to that described above in section “Alkali Saponification Treatment” of “Surface Treatment of Transparent Support Body”.

### (Polarizing Plate)

In the polarizing plate in accordance with the present invention, the above-described transparent protective film and/or the optical compensation film, and the transparent protective film and/or the optical compensation film are disposed on at least one surface of a polarizing film (polarizing plate).

### <Transparent Protective Film>

The optical compensation film in accordance with the present invention and one more transparent support body that forms a pair therewith can be used as the transparent protective film of the polarizing plate. Here, the transparency of the protective film means that the light transmittance thereof is equal to or more than 80%.

A pair of transparent protective films or the optical compensation film in accordance with the present invention and one more transparent protective film that forms a pair therewith can be used as the transparent protective film. Here, the transparency of the protective film means that the light transmittance thereof is equal to or more than 80%. By using the transparent protective film and optical compensation film in accordance with the present invention at the side of the polarizing plate that is pasted onto the liquid crystal cell, it is possible to reduce the variation of display characteristics of a liquid crystal display device in response to variations in ambient humidity. A conventional cellulose acylate film can be used as a transparent protective film on the side opposite the side that is pasted onto the liquid crystal cell.

The cellulose acylate film used as the transparent protective film is preferably formed by the solvent casting method described hereinabove in the explanation of the method for manufacturing the transparent support body. The thickness of the transparent protective film is preferably 10 μm to 200 μm, more preferably 20 μm to 100 μm, and even more preferably 60 μm to 100 μm.

### <Polarizing Film>

A iodine-containing polarizing film, a dye-containing polarizing film that uses a dichroic dye, and a polyene-containing polarizing film can be used as the polarizing film (polarizer) employed in the polarizing plate in accordance with the present invention. The iodine-containing polarizing film and dye-containing polarizing film are typically manufactured by using a poly(vinyl alcohol) film.

Polarizing films manufactured by any process can be also employed. For example, a method may be employed in which when a poly(vinyl alcohol) film is continuously supplied and stretched by imparting tension thereto, while holding both ends thereof by a holding means, the stretching may be so performed that a locus L1 of the holding means from a substantial holding initiation point to a substantial holding release point on one end of the film, a locus L2 of the holding means from a substantial holding initiation point to a substantial holding release point on the other end of the polymer film, and a distance W between the left and right substantial holding release points satisfy the following formula (4), a straight line connecting the left and right substantial holding initiation points is substantially perpendicular to the center line of the film introduced to the holding process, and a straight line connecting the left and right substantial holding release points is substantially perpendicular to the center line of the film transferred to the next process (see the description of United States Patent Application No. 2002/8840).

|L2−L1|>0.4W Formula (4)

Because the polarizing film has properties such as a low mechanical strength and hygroscopicity, a polarizing plate can be obtained by protecting the polarizing film by disposing films (protective films) having protection ability on both sides of the polarizing film.

As described above, the optical compensation film in accordance with the present invention and cellulose triacetate can be used as a pair to serve as a protective film of the polarizing film for the polarizing plate in accordance with the present invention.

The arrangement is preferably such that the angle formed by the transmission axis of the polarizing film and the slow axis of the transparent protective film used in the polarizing plate in accordance with the present invention is equal to or less than 3°, more preferably equal to or less than 2°, and still more preferably equal to or less than 1°.

A base material film provided with a hard coat layer or a film provided with a functional thin film can be also used as the protective film forming a pair with the optical compensation film. For example, it is also preferred that an antireflection film having an outermost surface that is resistant to contamination and abrasion be provided. Any well-known conventional antireflection film can be used.

It is especially preferred that an antireflection film be provided on the air-side surface of the transparent protective film. The air-side surface is a surface of the transparent protective film of the polarizing film that is opposite, via a variation film, the surface where the cellulose acylate optical compensation film in accordance with the present invention is employed, and the air-side surface is called a viewing-side surface. Such configuration is preferred because a bright image without the reflection of external light or glare can be obtained on the screen of the liquid crystal display device.

### [Antireflection Film]

The antireflection film is preferably obtained by providing a low-refractive layer that also serves as a contamination preventing layer on a transparent support body, and it is even more preferred that a low-refractive layer and at least one other layer (that is, a high-refractive layer, a medium-refractive layer, and the like) that has a refractive index higher than that of the low-refractive layer be provided on the transparent support body.

As for the methods for forming the antireflection film, a multilayer film in which thin transparent films of inorganic compounds (metal oxides or the like) with different refractive indexes can be formed by a chemical vapor deposition (CVD) method or a physical vapor deposition (PVD) method, and a thin film can be formed by a sol-gel method using a metal compound such as a metal alkoxide in which a film of colloidal metal oxide particles is formed and then an after-treatment is performed.

The after-treatment can involve UV irradiation and plasma treatment. A technique described in JP-A No. 09-157855 can be used for UV irradiation.

A technique described in JP-A No. 2002-327310 can be used for plasma treatment.

An antireflection film obtained by laminating thin films in which inorganic particles are dispersed in a matrix is an antireflection film that can be obtained with high productivity.

By providing fine peaks and valleys on the surface of the outermost layer of the antireflection film obtained by the above-described coating process, it is possible to produce an antireflection film imparted with antiglare property.

### —Layered Structure of Coating-Type Antireflection Film—

As described above, the antireflection film preferably has a layered configuration in which at least one layer (high-refractive layer) having a refractive index higher than that of the low-refractive layer and the low-refractive layer (outermost layer) are provided in the order of description on the transparent support body.

When the at least one layer (high-refractive layer) having a refractive index higher than that of the low-refractive layer is composed of two layers, it is preferred that the antireflection film have a layered configuration in which a medium-refractive layer, a high-refractive layer, and a low-refractive layer (outermost layer) be provided in the order of description on the transparent support body.

The antireflection film of such configuration is designed to have refractive indexes satisfying the following relationship: (refractive index of high-refractive layer)>(refractive index of medium-refractive layer)>(refractive index of transparent support body)>(refractive index of low-refractive layer). The refractive index of each refractive layer is relative.

Further, a hard coat layer may be provided between the transparent support body and the medium-refractive layer. The antireflection film may be also composed of a medium-refractive hard coat layer, a high-refractive layer, and a low-refractive layer.

The antireflection film is described, for example, in JP-A Nos. 08-122504, 08-110401, 10-300902, 2002-243906, and 2000-111706.

Other functions may be also imparted to each layer. For example, antireflection films are known in which a low-refractive layer is resistant to contamination and a high-refractive layer has antistatic priorities (for example, see JP-A Nos. 10-206603 and 2002-243906).

The haze value of the antireflection film is preferably equal to or less than 5%, more preferably equal to or less than 3%. The strength of the antireflection film is preferably equal to or more than H, more preferably equal to or more than 2H, and even more preferably equal to or more than 3H, as determined by the pencil hardness test according to JIS K5400.

### —Transparent Support Body for Use in Antireflection Film—

The light transmittance of the transparent support body is preferably 80% or more, more preferably 86% or more.

The haze value of the transparent support body is preferably 2.0% or less, more preferably 1.0% or less. Further, the refractive index of the transparent support body is preferably 1.4 to 1.7.

A plastic film is preferably used as the transparent support body. Examples of materials for the plastic film include cellulose acylate, polyamides, polycarbonates, polyesters (for example, polyethylene terephthalate and polyethylene naphthalate), polystyrene, polyolefins, polysulfones, polyethersulfones, polyallylates, polyetherimides, poly(methyl methacrylate), and polyetherketones. Among them, cellulose acylate is preferred when an antireflection film is provided on the polarizing plate. —High-Refractive Layer and Medium-Refractive Layer—

The layer having a high refractive index in the antireflection film is preferably composed of a curable film containing ultrafine particles of an inorganic compound having a mean particle size of 100 nm or less and a high refractive index and a matrix binder.

Examples of fine particles of an ultrafine compound with a high refractive index include particles of inorganic compounds with a refractive index of 1.65 or more, more preferably a refractive index of 1.9 or more. Examples of suitable particles include oxides of Ti, Zn, Sb, Sn, Zr, Ce, Ta, La, and In, and complex oxides containing atoms of these metals.

The preferred among them are fine inorganic particles containing as the main component titanium dioxide containing at least one element selected from Co, Zr, and Al (sometimes referred to hereinbelow as “specific oxide”), and the especially preferred are those in which the element is Co.

The total content of Co, Al, Zr related to that of Ti is preferably 0.05 wt. % to 30 wt. %, more preferably 0.1 wt. % to 10 wt. %, still more preferably 0.2 wt. % to 7 wt. %, even more preferably 0.3 wt. % to 5 wt. %, and most preferably 0.5 wt. % to 3 wt. %, based on Ti.

Co, Al, Zr are present inside or on the surface of fine inorganic particles containing titanium dioxide as the main component. It is more preferred that Co, Al, Zr be present inside the fine inorganic particles containing titanium dioxide as the main component, and it is even more preferred that these metal elements be present both inside and on the surface. These specific metal elements may be present in the form of oxides.

Examples of other suitable inorganic particles include particles of composite oxides containing a titanium element and at least one metal element (abbreviated hereinbelow as “Met”) selected from metal elements whose oxide has a refractive index of 1.95 or more, and inorganic particles of these composite oxides that are doped with metal ions of at least one kind selected from Co ions, Zr ions, and Al ions (sometimes referred to hereinbelow as “specific composite oxides”).

Examples of preferred metal elements whose oxide has a refractive index of 1.95 or more include Ta, Zr, In, Nd, Sb, Sn, and BI; Ta, Zr, Sn, and BI are especially preferred.

From the standpoint of maintaining the refractive index, it is preferred that the content ratio of metal ions doped into the composite oxides be within a range of lo below 25 wt. % with respect to the total amount of metals [Ti+Met] constituting the composite oxides; a range of 0.05 wt. % to 10 wt. % is more preferred, a range of 0.1 wt. % to 5 wt. % is even more preferred, and a range of 0.3 wt. % to 3 wt. % is especially preferred.

The doped metal ions may be present as metal ions or metal atoms, and it is preferred that they be appropriately present from the surface to the inside of the composite oxide. The presence on both the surface and the inside is more preferred.

The above-described ultrafine particles can be obtained by a method by which the surface of particles is treated with a surface treatment agent, a method by which a core-shell structure having high-refractive particles as a core is obtained, and a method employing a special dispersant.

Silane coupling agents described in JP-A Nos. 11-295503, 11-153703, and 2000-9908 and anionic compounds or organometallic coupling agents described in JP-A No. 2001-310432 are disclosed as examples of surface treatment agents suitable for the method by which the surface of particles is treated with a surface treatment agent.

The technology described in JP-A No. 2001-166104 and US Patent Application No. 2003/0202137 can be used as a method for obtaining a core-shell structure having high-refractive particles as a core.

The technology described in JP-A No. 11-153703, U.S. Pat. No. 6,210,858, and JP-A No. 2002-2776069 can be used as a method employing a special dispersant.

Examples of materials for forming the matrix include well-known conventional thermoplastic resins and thermosetting resin coatings.

Further, compositions of at least one kind selected from compositions containing polyfunctional compounds having at least two polymerizable groups that are radical polymerizable and/or cation polymerizable, organometallic compounds containing hydrolyzable groups, and compositions of partial condensates thereof. Suitable examples include compounds described in JP-A Nos. 2000-47004, 2001-315242, 2001-31871, and 2001-296401.

Curable films obtained from colloidal metal oxides and metal alkoxide compositions obtained from hydrolysis condensates of metal alkoxides are also preferred. Examples thereof are described in JP-A No. 2001-293818.

The refractive index of the high-refractive layer is preferably 1.70 to 2.20. The thickness of the high-refractive layer is 5 nm to 10 μm, more preferably 10 nm to 1 μm.

The refractive index of the medium-refractive layer is adjusted to assume a value between the refractive index of the low-refractive layer and the refractive index of the high-refractive layer. The refractive index of the medium-refractive layer is preferably 1.50 to 1.70. The thickness of the medium-refractive layer is preferably 5 nm to 10 μm, more preferably 10 nm to 1 μm.

### —Low-Refractive Layer—

The low-refractive layer is preferably laminated on the high-refractive layer. The refractive index of the low-refractive layer is preferably 1.20 to 1.55, more preferably 1.30 to 1.50.

The low-refractive layer is preferably configured as an outermost layer having resistance to abrasion and contamination. Imparting sliding ability to the surface is an effective means for greatly improving the abrasion resistance, and the conventional well-known thin-film layer obtained by introducing a silicone or fluorine can be employed as such means.

The refractive index of the fluorine-containing compound is preferably 1.35 to 1.50, more preferably 1.36 to 1.47. The fluorine-containing compound is preferably a crosslinkable compound or a compound having a polymerizable function group, this compound containing fluorine atoms within a range of 35 wt. % to 80 wt. %.

Examples of suitable compounds are described in Par. Nos. [0018] to [0026] of JP-A No. 09-222503, Par. Nos. [0019] to [0030] of JP-A No. 11-38202, Par. Nos. [0027] to [0028] of JP-A No. 2001-40284, and JP-A Nos. 2000-284102 and 2004-45462.

The preferred examples of silicone compounds include compounds having a polysiloxane structure and compounds having a bridge structure in the film that contains a curable functional group or a polymerizable functional group in a macromolecular chain. Suitable examples include reactive silicones (for example, Silaplane, manufactured by Chisso Corp.) and a polysiloxane containing silanol groups at both ends (JP-A No. 11-258403).

The crosslinking or polymerization reaction of the fluorine-containing and/or siloxane polymer having crosslinkable or polymerizable groups is preferably carried out by coating a coating composition for forming the outermost layer containing a polymerization initiation, a sensitizer, and the like and irradiating with light or heating simultaneously with the coating process or thereafter. Well-known conventional polymerization initiators and sensitizers can be used.

A sol-gel cured film that is cured by a condensation reaction of an organometallic compound such as a silane coupling agent and a silane coupling agent containing a special fluorine-containing hydrocarbon group in the presence of a catalyst is also preferred.

Suitable examples include silane compounds containing polyfluoroalkyl groups or partial hydrolyzation condensates thereof (compounds described in JP-A Nos. 58-142958, 58-147483, 58-147484, 09-157582, and 11-106704), silyl compounds containing poly[perfluoroalkylether] groups, which are fluorine-containing long-chain groups (compounds described in JP-A Nos. 2000-117902, 2001-48590, and 2002-53804).

The low-refractive layer preferably contains a low-refractive inorganic compound with a mean diameter of primary particles of 1 nm to 150 nm, such as silicon dioxide (silica) and fluorine-containing particles (magnesium fluorine, calcium fluoride, barium fluoride) as a filler serving as another additive.

It is especially preferred that the low-refractive layer contain hollow fine inorganic particles to reduce further the increase in the refractive index thereof.

The refractive index of the hollow fine inorganic particles is preferably 1.17 to 1.40, more preferably 1.17 to 1.37, and even more preferably 1.17 to 1.35. This refractive index represents the refractive index of the entire particle, rather than the refractive index of only the outer shell forming the hollow fine inorganic particle.

The porosity w (%) represented by Equation (5) below, where (a) stands for a radius of cavity inside the particle and (b) stands for a radius of outer shell of the particle, is calculated in the below-described manner.

w=(4πa³/3)/(4πb³/3)×100 Equation (5)

The porosity is preferably 10% to 60%, more preferably 20% to 60%, and even more preferably 30% to 60%. From the standpoint of particle strength and abrasion resistance of the low-refractive layer containing hollow particles, it is preferred that the refractive index of the hollow particles be equal to or higher than 1.17.

The mean particle size of the hollow inorganic particles contained in the low-refractive index is preferably 30% or more to 100% or less of the thickness of the low-refractive layer, more preferably 35% or more to 80% or less of the thickness of the low-refractive layer, still more preferably 40% or more to 60% or less of the thickness of the low-refractive layer.

Thus, where the thickness of the low-refractive layer is 100 nm, the particle size of the inorganic particles is preferably 30 nm or more to 100 nm or less, more preferably 35 nm or more to 80 nm or less, and still more preferably 40 nm or more to 60 nm or less.

The refractive index of the hollow inorganic particles can be measured with an Abbe refractometer (manufactured by Atago KK).

Examples of other additives include organic fine particles described in Par. Nos. [0020] to [0038] of JP-A No. 11-3820, silane coupling agents, lubricating agents, and surfactants.

When the low-refractive layer is positioned below the outermost layer, the low-refractive layer may be formed by a vapor-phase method (a vacuum vapor deposition method, a sputtering method, an ion plating method, a plasma CVD method, and the like).

A coating method is preferred because the layer can be manufactured at a low cost.

The thickness of the low-refractive layer is preferably 30 nm to 200 nm, more preferably 50 nm to 150 nm, and even more preferably 60 nm to 120 nm.

—Other Layers of Antireflection film—

The antireflection film may be further provided with a hard coat layer, forward scattering layer, a primer layer, an antistatic layer, an undercoat layer, a protective layer and the like.

### —Hard Coat Layer—

A hard coat layer can impart physical strength to the antireflection film an is preferably provided on the surface of the transparent support body. It is especially preferred that the hard coat layer be provided between the transparent support body and the high-refractive layer.

The hard coat layer is preferably formed by a crosslinking reaction or polymerization reaction of a photo- and/or thermally curable compound.

Photopolymerizable functional groups are preferred as curable functional groups, and organic alkoxysilyl compounds are preferred as organometallic compounds containing hydrolyzable functional groups.

Specific examples of such compounds are identical to those described in relation to the high-refractive layer.

Specific compounds that can constitute the hard coat layer are described, for example, in JP-A Nos. 2002-144913 and 2000-9908 and International Publication No. WO00/46617.

The high-refractive layer can also serve as the hard coat layer. In this case, the high-refractive layer is preferably formed by finely dispersing particles and introducing them into a hard coat layer by using the technique described in relation to the high-refractive layer.

The hard coat layer can also contain particles with a mean particle size of 0.2 μm to 10 μm and serve as an antiglare layer imparted with antiglare function (described later).

The thickness of the hard coat layer is not particularly limited and can be appropriately selected according to the object. For example, this thickness is preferably 0.2 μm to 10 μm, more preferably 0.5 μm to 7 μm.

The strength of the hard layer is preferably H or more, more preferably 2H or more, and even more preferably 3H or more, as measured by a pencil hardness test according to JIS K5400.

The smaller is the amount of wear of the sample in the Taber test according to JIS K5400 the better.

### —Forward Scattering Layer—

In applications of liquid crystal display devices, the forward scattering layer is preferred because it can provide a viewing angle improvement effect when the viewing direction is tilted up or down, or to the left or to the right. This layer can also have a hard coat function when fine particles of a different refractive index are dispersed in the hard coat layer.

Examples of forward scattering layers are described in JP-A No. 11-38208 in which the forward scattering coefficient is specified, JP-A No. 2000-199809 in which the ranges of relative refractive indexes of a transparent resin and fine particles are specified, and JP-A No. 2002-107512 in which a haze value is stipulated to be equal to or higher than 40%.

### [Formation of Antireflection Film]

Each layer of the antireflection film can be formed by coating using a dip coating method, an air knife coating method, a curtain coating method, a roll coating method, a wire bar coating method, a gravure coating method, a microgravure method, and an extrusion coating method (described in U.S. Pat. No. 2,681,294).

### —Antiglare Function—

The antireflection film may have an antiglare function of scattering the external light. The antiglare function can be obtained by forming peaks and valleys on the surface of the antireflection film. When the antireflection film has the antiglare function, the haze of the antireflection film is preferably 3% to 50%, more preferably 5% to 30%, even more preferably 5% to 20%.

Any method can be employed for forming peaks and valleys on the antireflection film surface, provided that the surface state of the antireflection film can be sufficiently maintained.

Examples of suitable methods include a method of forming peaks and valleys on the film surface by using fine particles in the low-refractive layer (for example, see JP-A No. 2000-271878), a method of forming a surface peak-valley layer by adding a small amount (0.1 wt. % to 50 wt. %) of comparatively large particles (particle size 0.05 μm to 2 μm) to the layer (high-refractive layer, medium-refractive layer, or hard coat layer) located below the low-refractive layer, and then forming a low-refractive layer on the surface peak-valley layer so as to maintain the shape thereof (for example, see JP-A Nos. 2000-281410, 2000-95893, 2001-100004, and 2001-281407), and a method of physically transferring the peak-valley shape of the outermost layer (layer with resistance to contamination) on the surface after coating (for example, see JP-A Nos. 63-278839, 11-183710, and 2000-275401 that describe an emboss processing method).

In the polarizing plate provided with the antireflection film in accordance with the present invention, the transparent support body provided with the antireflection film preferably also serves as a protective film of the polarizing plate.

Here, the surface of a cellulose acylate film on the side of the transparent support body (preferably, a cellulose acylate film) opposite that where the antireflection film is provided is preferably produced by subjecting to hydrophilization treatment and joining to a polarizing film with an adhesive.

A treatment identical to that described above in relation to the surface treatment of the optical compensation film can be used for the hydrophilization treatment.

On the surface on the opposite side, via the polarizing film, from the antireflection film of the polarizing film, the optical compensation film in accordance with the present invention is used, as described above, as a film also serving as a protective film.

Here, the surface of the transparent support body of the optical compensation film opposite that where the optically anisotropic layer is provided is preferably produced by subjecting to hydrophilization treatment and joining to a polarizing film with an adhesive.

This is preferred because the polarizing plate thickness is decreased and the liquid crystal display device can be reduced in weight.

### (Liquid Crystal Display Device)

The liquid crystal display device in accordance with the present invention contains a liquid crystal cell and two polarizing plates disposed on both sides of the liquid crystal cell. In the liquid crystal cell, a liquid crystal is held between two electrode substrates.

One optical compensation film is disposed between the liquid crystal cell and one polarizing plate, or two optical compensation films are disposed between the liquid crystal cell and both polarizing plates.

The liquid crystal display device in accordance with the present invention is also effective in any of types including a transmissive type, a reflective type, and a semitransmissive type.

The transparent protective film in accordance with the present invention can be used in liquid crystal display devices of various display modes. Thus liquid crystal cells of such as a TN (Twisted Nematic) mode, an STN (Super Twisted Nematic) mode, an IPS (In-plane Switching) mode, an FLC (Ferroelectric Liquid Crystal) mode, an AFLC (Anti-ferroelectric Liquid Crystal) mode, and an ECB (Electrically Controlled Birefringence) mode can be used, examples of the ECB mode including an OCB (Optically Compensatory Bend) mode, an HAN (Hybrid Aligned Nematic) mode, a VA (Vertically Aligned) mode, an MVA mode, and a homogeneous alignment mode. Among them, liquid crystal cells of the TN mode and ECB mode such as the OCB mode, HAN mode, VA mode, MVA mode, and homogeneous alignment mode are preferred.

Display modes in which the aforementioned display modes have a split alignment have also been suggested. The transparent protective film in accordance with the present invention is also effective in liquid crystal display devices of all those display modes. It is also effective in transmissive, reflective, and semitransmissive liquid crystal display devices.

The liquid crystal cells are described in “1999 PDP/LCD Construction Materials—Chemicals Market”, Jul. 30, 1999, and CMC, “Trend of EL, PDP, LCD Display Technology and Market”, March 2001, Toray Research Center.

The preferred forms of the optically anisotropic layer in each liquid crystal mode is described below.

### <TN-Mode Liquid Crystal Display Device>

A TN-mode liquid crystal cell is most often used as a color TFT liquid crystal display device and described in a large number of publications. In the alignment state in the liquid crystal cell during black display mode of the TN mode, the rod-like liquid crystal molecules are raised vertically in the central portion of the cell, but the rod-like liquid crystal molecules are horizontal in the vicinity of the cell substrates.

The transparent protective film in accordance with the present invention may be also used as a support body for an optical compensation film of TN-type liquid crystal display device having a TN-mode liquid crystal cell. The TN-mode liquid crystal cells and TN-type liquid crystal display devices have been well known for a long time.

Optical compensation films for use in the TN-mode liquid crystal display devices are described in JP-A Nos. 03-9325, 06-148429, 08 50206, and 09-26572.

They are also described in the articles by Mori et al. (Jpn. J. Appl. Phys. Vol. 36 (1997), p. 143, Jpn. J. Appl. Phys. Vol. 36 (1997), p. 1068).

The so-called picture frame defect occurring in liquid crystal display devices can be overcome by using the transparent protective film in accordance with the present invention instead of the conventional triacetyl cellulose employed as a transparent protective film in the devices described in the aforementioned publications and compensating the insufficiency of Rth required for optical compensation with the optical compensation layer in which stacked liquid crystal compounds are oriented, or by laminating anew a negative C plate layer formed by a cholesteric liquid crystal layer or a horizontally oriented layer of disk-like compounds.

### (STN-Mode Liquid Crystal Display Device)

The transparent protective film in accordance with the present invention may be also used as a support body for an optical compensation film of STN-type liquid crystal display device having an STN-mode liquid crystal cell.

In STN-mode liquid crystal display devices, rod-like liquid crystal molecules located in the liquid crystal cell are typically twisted within a range of 90° to 360°, and a product (Δnd) of refractive index anisotropy(Δn) of rod-like liquid crystal molecules and a cell gap (d) is within a range of from 300 nm to 1,500 nm. An optical compensation film used in an STN-mode liquid crystal display device is described in JP-A No. 2000-105316.

### <VA-Mode Liquid Crystal Display Device>

In a VA-mode liquid crystal cell, rod-like liquid crystal molecules are oriented substantially vertically when no voltage is applied.

In addition to (1) liquid crystal cells of a VA mode in the narrow meaning thereof in which rod-like liquid crystal molecules are oriented substantially vertically when no voltage is applied and oriented substantially horizontally when a voltage is applied (described in JP-A No. 02-176625), there are (2) liquid crystal cells in which the VA mode is subjected to multidomain conversion (MVA mode) to enlarge the viewing angle (described in SID 97, Digest of Tech. Papers (preprints) 28 (1997) 845), (3) liquid crystal cells of a mode (n-ASM mode) in which rod-like liquid crystal molecules are oriented substantially vertically when no voltage is applied and twist multidomain oriented when a voltage is applied (described in Japan Liquid Crystal Society, Preliminary Reports 58-59 (1998)), and (4) liquid crystal cells of a SURVIVAL mode (published by LCD International 98).

When the transparent protective film in accordance with the present invention is used as a support body of an optical compensation film of a VA-mode liquid crystal display device having a VA-mode liquid crystal cell, well-known A plate+C plate are laminated on the transparent protective film.

The VA-mode liquid crystal display devices may be of a system with a split alignment as described, for example, in JP-A No. 10-123576.

(IPS-Mode liquid Crystal Display Device and ECB-Mode Liquid Crystal Display Device)

The transparent protective film in accordance with the present invention can be especially advantageously used as a support body for an optical compensation film or a protective film of a polarizing plate in an IPS-mode liquid crystal display device and an ECB-mode liquid crystal display device having IPS-mode and ECB-mode liquid crystal cells.

In these modes, a liquid crystal material is oriented almost parallel during black display, and when no voltage is applied, liquid crystal molecules are oriented parallel to the substrate surface, producing black display.

In these modes, a polarizing plate using the transparent protective film in accordance with the present invention contributes to the improvement of color, expansion of a viewing angle, and contrast improvement.

In such mode, it is preferred that a polarizing plate using the transparent protective film in accordance with the present invention be used on at least one side of the protective film disposed between the liquid crystal cell and the polarizing plate (protective film on the cell side), from among the protective films of polarizing plates located below and above the liquid crystal cell.

It is even more preferred that an optically anisotropic layer be disposed between the liquid crystal cell and the protective film of the polarizing plate and the retardation value of the optically anisotropic layer be set equal to or less than a twofold value of Δn·d of the liquid crystal layer.

### (OCB-Mode Liquid Crystal Display Device and HAN-Mode Liquid Crystal Display Device)

The OCB-mode liquid crystal cell is a liquid crystal cell of a bend alignment mode in which rod-like liquid crystal molecules are oriented in substantially opposite directions (symmetrically) below and above the liquid crystal cell.

Liquid crystal display devices using the liquid crystal cells of a bend alignment mode are disclosed in U.S. Pat. No. 4,583,825 and 5,410,422.

Because rod-like liquid crystal molecules are oriented symmetrically below and above the liquid crystal cell, the liquid crystal cell of a bend alignment mode has an optical self-condensation function. For this reason, this liquid crystal mode is called an OCB (Optically Compensatory Bend) liquid crystal mode.

In the OCB-mode liquid crystal cell, similarly to the TN-mode liquid crystal cell, the alignment state in the liquid crystal cell is such that the rod-like liquid crystal molecules are raised vertically in the central portion of the cell, and the rod-like liquid crystal molecules are horizontal in the vicinity of the cell substrates.

The transparent protective film in accordance with the present invention can be also advantageously used as a support body for an optical compensation film of an OCB-mode liquid crystal display device having an OCB-mode liquid crystal cell or a HAN-mode liquid crystal display device having a HAN-mode liquid crystal cell.

In the optical compensation film for use in the OCB-mode liquid crystal display device or HAN-mode liquid crystal display device, the direction in which the absolute value of retardation is minimal is preferably present neither in the plane of the optical compensation film nor in the direction normal thereto.

Optical properties of the optical compensation film for use in the OCB-mode liquid crystal display device or HAN-mode liquid crystal display device are determined by the optical properties of the optically anisotropic layer, optical properties of the support body, and the arrangement of the optically anisotropic layer and the support body.

An optical compensation film for use in the OCB-mode liquid crystal display device or HAN-mode liquid crystal display device is described JP-A No. 09-197397.

It is also described in the articles by Mori et al. (Jpn. J. Appl. Phys. Vol. 38 (1999), p. 2837).

The so-called picture frame defects occurring in liquid crystal display devices can be overcome by using a cellulose acylate film instead of the conventional triacetyl cellulose employed as a transparent protective film for forming the below-described hybrid oriented optical compensation layer and compensating the insufficiency of Re and Rth required for optical compensation by laminating anew a layer in which rod-like liquid crystal compounds are oriented horizontally.

Further, instead of the above-described configuration, a λ/4 film and a biaxial film obtained by stretching a cyclic polyolefin resin may be laminated on the transparent protective film in accordance with the present invention.

### (Reflective-Type Liquid Crystal Display Device)

The transparent protective film in accordance with the present invention cam be also advantageously used as an optical compensation film for a reflective liquid crystal display device of the TN mode, STN mode, HAN mode, and GH (Guest-Host) mode.

These display modes have been well known for a long time. TN-mode reflective liquid crystal display devices are described in JP-A No. 10-123478, WO 9848320, and JP-B No. 3022477. The optical compensation films used in reflective liquid crystal display device are described in WO 00-65384.

### (Other Liquid Crystal Display Devices)

The transparent protective film in accordance with the present invention can be also advantageously used as a support body for an optical compensation film of an ASM-mode liquid crystal display device having a liquid crystal cell of an ASM (Axially Symmetric Aligned Microcell) mode.

A specific feature of ASM-mode liquid crystal cells is that the cell thickness is maintained by the adjustable resin spacer.

Other features are identical to those of the TN-mode liquid crystal cell. ASM-mode liquid crystal cells and ASM-mode liquid crystal display devices are described in an article by Kume et al. (SID 98 Digest 1089 (1998)).

According to the invention, it is possible to provide a transparent protective film, an optical compensation film, and a polarizing plate with a sufficiently small variation of Rth in response to variations in humidity of the environment in which they are used.

Further, according to the invention it is possible to provide a liquid crystal display device that is optically substantially isotropic, has low optical anisotropy (Re, Rth), and demonstrates sufficiently small variations in viewing angle characteristics of color and contrast in response to variations in humidity of the environment in which the liquid crystal display device is used.

### EXAMPLES

Examples of the present invention will be described below, but the present invention is not limited to these examples.

### Example 1

### <Fabrication of Transparent Protective Film>

### <<Synthesis of Polymer 1>>

The below-described composition was charged into a four-neck flask (equipped with a charging opening, a thermometer, a circulation cooling tube, a nitrogen introducing tube, and a stirrer) and gradually heated to 80° C. Polymerization was then conducted for 5 h under stirring. Upon completion of polymerization, the polymer liquid was charged into a large amount of methanol, precipitated, further washed with methanol, purified, and dried to yield Polymer 1 with a weight-average molecular weight 5,000 (as measured by GPC).

[Composition of Polymer 1]

| | |
|---|---|
| Methyl acrylate | 10 parts by mass |
| 2-Hydroxyethyl acrylate | 1 part by mass |
| Azobisisobutyronitrile (AIBN) | 1 part by mass |
| Toluene | 30 parts by mass |

### <<Preparation of Dope Composition 1>>

The below-described Dope Composition 1 was charged into a sealed pressure vessel and heated to 70° C. to increase the pressure inside the vessel to 1 atm or more. The cellulose ester was then completely dissolved under stirring.

The dope temperature was then lowered to 35° C. and it was allowed to stay overnight. The dope was then filtered using Azumi Filter paper No. 244 manufactured by Azumi Roshi Co., Ltd., and then again allowed to stay overnight to remove bubbles.

Filtration was then performed under a filtration pressure of 1.0×10⁶ Pa by using Finemet NM (absolute filtration accuracy 100 μm) and Finepore NF (used by successively increasing the filtration accuracy in the order of absolute filtration accuracy of 50 μm, 15 μm, and 5 μm) manufactured by Nippon Seisen Co., Ltd., and the filtered product was supplied to a film formation process.

### [Composition of Dope Composition 1]

Cellulose triacetate (degree of substitution 2.83) . . . 100 parts by mass
Above-described synthesized Polymer 1 . . . 15 parts by mass
Tinuvin 326 . . . 2 parts by mass
Dichloromethane . . . 475 parts by mass
Solution prepared by dissolving 7.5 parts by mass of Example Compound A-7 in 50 parts by mass of methanol . . . 57.5 parts by mass

A film was then formed by using the Dope Composition 1 at 35° C. that was obtained by filtration and casting it from a hangar-type die on an endless stainless steel belt that endlessly runs at a temperature of 22° C.

Before the stainless steel belt onto which the dope composition was cast has completed about one cycle of movement, the organic solvent was evaporated to an amount of residual solvent of 25% and the web was peeled off. The time for casting to peeling was 2 min.

Upon completion of peeling, both ends of the web were clipped with a tenter, the web was held in the width direction, and dried at 120° C., while being conveyed. The clips were then released, and the web was drawn by a plurality of rolls arranged in a zigzag manner in a roll drying machine to dry the web at 120° C. to 135° C.

The film was then cooled and both ends of the film were subjected to knurl processing to a width of 10 mm and a height of 5 μm, the initial coiling tension was set to 150 N/width, and the transparent protective film (cellulose acylate film) was coiled at a final coiling tension of 100 N/width.

The thickness of the transparent protective film obtained was 40 μm, the coiling length was 3,000 m, and the width was 1,450 mm.

### <Evaluation of Transparent Protective Film>

The transparent protective film thus obtained was humidity adjusted for 24 h at each relative humidity from among 10% RH, 60% RH, and 80% RH, the retardation was measured with KOBRA 21ADH (manufactured by Oji Scientific Instruments Co., Ltd.) at wavelengths of 479.2 nm, 546.3 nm, and 628.8 nm, the results were recalculated into values at 550 nm and 630 nm by curve fitting, and the values of Re and Rth at a measurement wavelength of 630 nm and ΔRth, ΔRth/d×80,000 at a measurement wavelength of 550 nm were calculated. The calculation results are shown in Table 1.

### Examples 2 to 11

### <Fabrication of Transparent Protective Films>

Transparent protective films of Examples 2 to 11 were fabricated in the same manner as in Example 1, except that Example Compound A-7 contained in Dope Composition 1 in Example 1 and the added amount thereof were replaced with the example compounds and the added amounts thereof that are shown in Table 1 below.

### <Evaluation of Transparent Protective Films>

The values of Re and Rth at a measurement wavelength of 630 nm of the obtained transparent protective films of Examples 2 to 11 and ΔRth, ΔRth/d×80,000 at a measurement wavelength of 550 nm were calculated in the same manner as in Example 1. The calculation results are shown in Table 1.

### Comparative Example 1

### <Fabrication of Transparent Protective Films>

A transparent protective film of Comparative Example 1 was fabricated in the same manner as in Example 1, except that the Example Compound A-7 contained in Dope Composition 1 in Example 1 and the added amount thereof (7.5 parts by mass) were replaced with triphenyl phosphate (5.6 parts by mass) and biphenyldiphenyl phosphate (1.9 parts by mass).

### <Evaluation of Transparent Protective Films>

The values of Re and Rth at a measurement wavelength of 630 nm of the obtained transparent protective film of Comparative Example 1 and ΔRth, ΔRth/d×80,000 at a measurement wavelength of 550 nm were calculated in the same manner as in Example 1. The calculation results are shown in Table 1.

TABLE 1

| | | Additive | | | | | |
|---|---|---|---|---|---|---|---|
| | | | Amount of | | | ΔRth | |
| | | | Compound | Re60% | Rth60% | (% | |
| | Thickness | | A added | RH | RH | RH) | ΔRth/d × 80,000 |
| | (μm) | Compound A | (wt. %) | (nm) | (nm) | (nm) | (nm) |
| Example 1 | 40 | Compound | 7.5 | 0.3 | 5 | 5 | 10 |
| | | A-7 | | | | | |
| Example 2 | 40 | Compound | 10.0 | 0.3 | 4 | 3 | 6 |
| | | A-7 | | | | | |
| Example 3 | 40 | Compound | 10.0 | 0.2 | 3 | 2 | 4 |
| | | A-11 | | | | | |
| Example 4 | 40 | Compound | 10.0 | 0.2 | 3 | 2 | 4 |
| | | A-26 | | | | | |
| Example 5 | 40 | Compound | 10.0 | 0.3 | 4 | 4 | 8 |
| | | A-28 | | | | | |
| Example 6 | 40 | Compound | 10.0 | 0.3 | 4 | 3 | 6 |
| | | A-28 | | | | | |
| Example 7 | 40 | Compound | 2.5 | 0.1 | 2 | 1 | 2 |
| | | A-29 | | | | | |
| Example 8 | 40 | Compound | 7.5 | 0.3 | 4 | 3 | 6 |
| | | A-30 | | | | | |
| Example 9 | 40 | Compound | 7.5 | 0.3 | 4 | 2 | 4 |
| | | A-39 | | | | | |
| Example | 40 | Compound | 2.5 | 0.2 | 5 | 8 | 16 |
| 10 | | A-23 | | | | | |
| Example | 40 | Compound | 2.5 | 0.2 | 5 | 8 | 16 |
| 11 | | A-43 | | | | | |
| Comparative | 40 | — | — | 0.4 | 7 | 14 | 28 |
| Example 1 | | | | | | | |

Table 1 confirms that the variation of Rth per unit thickness in response to variations in humidity in the transparent protective films of Examples 1 to 11 is much smaller than that in Comparative Example 1, and the transparent protective films are greatly improved.

### Example 12

### <Fabrication of Transparent Protective Film>

### <<Preparation of Dope Composition 2>>

A Dope Composition 2 was prepared by dissolving the below-described composition in the same sequence as that of the method for preparing Dope Composition 1 in Example 1.

The prepared Dope Composition 2 was then flow cast from a casting port onto a drum cooled to 0° C.

The film was peeled off at the side where the solvent content was 70 wt. %. Both sides of the film in the width direction thereof were fixed with a pin tenter (the pin tenter described in FIG. 3 of JP-A No. 04-1009) and the film was dried, while maintaining the spacing ensuring a stretching ratio of 3% in the lateral direction (direction perpendicular to the mechanical direction), with the solvent content maintained at from 3 wt. % to 5 wt. %.

The film was then further dried by conveying between the rolls of a heat treatment apparatus, and a transparent protective film (cellulose acylate film of Example 2 that had a thickness of 80 μm was produced.

### [Components of Dope Composition 2]

Cellulose triacetate with a degree of substitution of 2.86 . . . 100 parts by mass
Triphenyl phosphate (plasticizer) . . . 7.8 parts by mass
Biphenyldiphenyl phosphate (plasticizer) 3.9 parts by mass
Dichloromethane . . . 300 parts by mass
1-Butanol . . . 11 parts by mass
Solution prepared by dissolving Example Compound A-7 (7.5 parts by mass) in 54 parts by mass of methanol . . . 61.5 parts by mass
Solution prepared by dissolving the below-described alignment suppressing additive B-11 (11.1 parts by mass) and the below-described wavelength dispersion adjusting agent (1.1 part by mass) in 22.2 parts by mass of dichloromethane and 5.6 parts by mass of methanol . . . 40 parts by mass

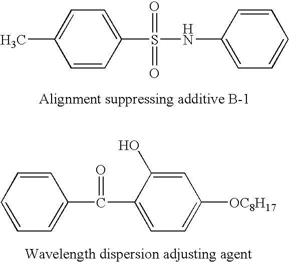

### <Evaluation of Transparent Protective Films>

The values of Re and Rth at a measurement wavelength of 630 nm of the obtained transparent protective film of Example 12 and ΔRth, ΔRth/d×80,000 at a measurement wavelength of 550 nm were calculated in the same manner as in Example 1. The calculation results are shown in Table 2.

### Examples 13 to 22

### <Fabrication of Transparent Protective Films>

Transparent protective films of Examples 13 to 22 were fabricated in the same manner as in Example 12, except that Example Compound A-7 contained in Dope Composition 1 in Example 12 and the added amount thereof were replaced with the example compounds and the added amounts thereof that are shown in Table 2 below.

### <Evaluation of Transparent Protective Films>

The values of Re and Rth at a measurement wavelength of 630 nm of the obtained transparent protective films of Examples 13 to 22 and ΔRth, ΔRth/d×80,000 at a measurement wavelength of 550 nm were calculated in the same manner as in Example 1. The calculation results are shown in Table 2.

### Comparative Example 2

### <Fabrication of Transparent Protective Film>

A transparent protective film of Comparative Example 2 was fabricated in the same manner as in Example 12, except that the Example Compound A-7 contained in Dope Composition 2 in Example 12 and the added amount thereof (7.5 parts by mass) were replaced with triphenyl phosphate (5.6 parts by mass) and biphenyldiphenyl phosphate (1.9 parts by mass).

### <Evaluation of Transparent Protective Films>

The values of Re and Rth at a measurement wavelength of 630 nm of the obtained transparent protective film of Comparative Example 2 and ΔRth, ΔRth/d×80,000 at a measurement wavelength of 550 nm were calculated in the same manner as in Example 1. The calculation results are shown in Table 2.

TABLE 2

| | | Additives | | | | | | | | | |
|---|---|---|---|---|---|---|---|---|---|---|---|
| | | | | | Weight- | LogP | | | | | |
| | | | Amount of | | average | value of | Amount of | | | | |
| | Thick- | | Compound | | molecular | Com- | Compound | Re60% | Rth60% | ΔRth | ΔRth/d × |
| | ness | Compound | A added | | weight of | pound | B added | RH | RH | (% | 80,000 |
| | (μm) | A | (wt. %) | Compound B | compound B | B | (wt. %) | (nm) | (nm) | RH) (nm) | (nm) |
| Example 12 | 80 | Compound | 7.5 | Compound | 171.2 | 2.5 | 8.45 | 2.0 | 7.2 | 10.0 | 10.0 |
| | | A-7 | | B-1 | | | | | | | |
| Example 13 | 80 | Compound | 10.0 | Compound | 171.2 | 2.5 | 8.29 | 2.0 | 7.2 | 7.0 | 7.0 |
| | | A-7 | | B-1 | | | | | | | |
| Example 14 | 80 | Compound | 10.0 | Compound | 171.2 | 2.5 | 8.29 | 1.7 | 6.5 | 6.2 | 6.2 |
| | | A-11 | | B-1 | | | | | | | |
| Example 15 | 80 | Compound | 10.0 | Compound | 171.2 | 2.5 | 8.29 | 1.5 | 6.0 | 6.2 | 6.2 |
| | | A-26 | | B-1 | | | | | | | |
| Example 16 | 80 | Compound | 10.0 | Compound | 171.2 | 2.5 | 8.29 | 2.0 | 6.5 | 8.0 | 8.0 |
| | | A-28 | | B-1 | | | | | | | |
| Example 17 | 80 | Compound | 10.0 | Compound | 171.2 | 2.5 | 8.29 | 2.0 | 6.5 | 6.7 | 6.7 |
| | | A-28 | | B-1 | | | | | | | |
| Example 18 | 80 | Compound | 2.5 | Compound | 171.2 | 2.5 | 8.78 | 1.2 | 5.3 | 3.1 | 3.1 |
| | | A-29 | | B-1 | | | | | | | |
| Example 19 | 80 | Compound | 7.5 | Compound | 171.2 | 2.5 | 8.45 | 2.0 | 6.5 | 6.9 | 6.9 |
| | | A-30 | | B-1 | | | | | | | |
| Example 20 | 80 | Compound | 7.5 | Compound | 171.2 | 2.5 | 8.45 | 2.0 | 6.5 | 6.2 | 6.2 |
| | | A-39 | | B-1 | | | | | | | |
| Example 21 | 80 | Compound | 2.5 | Compound | 171.2 | 2.5 | 8.45 | 2.0 | 6.0 | 16.0 | 16.0 |
| | | A-23 | | B-1 | | | | | | | |
| Example 22 | 80 | Compound | 2.5 | Compound | 171.2 | 2.5 | 8.45 | 2.0 | 6.0 | 16.0 | 16.0 |
| | | A-43 | | B-1 | | | | | | | |
| Comparative | 80 | — | — | — | 171.2 | 2.5 | 8.45 | 0.4 | 7.0 | 25.0 | 25.0 |
| Example 2 | | | | | | | | | | | |

Table 2 confirms that the variation of Rth per unit thickness in response to variations in humidity in the transparent protective films of Examples 12 to 22 is much smaller than that in Comparative Example 2 and the transparent protective films are greatly improved.

### Example 23

### <Fabrication of First Polarizing Plate>

The transparent protective film of Example 1 was immersed for 2 min at 55° C. in an aqueous solution of sodium hydroxide with a normality of 1.5. The transparent protective film was then washed in a water washing bath at room temperature and neutralized by using sulfuric acid with a normality of 0.1 at 30° C. The film was then again washed in the water washing bath at room temperature and dried with an air flow at 100° C. The surface of the transparent protective film of Example 1 was thus saponified.

A rolled poly(vinyl alcohol) film with a thickness of 80 μm was then continuously subjected to fivefold stretching in a iodine aqueous solution and dried to obtain a polarizing film.

Then, a 3% aqueous solution of poly(vinyl alcohol) (PVA-117H, manufactured by Kuraray Co., Ltd.) was used as an adhesive, two transparent protective films subjected to alkali saponification in the above-described manner were prepared, and the polarizing film was placed between the transparent protective films and adhesively bonded thereto with the adhesive to obtain a first polarizing plate in which both surfaces were protected with the transparent protective film of Example 1. The arrangement of the transparent protective films with respect to the polarizing film was such that the slow axis of each transparent protective film was parallel to the transmission axis of the polarizing axis.

### Example 24

### <Fabrication of First Polarizing Plate>

The first polarizing plate was prepared in the same manner as in Example 23, except that the transparent protective film of Example 1 in Example 23 was replaced with the transparent protective film of Example 12.

### Comparative Examples 3 to 4

<Fabrication of First Polarizing Plate>p The first polarizing plates were prepared in the same manner as in Example 23, except that the transparent protective film of Example 1 in Example 23 was replaced with the transparent protective film of Comparative Example 1 and Comparative Example 2, respectively.

The transparent protective films of Comparative Examples 3 to 4 had sufficient adhesivity to the stretched poly(vinyl alcohol) and demonstrated excellent suitability for polarizing plate processing.

### Example 25

### <Fabrication of Second Polarizing Plate>

A polarizing film was produced by causing adsorption of iodine on a stretched poly(vinyl alcohol) film, and the transparent protective film produced in Example 1 was pasted on one surface side of this polarizing film by using a poly(vinyl alcohol) adhesive.

The second polarizing plate was then fabricated by subjecting a commercial cellulose acetate film (Fujitack TF80UL, manufactured by FUJIFILM Corp.) to saponification treatment and pasting it on the other surface side of the polarizing film by using the poly(vinyl alcohol) adhesive.

### Example 26

### <Fabrication of Second Polarizing Plate>

The second polarizing plate was prepared in the same manner as in Example 25, except that the transparent protective film of Example 1 used in Example 25 was replaced with the transparent protective film of Example 12.

### Comparative Examples 5 to 6

### <Fabrication of Second Polarizing Plate>

The second polarizing plates were prepared in the same manner as in Example 25, except that the transparent protective film of Example 1 used in Example 25 was replaced with the transparent protective films of Comparative Example 1 and Comparative Example 2.

### Comparative Example 7

### <Fabrication of Third Polarizing Plate>

The third polarizing plate was prepared in the same manner, except that the commercial cellulose acetate film (Fujitack TF80UL, manufactured by FUJIFILM Corp.) was provided on both surfaces in the method for fabricating the first polarizing plate of Example 25.

### Example 27

### <Fabrication of IPS-Mode Liquid Crystal Display Device>

### <<Fabrication of IPS-Mode Liquid Crystal Cell 1>>

Electrodes were arranged on a glass substrate so that the distance between the adjacent electrodes was 20 μm, a polyimide film was provided as an alignment film thereon, and rubbing was performed. A polyimide film was also provided on one surface of a separately prepared glass substrate and rubbing was performed to obtain an alignment film.

The two glass substrates were stacked so that the alignment films faced each other, the spacing (gap: d) between the substrates was 3.9 μm, and rubbing directions of the two glass substrates were parallel, and a nematic liquid crystal composition with a refractive index anisotropy (Δn) of 0.0769 and a positive dielectric constant anisotropy (Δε) of 4.5 was enclosed between the substrates. The value of d·Δn of the liquid crystal layer was 300 nm.

The first polarizing plate of Example 23 was then pasted on one side of the IPS-mode liquid crystal cell fabricated in the above-described manner, so that the absorption axis of the first polarizing plate was parallel to the rubbing direction of the liquid crystal cell and so that the transparent protective film in accordance with the present invention was on the side of the liquid crystal cell.

The second polarizing plate of Example 25 was then pasted in a cross-nicol arrangement on the other side of the IPS-mode liquid crystal cell, and an IPS-mode liquid crystal display device of Example 27 was fabricated such that the backlight was disposed on the side of the first polarizing plate of Example 23.

### Example 28

### <Fabrication of IPS-Mode Liquid Crystal Display Device>

An IPS-mode liquid crystal display device of Example 28 was fabricated in the same manner as in Example 27, except that the first polarizing plate of Example 23 used in Example 27 was replaced with the first polarizing plate of Example 24, and the second polarizing plate of Example 25 used in Example 27 was replaced with the second polarizing plate of Example 26.

### Comparative Examples 8 to 9

### <Fabrication of IPS-Mode Liquid Crystal Display Device>

IPS-mode liquid crystal display devices of Comparative Examples 8 to 9 were fabricated in the same manner as in Example 27, except that the first polarizing plate of Example 23 used in Example 27 was replaced with the first polarizing plate of Comparative Examples 3 to 4, respectively, and the second polarizing plate of Example 25 used in Example 27 was replaced with the second polarizing plate of Comparative Examples 5 to 6, respectively.

### Comparative Example 10

### <Fabrication of IPS-Mode Liquid Crystal Display Device>

An IPS-mode liquid crystal display device of Comparative Example 10 was fabricated in the same manner as in Example 27, except that the first polarizing plate of Example 23 used in Example 27 and the second polarizing plate of Example 25 were replaced with the third polarizing plate of Comparative Example 7.

### <Evaluation of Liquid Crystal Display Device>

The IPS-mode liquid crystal display devices of Examples 27 to 28 and Comparative Examples 8 to 10 fabricated in the above-described manner were humidity conditioned for one week at 60% RH, and then the variation (Δuv) in black color in the full azimuth direction at a polar angle of 60 degree was measured. The measurement results are shown in Table 3.

As shown in Table 3, in the liquid crystal display devices of Examples 27 to 28 and Comparative Examples 8 to 9, Δuv was 0.05 or less and practically no color variations could be observed. By contrast, in the liquid crystal display device of Comparative Example 10, Δuv exceeded 0.05 and color variations were clearly seen.

Therefore, it was established that by using the transparent protective film in accordance with the present invention in which Re and Rth are small and wavelength dispersion of Re, and Rth is small, it is possible to improve color variation in the IPS-mode liquid crystal display device.

Similar measurements were performed after humidity conditioning the liquid crystal display devices of Examples 27 to 28 and Comparative Examples 8 to 10 for one week at 10% RH, and the variation of display characteristics in response to variations in ambient humidity was studied. The results obtained confirmed that, compared with the liquid crystal display devices of Comparative Examples 8 to 10, the liquid crystal display devices of Examples 27 to 28 were improved to a level such that practically no changes in the panel color and brightness were observed even when ambient humidity changes.

TABLE 3

| Liquid crystal display | Viewing | | Variation in |
|---|---|---|---|
| device | angle | Δcu‘v’ | humidity |
| Example 27 | 70° | 0.04 | Small |
| Example 28 | 70° | 0.04 | Small |
| Comparative Example 8 | 70° | 0.04 | Large |
| Comparative Example 9 | 70° | 0.05 | Large |
| Comparative Example | 70° | 0.07 | Large |
| 10 | | | |

### Example 29

### <Fabrication of IPS-Mode Liquid Crystal Display Device>

An optical compensation film was fabricated by uniaxially stretching a commercial Arton Film (manufactured by JSR Corp.), and the optical compensation film was pasted onto the first polarizing plate fabricated in Example 23 to provide it with an optical compensation function. At this time, the viewing angle characteristic can be improved, without changing the front characteristic in any way by setting the slow axis of in-plane retardation of the optical compensation film perpendicularly to the transmission axis of the first polarizing plate.

The optical compensation film with an in-plane retardation Re of 270 nm and a thickness-direction retardation Rth of 0 nm (Nz=0.5) was used.

Two laminates of the first polarizing plate and the optical compensation film were prepared, and a liquid crystal display device was fabricated by a process in which “the laminate of the first polarizing plate and the optical compensation film, the IPS-mode liquid crystal cell, and the laminate of the first polarizing plate and the optical compensation film” were laminated in the order of description so that the optical compensation films were disposed at respective sides of the liquid crystal cell.

In this process, the transmission axes of the upper and lower first polarizing plates were perpendicular to each other, and the transmission axis of the upper first polarizing plate was parallel to the long axis direction of the molecule of the liquid crystal cell (that is, the slow axis of the optical compensation layer and the long axis direction of the molecule were perpendicular to each other).

The liquid crystal cell, electrodes, and substrates that have been conventionally used in the IPS configuration can be directly employed. Liquid crystal cells with a horizontal alignment and liquid crystal with positive dielectric constant anisotropy that have been developed and marketed for IPS liquid crystals can be used.

The liquid crystal cell had the following physical properties: Δn of liquid crystal of 0.099, a cell gap of a liquid crystal of 3.0 μm, a pretilt angle of 5 degree, and a rubbing direction at 75° both below and above the substrate.

In the liquid crystal display devices fabricated in the above-described manner, a light leak ratio in a black display mode was measured in the azimuth direction of 45 degree and polar angle direction of 70 degree from the front surface of the liquid crystal display device. The smaller is this value, the smaller is the light leak in the direction tilted at 45 degree and the better is the contrast of the liquid crystal display device; the viewing angle characteristic of the liquid crystal display device can thus be evaluated. The results are shown in Table 4.

Table 4 confirms that when the polarizing plate of Example 29 was used, the viewing angle further widened and the black color variation (Δuv) further decreased by comparison with those obtained in Example 27 in which only the first polarizing plate of Example 23 was used.

TABLE 4

| Liquid crystal display | Viewing | | Variation in |
|---|---|---|---|
| device | angle | Δcu‘v’ | humidity |
| Example 27 | 70° | 0.04 | Small |
| Example 29 | >80° | 0.02 | Small |

### Example 30

### <Fabrication of OCB-Mode Liquid Crystal Display Device>

### <<Fabrication of λ/4 Wavelength Plate>>

A commercial Pureace WR W147 (manufactured by Teijin Corp.) was used as the λ/4 wavelength plate. The Re₍₅₅₀₎ of the λ/4 wavelength plate (film) was 140 nm.

### <<Fabrication of Biaxial Film>>

A biaxial film with Re₍₅₅₀₎ of 28 nm and Rth₍₅₅₀₎ of 275 nm was fabricated by stretching a commercial cycloolefin film (Zeonoa ZF14, manufactured by Optex Co., Ltd.) in a biaxial stretching machine.

A product (Re₂(λ)×Rth₂(λ)) of retardation Re₂(λ) and thickness-direction retardation Rth₂(λ) of the biaxial film were measured at wavelengths of 450 nm, 550 nm, and 630 nm. The respective results were 7,750, 7,700, and 7,700.

### <<Fabrication of OCB-Mode Liquid Crystal Cell>>

A glass substrate having ITO electrodes was provided with a polyimide film as an alignment film, and the alignment film was subjected to rubbing.

The obtained two glass substrates were set opposite each other so that the rubbing directions thereof were parallel, and the cell gap was set to 5.7 μm.

A bend alignment liquid crystal cell was then fabricated by injecting a liquid crystal compound (ZLI 1132, manufactured by Merck and Co., Inc.) with Δn of 0.1396 into the cell gap.

The product Δn×d of the fabricated liquid crystal cell was 796 nm. The size of the liquid crystal cell was 26 inches.

The fabricated λ/4 wavelength plate and biaxial film were disposed in the order of description on the first polarizing plate of Example 23 and joined by a pressure-sensitive adhesive.

Two first polarizing plates provided with the optically anisotropic layer that were thus fabricated were cross-nicol arranged so that the optically anisotropic layers were on the inner side and the liquid crystal cell was sandwiched therebetween.

At this time, the two first polarizing plates provided with the optically anisotropic layer were joined to the liquid crystal cell so that the angle between the transmission axis of the first polarizing plate equipped with the optically anisotropic layer and the slow axis of the λ/4 film was 45°, the in-plane slow axis of the biaxial film was perpendicular to the rubbing direction of the liquid crystal cell, and the angle between the in-plane slow axis of the biaxial film and the transmission axis of the polarizing plate was 45°, and an OCB-mode liquid crystal display device of Example 30 was fabricated. The Δnd of the liquid crystal cell of the liquid crystal display device was 796 nm.

### Example 31

### <Fabrication of OCB-Mode Liquid Crystal Device>

An OCB-mode liquid crystal display device of Example 31 was fabricated in the same manner as in Example 30, except that the first polarizing plate of Example 23 used in Example 30 was replaced with the first polarizing plate of Example 24.

### Comparative Examples 11 to 12

### <Fabrication of OCB-Mode Liquid Crystal Device>

OCB-mode liquid crystal display devices (26 inch) of Comparative Examples 11 to 12 were fabricated in the same manner as in Example 30, except that the first polarizing plate of Example 23 used in Example 30 was replaced with the first polarizing plate of Comparative Examples 3 to 4, respectively.

### Comparative Example 13

### <Fabrication of OCB-Mode Liquid Crystal Device>

An OCB-mode liquid crystal display device (26 inch) of Comparative Example 13 was fabricated in the same manner as in Example 30, except that the first polarizing plate of Example 23 used in Example 30 was replaced with the third polarizing plate of Comparative Example 7.

### <Evaluation of Viewing Angle>

The viewing angle was measured in the liquid crystal display devices of Examples 30 to 31 and Comparative Examples 11 to 13 in 8 stages from black display (L1) to white display (L8) by using a measurement device (EZ-Contrast 160D, manufactured by ELDIM Co., Ltd.). The devices were then exposed for 24 h to dry conditions at 80° C., and the panels were then lighted and visual and functional evaluation of light leak was carried out based on the following evaluation criteria. The results are shown in Table 5. The “dry conditions” as referred to herein indicate the condition of heating in an oven or the like at a relative humidity of about 0%.

### <<Evaluation Criteria>>

A: frame-like light leak was not observed.
B: frame-like light leak was observed.

TABLE 5

| | Viewing angle | | | |
|---|---|---|---|---|
| Liquid crystal display | | | Left- | Evaluation |
| device | Above | Below | right | results |
| Example 30 | 70° | 70° | 140° | A |
| Example 31 | 70° | 70° | 140° | A |
| Comparative Example | 70° | 70° | 140° | B |
| 11 | | | | |
| Comparative Example | 70° | 70° | 140° | B |
| 12 | | | | |
| Comparative Example | 55° | 55° | 100° | B |
| 13 | | | | |

The results presented in Table 5 confirm that the frame-like light leak in liquid crystal display devices of Examples 30 to 31 was improved over that of Comparative Examples 11 to 13.

Similar measurements were also conducted after conditioning the liquid crystal display devices of Examples 30 to 31 and Comparative Examples 11 to 13 for one week at a relative humidity of 60% RH, and then similar measurements were conducted after conditioning for one week at a relative humidity of 10% RH to study the variation of display characteristics in response to variations in ambient humidity. The results obtained confirmed that the variation of color and brightness of the panel in the liquid crystal display devices of Examples 30 to 31 in response to variations in ambient humidity was improved to an almost unnoticeable level by comparison with that of Comparative Examples 11 to 13.

### Example 32

### <Fabrication of Optical Compensation Film>

The transparent protective film fabricated in Example 1 was immersed for 5 min in a 1.5 N solution of potassium hydroxide (40° C.), then neutralized with sulfuric acid, washed with pure water, and dried. The surface energy of the transparent protective film measured by a contact angle method was 68 mN/m.

### <<Fabrication of Alignment Film>>

A coating liquid for forming an alignment film of the following composition was coated on the transparent protective film (alkali treated surface) at 28 mL/m² with a #16 wire bar coater. The coating was dried for 60 sec with hot air at 60° C. and then for 150 sec with hot air at 90° C. to form a film, and an alignment film was then produced by performing rubbing of the coated film in the direction at an angle of 45° to the slow axis of the transparent protective film (measurement at a wavelength of 632.8 nm).

[Composition of Coating Liquid for Alignment film]

| | | |
|---|---|---|
| Modified poly(vinyl alcohol) described below | 10 | parts by mass |
| Water | 371 | parts by mass |
| Methanol | 119 | parts by mass |
| Glutaraldehyde (crosslinking agent) | 0.5 | parts by mass |
| Citric acid ester (AS3, manufactured by Sankyo | 0.35 | part sby mass |
| Chemical Industries, Ltd.) | | |

Modified poly(vinyl alcohol)

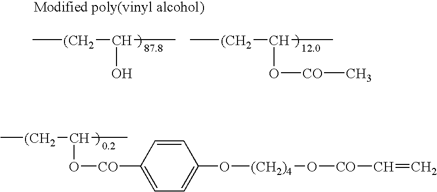

### <<Preparation of Liquid Crystal Compound>>

A coating liquid prepared by dissolving 43.5 wt. % below-described rod-like liquid crystal molecules (1), 43.5 wt. % below-described rod-like liquid crystal molecules (2), and 3 wt. % below-described photopolymerization initiator in chloroform was coated on the alignment film and heated for 3 min at 130° C. to cause the horizontal alignment of the rod-like liquid crystal molecules. The thickness of the formed coating layer was 1.0 μm.

The, rod-like liquid crystal molecules were then polymerized by ultraviolet irradiation with a mercury lamp at an illumination intensity of 500 W/cm².

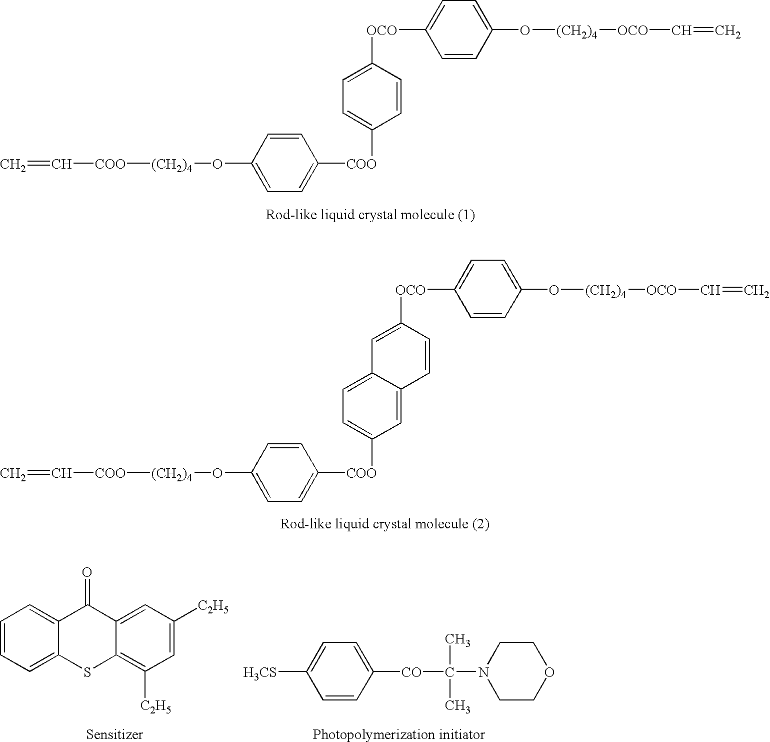

Then, a coating liquid with a concentration of solids of 38 wt. % was prepared by dissolving 90 parts by mass of the below-described disk-like liquid crystal molecules, 10 parts by mass of ethylene oxide-modified trimethylolpropane triacrylate (V #360, manufactured by Osaka Organic Chemistry Co., Ltd.), 0.6 parts by mass of melamine formaldehyde—acrylic acid copolymer (Aldrich reagent), 3.0 parts by mass of photopolymerization initiator (Irgacure 907, manufactured by Nippon Chiba Geigy Co., Ltd.), and 1.0 part by mass of photosensitizer (Kayacure DETX, manufactured by Nippon Kayaku KK) in methyl ethyl ketone.

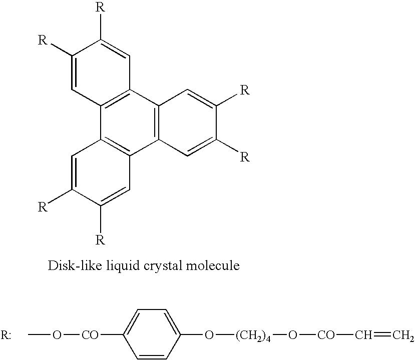

The prepared coating liquid was coated on the disk-like liquid crystal molecule layer and dried. The disk-like liquid crystal molecules were oriented by drying for 1 min at 130° C. Then, the coating was immediately cooled to room temperature and irradiated with ultraviolet radiation at 500 mJ/cm² to polymerize the disk-like liquid crystal molecules and fix the alignment state. The thickness of the formed disk-like liquid crystal molecule layer was 2.5 μm. An optical compensation film of Example 32 was thus fabricated.

### Example 33

### <Fabrication of Optical Compensation Film>

An optical compensation film of Example 33 was fabricated in the same manner as in Example 32, except that the transparent protective film of Example 1 that was used in Example 32 was replaced with the transparent protective film of Example 12.

### Comparative Examples 14 to 16

### <Fabrication of Optical Compensation Film>

Optical compensation films of Comparative Examples 14 to 15 were fabricated in the same manner as in Example 32, except that the transparent protective film of Example 1 that was used in Example 32 was replaced with the transparent protective films of Comparative Examples 1 to 2, respectively.

Re₍₅₅₀₎ of the entire optically anisotropic layer in these examples was 34 nm and Rth₍₅₅₀₎ was 250 nm.

Further, Re(λ)×Rth(λ) of the entire optically anisotropic layer at a wavelength of 450 nm, 550 nm, and 630 nm was 10,450, 8,500, and 7,360, respectively.

The product (Re_{—}1(λ)×Rth_{—}2(λ)) of the in-plane retardation Re_{—}1(λ) of the first optically anisotropic layer (a layer formed from the composition containing lo discotic liquid crystals) and the thickness-direction retardation Rth_{—}2(λ) of the second optically anisotropic layer (a layer formed from the composition containing rod-like liquid crystals) was 11,210, 9,180, and 8,120 at a wavelength of 450 nm, 550 nm, and 630 nm, respectively.

### Example 34

### <Fabrication of Fourth Polarizing Plate>

A polarizing film was fabricated by causing the adsorption of iodine on a stretched poly(vinyl alcohol) film.

Then, the optical compensation film of Example 32 was pasted onto one surface of the polarizing film by using a poly(vinyl alcohol) adhesive so that the transparent protective film of Example 1 was on the side of the polarizing film.

A commercial cellulose triacylate film (Fujitack TD80UF, manufactured by FUJIFILM Corp.) was subjected to saponification treatment and pasted on the other surface side of the polarizing film by using the poly(vinyl alcohol) adhesive. In this process, the transmission axis of the polarizing film and the slow axis of the commercial cellulose triacylate film were disposed so as to be perpendicular to each other. The fourth polarizing plate of Example 34 was thus fabricated.

### Example 35

### <Fabrication of Fourth Polarizing Plate>

The fourth polarizing plate of Example 35 was fabricated in the same manner as in Example 34, except that the transparent protective film of Example 1 that was used in Example 34 was replaced with the transparent protective film of Example 12.

### Comparative Examples 16 to 17

### <Fabrication of Fourth Polarizing Plate>

The fourth polarizing plates of Comparative Examples 16 to 17 were fabricated in the same manner as in Example 34, except that the optical compensation film of Example 32 that was used in Example 34 was replaced with the optical compensation films of Comparative Examples 14 to 15, respectively.

### Example 36

### <Fabrication of Liquid Crystal Display Device>

### <<Fabrication of Liquid Crystal Cell>>

A glass substrate having ITO electrodes was provided with a polyimide film as an alignment film, and the alignment film was subjected to rubbing.

The obtained two glass substrates were set opposite each other so that the rubbing directions thereof were parallel, and the cell gap was set to 9.7 μm.

A bend alignment liquid crystal cell was then fabricated by injecting a liquid crystal compound (ZLI 1132, manufactured by Merck and Co., Inc.) with Δn of 0.1396 into the cell gap. The product Δn×d of the fabricated liquid crystal cell was 1,354 nm. The size of the liquid crystal cell was 26 inches.

The polarizing plates fabricated in Example 34 were cross-nicol disposed so that the optically anisotropic layers of Example 32 were on the inner side, and a liquid crystal cell was sandwiched therebetween. The components were then pasted with a pressure-sensitive adhesive so that the in-plane slow axis of the optically anisotropic layer was perpendicular to the rubbing direction of the liquid crystal cell. A liquid crystal display device of Example 36 was thus fabricated.

### Example 37

### <Fabrication of Liquid Crystal Display Device>

A liquid crystal display device of Example 37 was fabricated in the same manner as in Example 36, except that the polarizing plate of Example 34 that was used in Example 36 was replaced with the polarizing plate of Example 35.

### Comparative Examples 18 to 19

### <Fabrication of Liquid Crystal Display Device>

Liquid crystal display devices of Comparative Examples 18 to 19 were fabricated in the same manner as in Example 36, except that the polarizing plate of Example 34 that was used in Example 36 was replaced with the polarizing plates of Comparative Examples 16 to 17, respectively.

### <<Measurement of Viewing Angle>>

A viewing angle was measured for the liquid crystal display devices of Examples 36 to 37 and Comparative Examples 18 to 19 that were thus fabricated in the same manner as it was measured for liquid crystal display devices of Examples 30 to 31 and Comparative Examples 11 to 13, and light leak was visually and functionally evaluated. The results are shown in Table 6.

TABLE 6

| | Viewing angle | | | |
|---|---|---|---|---|
| Liquid crystal display | | | Left- | Evaluation |
| device | Above | Below | right | results |
| Example 36 | 50° | 40° | 120° | A |
| Example 37 | 50° | 40° | 120° | A |
| Comparative Example | 50° | 40° | 120° | B |
| 18 | | | | |
| Comparative Example | 50° | 40° | 120° | B |
| 19 | | | | |

Similar measurements were also conducted after conditioning the liquid crystal display devices of Examples 36 to 37 and Comparative Examples 18 to 19 for one week at a relative humidity of 60% RH, and then similar measurements were conducted after conditioning for one week at a relative humidity of 10% RH to study the variation of display characteristics in response to variations in ambient humidity. The results obtained confirmed that the variation of color and brightness of the panel in the liquid crystal display devices of Examples 36 to 37 in response to variations in ambient humidity was improved to an almost unnoticeable level by comparison with that of Comparative Examples 18 to 19.

### Example 38

### <Fabrication of Optical Compensation Film>

A cellulose acetate solution was prepared by charging following composition into a mixing tank and stirring to dissolve the components.

[Composition of Cellulose Acetate Solution]

| | | |
|---|---|---|
| Cellulose acetate with a degree of acetylation | 100 | parts by mass |
| of 60.9% | | |
| Triphenyl phosphate (plasticizer) | 7.8 | parts by mass |
| Biphenyldiphenyl phosphate (plasticizer) | 3.9 | parts by mass |
| Methylene chloride (first solvent) | 300 | parts by mass |
| Methanol (second solvent) | 45 | parts by mass |
| Dye (360FP, manufactured by Sumika Fine | 0.0009 | parts by mass |
| Chemicals Co., Ltd.) | | |

A retardation increasing solution was prepared by charging 16 parts by mass of the below-described retardation increasing agent, 80 parts by mass of methylene chlorine, and 20 parts by mass of methanol into a separate mixing tank and stirring under heating.

A total of 36 parts by mass of the retardation increasing solution and 1.1 part by mass of silica fine particles (Aerosil R972) were mixed with 464 parts by mass of the cellulose acetate solution of the above-described composition, and the components were stirred thoroughly to prepare a dope. The amount added of the temperature increasing agent was 5.0 parts by mass per 100 parts by mass of the cellulose acetate. The amount added of silica fine particles was 0.15 parts by mass per 100 parts by mass of the cellulose acetate.

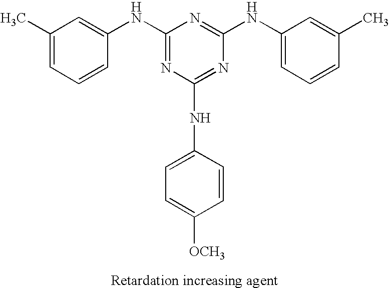

The dope obtained was cast by using a flow casting machine having a band with a width of 2 m and a length of 65 m. After the film surface temperature on the band has reached 40° C., the film was dried for 1 min, peeled off, and stretched to 28% in the width direction by using a tenter under a dry air at 140° C.

A support body PK-1 with a residual solvent amount of 0.3 wt. % was then obtained by drying for 20 min with dry air at 135° C.

The obtained support body PK-1 had a width of 1,340 mm and a thickness of 92 μm.

Re₍₅₉₀₎ and Rth₍₅₉₀₎ measured with an ellipsometer (M-150, manufactured by Nippon Bunko KK) were 38 nm and 175 nm, respectively.

A 1.0 N potassium hydroxide solution (solvent: water/isopropyl alcohol/propylene glycol=69.2 parts by mass/15 parts by mass/15.8 parts by mass) was coated at 10 mL/m² on the band surface side of the fabricated support body PK-1 and held for 30 sec at a temperature of about 40° C. The alkali solution was then wiped out, the support was washed with water, and water drops were removed with an air knife.

Then, drying was carried out for 15 sec at 100° C. The contact angle of the support body PK-1 with respect to pure water was found to be 42°.

### <<Fabrication of Alignment Film>>

A coating liquid for forming an alignment film of the following composition was coated on the support body PK-1 (alkali treated surface) at 28 mL/m² with a #16 wire bar coater. The coating was dried for 60 sec with hot air at 60° C. and then for 150 sec with hot air at 90° C. to form an alignment film.

[Composition of Coating Liquid for Alignment film}

| | | |
|---|---|---|
| Modified poly(vinyl alcohol) described below | 10 | parts by mass |
| Water | 371 | parts by mass |
| Methanol | 119 | parts by mass |
| Glutaraldehyde (crosslinking agent) | 0.5 | parts by mass |
| Citric acid ester (AS3, manufactured by | 0.35 | parts by mass |
| Sankyo Chemical Industries, Ltd.) | | |

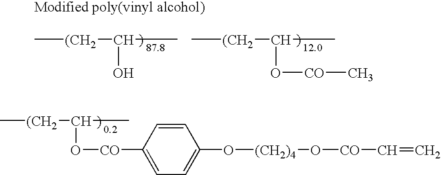

### <Rubbing Treatment>

The support body PK-1 was conveyed at a speed of 20 m/min in the lengthwise direction, a rubbing roll (diameter 300 mm) was set so as to perform rubbing at an angle of 45° with respect to the lengthwise direction, and the surface of the support body PK-1 where the alignment film was disposed was subjected to rubbing at a rubbing roll rotation rate of 650 rpm. The contact length of the rubbing roll and the support body PK-1 was set to 18 mm.

### <Formation of Optically Anisotropic Layer>

A coating liquid was prepared by dissolving 41.01 kg of the below-described discotic liquid crystal composition, 4.06 kg of ethylene oxide-modified trimethylolpropane triacrylate (V #36, manufactured by Osaka Organic Chemistry Co., Ltd.), 0.45 kg of cellulose acetate butyrate (CAB531-1, manufactured by Eastman Chemical Co., Ltd.), 1.35 kg of photopolymerization initiator (Irgacure 907, manufactured by Chiba Geigy Co., Ltd.), and 0.45 kg of photosensitizer (Kayacure DETX, manufactured by Nippon Kayaku KK) in 102 kg of methyl ethyl ketone, then 0.1 kg of fluoroaliphatic group-containing copolymer (Megafac F780, manufactured by Dainippon Ink and Chemicals, Inc.) was added to the coating solution and the resultant composition was continuously coated on the alignment film surface of the support body PK-1 that was conveyed at a speed of 20 m/min, while rotating the #3.0 wire bar at 391 rpm in the same direction as the conveying direction of the film.

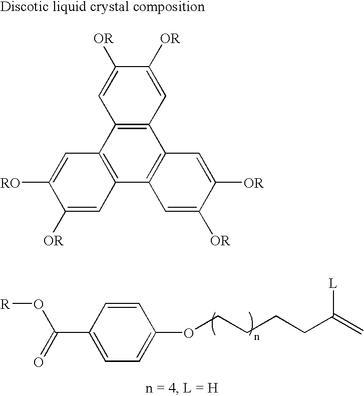

The solvent was dried in the process of continuously heating from room temperature to 100° C., and then heating was performed for about 90 sec in the drying zone with a temperature of 130° C. so that the air flow rate at the film surface of the discotic liquid crystal compound layer was 2.5 m/sec and the flow was parallel to the film conveying direction. As a result, the discotic liquid crystal compound was oriented.

The film was then conveyed into a drying zone with a temperature of 80° C. and irradiated for 4 sec with ultraviolet radiation at an illumination intensity of 600 mW with an ultraviolet radiation irradiation device (ultraviolet radiation lamp: output 160 W/cm, emission length 1.6 m) in a state in which the surface temperature of the film was about 100° C., thereby enhancing the crosslinking reaction and fixing the alignment of the discotic liquid crystal compound.

The film was then naturally cooled to room temperature and coiled into a cylindrical shape to obtain a roll-like form.

A roll-shaped optical compensation film KH-1 was thus produced in which an optically anisotropic layer KI-1 was formed on the support body PK-1.

The film surface temperature of the discotic liquid crystal compound layer was 127° C., and the layer viscosity at this temperature was 695 cp. The viscosity was measured with an E-type viscosity system by heating the liquid crystal layer (solvent was removed) of the same composition as the aforementioned layer.

Part of the produced roll-shaped optical compensation film KH-1 was cut out and used as a sample to measure optical properties. The retardation value Re of the optically anisotropic layer measured at a wavelength of 546 nm was as follows: Re(0°)=30.5 nm, Re(40°)=44.5 nm, Re(−40°)=107.5 nm.

The angle (tilt angle) between the disk surface of the discotic liquid crystal compound in the optically anisotropic layer and the support body surface changed continuously in the layer thickness direction, and the average value thereof was 32°.

Only the optically anisotropic layer was then peeled off from the sample, and the average direction of the molecule symmetry axis of the optically anisotropic layer was measured. This direction was at an angle 45° to the lengthwise direction of the optically anisotropic layer KI-1.

### <Transfer of Optically Anisotropic Layer>

A pressure-sensitive adhesive was coated on one surface of the transparent protective film fabricated in Example 1, and the film was pasted on the optical compensation film (KH-1) on the side of the discotic liquid crystal compound layer. Then, only PK-1 was peeled off to obtain an optical compensation film of Example 38 in which the optically anisotropic layer KI-1 was laminated on one surface of the transparent protective film.

### Example 39

### <Fabrication of Optical Compensation Film>

An optical compensation film of Example 39 was fabricated in the same manner as in Example 38, except that the transparent protective film of Example 1 that was used in Example 38 was replaced with the transparent protective film of Example 12.

### Comparative Examples 20 to 21

### <Fabrication of Optical Compensation Film>

Optical compensation films of Comparative Examples 20 to 21 were fabricated in the same manner as in Example 38, except that the transparent protective film of Example 1 that was used in Example 38 was replaced with the transparent protective films of Comparative Examples 1 to 2, respectively.

### Example 40

### <Fabrication of Fifth Polarizing Plate>

A roll-shaped poly(vinyl alcohol) film with a thickness of 80 μm was continuously subjected to fivefold stretching in an aqueous solution of iodine and dried to obtain a polarizing film.

The optical compensation film of Example 38 was then immersed for 2 min at 55° C. into a 1.5 N aqueous solution of sodium hydroxide, washed in a water washing bath at room temperature, and neutralized by using 0.1 N sulfuric acid at 30° C. The film was then again washed in a waster washing bath at room temperature and then dried with hot air flow at 100° C. The optical compensation film of Example 38 that was thus subjected to alkali saponification on the surface thereof was pasted onto one surface of the polarizing film so that the optically anisotropic layer side of the optical compensation film faced the polarizing film.

A commercial cellulose triacylate film (Fujitac TD80UF, manufactured by FUJIFILM Corp.) that was subjected to saponification was then pasted onto the other surface of the polarizing film by using a 3% aqueous solution of poly(vinyl alcohol) (PVA-117H, manufactured by Kuraray Co., Ltd.) as an adhesive. In this process, the transmission axis of the polarizing film and the slow axis of the commercial cellulose triacylate film were disposed so as to be perpendicular to each other. The fifth polarizing plate of Example 40 was thus fabricated.

### Example 41

### <Fabrication of Fifth Polarizing Plate>

The fifth polarizing plate of Example 41 was fabricated in the same manner as in Example 40, except that the optical compensation film of Example 38 that was used in Example 40 was replaced with the optical compensation film of Example 39.

### Comparative Examples 22 to 23

### <Fabrication of Fifth Polarizing Plate>

The fifth polarizing plates of Comparative Examples 22 to 23 were fabricated in the same manner as in Example 40, except that the optical compensation film of Example 38 that was used in Example 40 was replaced with the optical compensation film of Comparative Examples 20 to 21, respectively.

### Example 42

### <Fabrication of Liquid Crystal Display Device>

A glass substrate having ITO electrodes was provided with a polyimide film as an alignment film, and the alignment film was subjected to rubbing. The obtained two glass substrates were set opposite each other so that the rubbing directions thereof were parallel, and the cell gap was set to 4.3 μm. A bend alignment liquid crystal cell was then fabricated by injecting a liquid crystal compound (ZLI 1132, manufactured by Merck and Co., Inc.) with Δn of 0.1396 into the cell gap. The size of the liquid crystal cell was 26 inches.

Two fifth polarizing plates fabricated in Example 40 were cross-nicol arranged so that the laminated films were on the inner side, and a liquid crystal cell was sandwiched therebetween.

The components were then pasted with a pressure-sensitive adhesive so that the in-plane slow axis of the optically anisotropic layer was perpendicular to the rubbing direction of the liquid crystal cell. An OCB-mode liquid crystal display device of Example 42 was thus fabricated.

### Example 43

### <Fabrication of Liquid Crystal Display Device>

A liquid crystal display device of Example 43 was fabricated in the same manner as in Example 42, except that the polarizing plate of Example 40 that was used in Example 42 was replaced with the polarizing plate of Example 41.

### Comparative Examples 24 to 25

### <Fabrication of Liquid Crystal Display Device>

Liquid crystal display devices of Comparative Examples 24 to 25 were fabricated in the same manner as in Example 42, except that the polarizing plate of Example 40 that was used in Example 42 was replaced with the polarizing plates of Comparative Examples 22 to 23, respectively.

### <<Measurement of Viewing Angle>>

The viewing angle was measured in the OCB-mode liquid crystal display devices of Examples 42 to 43 and Comparative Examples 24 to 25 in 8 stages from black display (L1) to white display (L8) by using a measurement device (EZ-Contrast 160D, manufactured by ELDIM Co., Ltd.).

The devices were then exposed for 24 h to dry conditions at 80° C., and visual and functional evaluation of light leak was carried out by a lighting method. The results are shown in Table 7.

TABLE 7

| Liquid crystal display | Viewing angle | | | Evaluation |
|---|---|---|---|---|
| device | Above | Below | Left-right | results |
| Example 42 | >80° | >80° | >160° | A |
| Example 43 | >80° | >80° | >160° | A |
| Comparative Example | >80° | >80° | >160° | B |
| 24 | | | | |
| Comparative Example | >80° | >80° | >160° | B |
| 25 | | | | |

Similar measurements were also conducted after conditioning the liquid crystal display devices of Examples 42 to 43 and Comparative Examples 24 to 25 for one week at a relative humidity of 60% RH, and then similar measurements were conducted after conditioning for one week at a relative humidity of 10% RH to study the variation of display characteristics in response to variations in ambient humidity. The results obtained confirmed that the variation of color and brightness of the panel in the liquid crystal display devices of Examples 42 to 43 in response to variations in ambient humidity was improved to an almost unnoticeable level by comparison with that of Comparative Examples 24 to 25.

### Example 44

### <<Fabrication of Optical Compensation Film (Optically Anisotropic Layer) A1>>

An aqueous solution of sodium hydroxide and ion-exchange water were poured into a reaction vessel equipped with a stirrer, a thermometer, and a reflux cooler, the monomer A and monomer B of the below-described structure were dissolved at a ratio of 55 mol % of the former to 45 mol % of the latter, and a small amount of hydrosulfide was added.

Methylene chloride was then added and phosgene was blown into the vessel for about 60 min at 20° C.

Then, p-tert-butylphenol was added and emulsification was performed, followed by the addition of triethylamine and stirring for about 3 h at 30° C. to complete the reaction.

Upon completion of the reaction, the organic phase was fractionated and a polycarbonate copolymer was obtained upon evaporation of methylene chloride. The composition ratio of the obtained copolymer was almost identical to the ratio of charged monomers.

The copolymer was dissolved in methylene chloride to obtain a dope solution with a concentration of solids of 15 wt. %.

The dope solution was cast with a band flow casting machine to produce a film that was stretched transversely by 21% with a tenter at a temperature of 210° C., thereby producing an optically anisotropic layer A1 as an optical compensation film. The thickness after stretching was 83 μm. Re₍₄₅₀₎, Re₍₅₉₀₎, Re₍₆₅₀₎, Rth₍₄₅₀₎, Rth₍₅₉₀₎, Rth₍₆₅₀₎ of the optically anisotropic layer A1 were measured. The results are shown in Table 8.

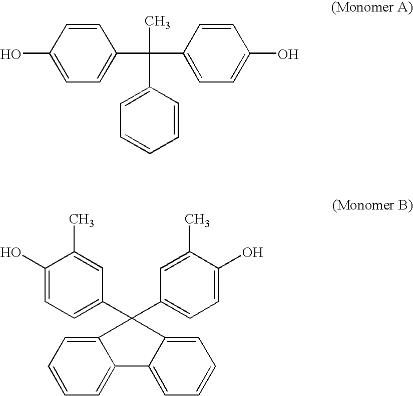

### <Fabrication of Optical Compensation Film AC1>

A polyimide synthesized from 2,2′-bis(3,4-dicarboxyphenyl)hexafluoropropane and 2,2′-bis(trifluoromethyl)-4,4′-dioaminobiphenyl was dissolved in cyclohexanone to prepare a 15 wt. % polyimide solution.

The polyimide solution was coated to a film thickness of 1.8 μm after drying on the surface of the optically anisotropic layer A1 subjected to corona discharge treatment with a solid-state corona treatment device 6KVA (manufactured by Pillar Corp.), and the coating was dried for 5 min at 150° C. to produce an optical compensation film AC1 having formed thereon an optically anisotropic layer C1 composed of the polyimide.

The polyimide solution was coated to a film thickness of 1.8 μm after drying on a glass substrate that was prepared separately, and the coating was dried for 5 min at 150° C. to produce an optically anisotropic layer C1G composed of the polyimide. Re₄₅₀, Re₅₉₀, Re₆₅₀, Rth₄₅₀, Rth₅₉₀, and Rth₆₅₀ of the optically anisotropic layer C1G were measured. The results are shown in Table 8.

### <Fabrication of Sixth Polarizing Plate>

A poly(vinyl alcohol) (PVA) film with a thickness of 80 μm was dyed by immersing for 60 sec at 30° C. into a iodine aqueous solution with a iodine concentration of 0.05 wt. % and then immersed for 60 set into an aqueous solution of boric acid with a boric acid concentration of 4 wt. %. In the latter immersion process, the film was stretched longitudinally to a length that was fivefold the original length and then dried for 4 min at 50° C. to obtain a polarizer with a thickness of 20 μm.

The transparent protective film fabricated in Example 1 and a commercial protective film CVL-02 (manufactured by FUJIFILM Corp.) having an antiglare reflective layer on a triacetyl cellulose film were immersed into an aqueous solution of sodium hydroxide that had a concentration of 1.5 mol/L and a temperature of 55° C., and sodium hydroxide was then washed away thoroughly with water.

The films were then immersed for 1 min into a diluted aqueous solution of sulfuric acid with a concentration of 0.005 mol/L and a temperature of 35° C., and then immersed into water to wash away the diluted aqueous solution of sulfuric acid. Finally, the samples were dried thoroughly at 120° C.

The transparent protective film of Example 1 and the commercial protective film CVL-02 having an antiglare reflective layer that were thus subjected to saponification treatment were pasted by using a poly(vinyl alcohol) adhesive so as to sandwich the polarizer. A sixth polarizing plate was thus produced. The protective film CVL-02 having an antiglare reflective layer was pasted onto the polarizer so that the triacetyl cellulose film was on the side of the polarizer.

The optical compensation film AC1 was pasted via an acrylic pressure-sensitive adhesive onto the transparent protective film of Example 1 of the sixth polarizing plate so that the optically anisotropic layer A1 was on the side of the pressure-sensitive adhesive, thereby producing a sixth polarizing plate of Example 44.

An acrylic pressure-sensitive adhesive was also coated on the optical compensation film AC1 on the side of the optically anisotropic layer C1.

Because the polarizer and the protective films for both sides of the polarizer have been fabricated in the form of rolls, the lengthwise directions of the rolled films were parallel to each other and the pasting was conducted in a continuous mode. The slow axis of the optically anisotropic layer A1 and the transmission axis of the polarizer were parallel to each other.

### Example 45

### <Fabrication of Sixth Polarizing Plate>

The sixth polarizing plate of Example 45 was fabricated in the same manner as in Example 44, except that the transparent protective film of Example 1 that was used in Example 44 was replaced with the transparent protective film of Example 12.

### Example 46

### <Fabrication of Sixth Polarizing Plate>

The sixth polarizing plate of Example 46 was fabricated in the same manner as in Example 44, except that the protective film CVL-02 used in Example 44 was replaced with a commercial triacetyl cellulose film (Fujitac TFY80UL, manufactured by FUJIFILM Corp.). The results obtained in measuring optical properties of the film Fujitac TFY80UL are shown in Table 8.

### Example 47

### <Fabrication of Sixth Polarizing Plate>

The sixth polarizing plate of Example 47 was fabricated in the same manner as in Example 44, except that the transparent protective film of Example 1 that was used in Example 44 was replaced with the transparent protective film of Example 12, and the protective film CVL-02 used in Example 44 was replaced with a commercial triacetyl cellulose film (Fujitac TFY80UL, manufactured by FUJIFILM Corp.).

### Comparative Examples 26 to 27

### <Fabrication of Sixth Polarizing Plate>

The sixth polarizing plates of Comparative Examples 26 to 27 were fabricated in the same manner as in Example 44, except that the transparent protective film of Example 1 that was used in Example 44 was replaced with the transparent protective films of Comparative Examples 1 to 2, respectively.

### Comparative Example 28

### <Fabrication of Sixth Polarizing Plate>

sixth polarizing plate of Comparative Example 28 was fabricated in the same manner as in Example 44, except that that the transparent protective film of Example 1 that was used in Example 44 was replaced with a commercial triacetyl cellulose film (Fujitac TFY80UL, manufactured by FUJIFILM Corp.).

### Comparative Examples 29 to 30

### <Fabrication of Sixth Polarizing Plate>

The sixth polarizing plates of Comparative Examples 29 to 30 were fabricated in the same manner as in Comparative Examples 26, 27, except that the protective film CVL-02 used in Comparative Examples 26, 27 was replaced with a commercial triacetyl cellulose film (Fujitac TFY80UL, manufactured by FUJIFILM Corp.).

### Comparative Example 31

### <Fabrication of Sixth Polarizing Plate>

The sixth polarizing plate of Comparative Example 31 was fabricated in the same manner as in Example 44, except that the transparent protective film of Example 1 used in Example 44 and the protective film CVL-02 were replaced with a commercial triacetyl cellulose film (Fujitac TFY80UL, manufactured by FUJIFILM Corp.).

### Example 48

### <Fabrication of VA-Mode Liquid Crystal Display Device>

The polarizing plate fabricated in Example 44 was punched to a 26-inch-wide size (screen ratio 16:9), so that the absorption axis of the polarizer served as a long side.

The polarizing plate fabricated in Example 46 was punched to a 26-inch-wide size, so that the absorption axis of the polarizer served as a short side.

Front and rear polarizing plates and a phase difference plate disposed in a liquid crystal cell of a VA-mode liquid crystal TV (KDL-L26HVX, manufactured by Sony Corp.) were peeled off, and a liquid crystal display device of Example 48 was fabricated by disposing the polarizing plate fabricated in Example 44 and punched out as described above on the viewing side of the liquid crystal cell and disposing the polarizing plate fabricated in Example 46 and punched out as described above on the backlight side of the liquid crystal cell.

When the polarizing plates were disposed, they were pasted on the liquid crystal cell and then held for 20 min at a temperature of 50° C. under a pressure of 5 kg/cm² to bond the components. In this process, the polarizing plates were disposed so that the absorption axis of the polarizing plate on the viewing side (polarizing plate fabricated in Example 44) was in the horizontal direction of the panel, the absorption axis of the polarizing plate on the backlight side (polarizing plate fabricated in Example 46) was in the direction perpendicular to the panel, and the pressure-sensitive adhesive side was on the liquid crystal cell side.

The viewing angle (range in which the contrast ratio is 20 or more) was calculated for the liquid crystal display device of Example 48 fabricated in the above-described manner from the brightness measurements of black display and white display conducted by using a measurement device (EZ-Contrast 160D, manufactured by ELDIM Co., Ltd.). The viewing angle in the direction of an azimuth of 45 degree is shown, as a result of such calculations, in Table 9.

Color measurements in a u′ v′ chromaticity diagram of black display were performed with respect to the liquid crystal display device of Example 48, and a color variation index ΔCu′v′ defined by the following formula was calculated from the measured values of chromaticity (u′₀, v′₀) in the direction normal to the panel (polar angle 0 degree) and chromaticity (u′₆₀, v′₆₀) in the direction (polar angle 60 degree) tilted by 60 degree from the direction normal to the panel to the panel surface at an azimuth turned counterclockwise through 45 degree from the direction parallel to the screen (azimuth angle 45 degree). The results are shown in Table 9.

ΔCu′v′=((u′₀−u′₆₀)²−(v′₀−v′₆₀)²)^{0.5}.

Similar measurements were also conducted after conditioning the liquid crystal display device of Example 48 for one week at a relative humidity of 60% RH, and then similar measurements were conducted after conditioning for one week at a relative humidity of 10% RH. The results obtained by visually observing the variation of display characteristics in response to variations in ambient humidity are shown in Table 9.

### Example 49

### <Fabrication of Liquid Crystal Display Device>

The liquid crystal display device of Example 49 was fabricated in the same manner as in Example 48, except that the polarizing plate of Example 44 that was used in Example 48 was replaced with the polarizing plate of Example 45, and the polarizing plate of Example 46 that was used in Example 48 was replaced with the polarizing plate of Example 47.

Similarly to Example 48, the calculated viewing angle and color variation index ΔCu′v′ and also the variation of display characteristic in response to variations in ambient humidity are shown in Table 9.

### Comparative Example 32

### <Fabrication of Liquid Crystal Display Device>

The liquid crystal display device of Comparative Example 32 was fabricated in the same manner as in Example 48, except that the polarizing plate of Example 44 that was used in Example 48 was replaced with the polarizing plate of Comparative Example 26, and the polarizing plate of Example 46 that was used in Example 48 was replaced with the polarizing plate of Comparative Example 29.

Similarly to Example 48, the calculated viewing angle and color variation index ΔCu′v′ and also the variation of display characteristic in response to variations in ambient humidity are shown in Table 9.

### Comparative Example 33

### <Fabrication of Liquid Crystal Display Device>

The liquid crystal display device of Comparative Example 33 was fabricated in the same manner as in Example 48, except that the polarizing plate of Example 44 that was used in Example 48 was replaced with the polarizing plate of Comparative Example 27, and the polarizing plate of Example 46 that was used in Example 48 was replaced with the polarizing plate of Comparative Example 30.

Similarly to Example 48, the calculated viewing angle and color variation index ΔCu′v′ and also the variation of display characteristic in response to variations in ambient humidity are shown in Table 9.

### Comparative Example 34

### <Fabrication of Liquid Crystal Display Device>

The liquid crystal display device of Comparative Example 34 was fabricated in the same manner as in Example 48, except that the polarizing plate of Example 44 that was used in Example 48 was replaced with the polarizing plate of Comparative Example 28, and the polarizing plate of Example 46 that was used in Example 48 was replaced with the polarizing plate of Comparative Example 31.

Similarly to Example 48, the calculated viewing angle and color variation index ΔCu′v′ and also the variation of display characteristic in response to variations in ambient humidity are shown in Table 9.

As shown in Table 9, the viewing angle characteristic of the liquid crystal display devices of Examples 48 to 49 was improved over that of liquid crystal display devices of Comparative Examples 32 to 34. Further, the variation in color occurring when the viewing angle is tilted from the front in a black display mode was also improved, and the possibility of obtaining a liquid crystal display device with small variation of characteristic in response to variations in ambient humidity was confirmed.

### Example 50

### <Fabrication of Optical Compensation Film AC2>

The surface of the optically anisotropic layer A1 fabricated in Example 44 was subjected to corona discharge treatment with a solid-state corona treatment device 6KVA (manufactured by Pillar Corp.) and coated at 24 mL/m² with a coating solution for an alignment film of the below-described composition by using a #14 wire bar coater. The coating was dried for 60 see with a hot air flow at 60° C. and then for 150 sec with a hot air flow at 90° C. to form an alignment film on the surface of the optically anisotropic layer A1.

[Composition of Coating Liquid for Alignment film]

| | | |
|---|---|---|
| Modified poly(vinyl alcohol) described below | 40 | parts by mass |
| Water | 728 | parts by mass |
| Methanol | 228 | parts by mass |
| Glutaraldehyde (crosslinking agent) | 2 | parts by mass |
| Citric acid ester (AS3, manufactured by Sankyo | 0.69 | parts by mass |
| Chemical Industries, Ltd.) | | |

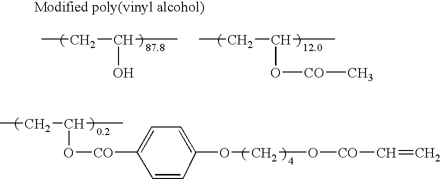

Then, a coating liquid was prepared by dissolving 41.01 parts by mass of the below-described disk-like liquid crystal molecules, 4.06 parts by mass of ethylene oxide-modified trimethylolpropane triacrylate (V #360, manufactured by Osaka Organic Chemistry Co., Ltd.), 1.35 parts by mass of photopolymerization initiator (Irgacure 907, manufactured by Chiba Geigy Co., Ltd.), 0.45 parts by mass of photosensitizer (Kayacure DETX, manufactured by Nippon Kayaku KK) in methyl ethyl ketone, and 0.12 parts by mass of the below-described melamine polymer in 75 parts by mass of methyl ethyl ketone, then 0.1 part by mass of fluoroaliphatic group-containing copolymer (Megafac F780, manufactured by Dainippon Ink and Chemicals, Inc.) was added to the coating solution and the resultant composition was continuously coated on the alignment film surface of the optically anisotropic layer A1 that was conveyed at a speed of 20 m/min, while rotating the #2.8 wire bar at 391 rpm in the same direction as the conveying direction of the film.

The solvent was dried in the process of continuously heating from room temperature to 100° C., and then heating was performed for about 90 sec in the drying zone with a temperature of 135° C. so that air flow rate at the film surface of the discotic liquid crystal compound layer was 1.5 m/sec and the flow was parallel to the film conveying direction. As a result, the discotic liquid crystal compound was oriented.

The film was then conveyed into a drying zone with a temperature of 80° C. and irradiated for 4 sec with ultraviolet radiation at an illumination intensity of 600 mW with an ultraviolet radiation irradiation device (ultraviolet radiation lamp: output 160 W/cm, emission length 1.6 m) in a state in which the surface temperature of the film was about 100° C., thereby enhancing the crosslinking reaction and fixing the alignment of the discotic liquid crystal compound.

The film was then naturally cooled to room temperature and coiled into a cylindrical shape to obtain a roll-like form, thereby producing an optical compensation film AC2 including the optically anisotropic layer A1 and optically anisotropic layer C2.

An optically anisotropic layer C2G composed of the discotic liquid crystal compound was fabricated by forming the alignment film and the optically anisotropic layer C2 on the separately prepared glass substrate, instead of the optically anisotropic layer A1 subjected to corona treatment, and Re₄₅₀, Re₅₉₀, Re₆₅₀, Rth₄₅₀, Rth₅₉₀, Rth₆₅₀ of the optically anisotropic layer C2G were measured. The results are shown in Table 8.

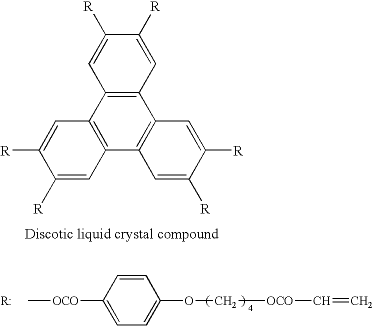

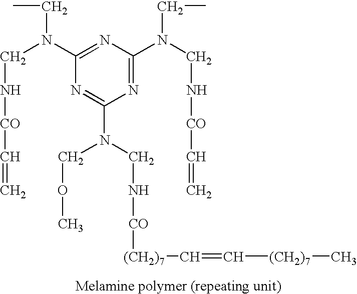

### <Fabrication of Seventh Polarizing Plate>

The seventh polarizing plate of Example 50 was fabricated in the same manner as in Example 44, except that AC1 was replaced with AC2 in the optical compensation film of Example 44. An acrylic pressure-sensitive adhesive was then also coated on the optical compensation film AC2 on the side of the optically anisotropic layer C2. Because the polarizer and the protective films for both sides of the polarizer have been fabricated in the form of rolls, the lengthwise directions of the rolled films were parallel to each other and the pasting was conducted in a continuous mode. The slow axis of the optically anisotropic layer A1 and the transmission axis of the polarizer were parallel to each other.

### Example 51

### <Fabrication of Seventh Polarizing Plate>

The seventh polarizing plate of Example 51 was fabricated in the same manner as in Example 51, except that the transparent protective film of Example 1 that was used in Example 50 was replaced with the transparent protective film of Example 12.

### Example 52

### <Fabrication of Seventh Polarizing Plate>

The seventh polarizing plate of Example 52 was fabricated in the same lo manner as in Example 50, except that the protective film CVL-02 used in Example 50 was replaced with a commercial triacetyl cellulose film (Fujitac TFY80UL, manufactured by FUJIFILM Corp.).

### Example 53

### <Fabrication of Seventh Polarizing Plate>

The seventh polarizing plate of Example 53 was fabricated in the same manner as in Example 50, except that the transparent protective film of Example 1 that was used in Example 50 was replaced with the transparent protective film of Example 12, and the protective film CVL-02 was replaced with a commercial triacetyl cellulose film (Fujitac TFY80UL, manufactured by FUJIFILM Corp.).

### Comparative Examples 35 to 36

### <Fabrication of Seventh Polarizing Plate>

The seventh polarizing plates of Comparative Examples 35 to 36 were fabricated in the same manner as in Example 50, except that the transparent protective film of Example 1 that was used in Example 50 was replaced with the transparent protective films of Comparative Examples 1 to 2, respectively.

### Comparative Example 37

### <Fabrication of Seventh Polarizing Plate>

The seventh polarizing plate of Comparative Example 37 was fabricated in the same manner as in Example 50, except that the transparent protective film of Example 1 that was used in Example 50 was replaced with a commercial triacetyl cellulose film (Fujitac TFY80UL, manufactured by FUJIFILM Corp.).

### Comparative Examples 38 to 39

### <Fabrication of Seventh Polarizing Plate>

The seventh polarizing plates of Comparative Examples 38 to 39 were fabricated in the same manner as in Example 50, except that the transparent protective film of Example 1 that was used in Example 50 was replaced with the transparent protective film of Example 12, and the protective film CVL-02 was replaced with a commercial triacetyl cellulose film (Fujitac TFY80UL, manufactured by FUJIFILM Corp.).

### Comparative Example 40

### <Fabrication of Seventh Polarizing Plate>

The seventh polarizing plate of Comparative Example 40 was fabricated in the same manner as in Example 50, except that the transparent protective film of Example 1 that was used in Example 50 and the protective film CVL-02 were replaced with a commercial triacetyl cellulose film (Fujitac TFY80UL, manufactured by FUJIFILM Corp.).

### Example 54

### <Fabrication of VA-Mode Liquid Crystal Display Device>

The polarizing plate fabricated in Example 50 was punched to a 26-inch-wide size, so that the absorption axis of the polarizer served as a long side.

The polarizing plate fabricated in Example 52 was punched to a 26-inch-wide size, so that the absorption axis of the polarizer served as a short side.

Front and rear polarizing plates and a phase difference plate disposed in a liquid crystal cell of a VA-mode liquid crystal TV (KDL-L26HVX, manufactured by Sony Corp.) were peeled off, and a liquid crystal display device of Example 54 was fabricated by disposing the polarizing plate fabricated in Example 50 and punched out as described above on the viewing side of the liquid crystal cell and disposing the polarizing plate fabricated in Example 52 and punched out as described above on the backlight side of the liquid crystal cell.

When the polarizing plates were disposed, they were pasted on the liquid crystal cell and then held for 20 min at a temperature of 50° C. under a pressure of 5 kg/cm² to bond the components. In this process, the polarizing plates were disposed so that the absorption axis of the polarizing plate on the viewing side (polarizing plate fabricated in Example 50) was in the horizontal direction of the panel, the absorption axis of the polarizing plate on the backlight side (polarizing plate fabricated in Example 52) was in the direction perpendicular to the panel, and the pressure-sensitive adhesive side was on the liquid crystal cell side.

The viewing angle (range in which the contrast ratio was 20 or more) was calculated for the liquid crystal display device of Example 54 fabricated in the above-described manner from the brightness measurements of black display and white display conducted by using a measurement device (EZ-Contrast 160D, manufactured by ELDIM Co., Ltd.). The viewing angle in the direction of an azimuth of 45 degree is shown, as a result of such calculations, in Table 10.

Similarly to Example 48, the color variation index ΔCu′v′ was also calculated for the liquid crystal display device of Example 54. The results are shown in Table 10.

Similar measurements were also conducted after conditioning the liquid crystal display device of Example 54 for one week at a relative humidity of 60% RH, and then similar measurements were conducted after conditioning for one week at a relative humidity of 10% RH. The results obtained in visually evaluating the variation of display characteristics in response to variations in ambient humidity are shown in Table 11.

### Example 55

### <Fabrication of Liquid Crystal Display Device>

The liquid crystal display device of Example 55 was fabricated in the same manner as in Example 54, except that the polarizing plate of Example 50 that was used in Example 54 was replaced with the polarizing plate of Example 51, and the polarizing plate of Example 52 that was used in Example 54 was replaced with the polarizing plate of Example 53.

Similarly to Example 54, the calculated viewing angle and color variation index ΔCu′v′ and also the variation of display characteristic in response to variations in ambient humidity are shown in Table 10.

### Comparative Example 41

### <Fabrication of VA-Mode Liquid Crystal Display Device>

The liquid crystal display device of Comparative Example 41 was fabricated in the same manner as in Example 54, except that the polarizing plate of Example 50 that was used in Example 54 was replaced with the polarizing plate of Comparative Example 35, and the polarizing plate of Example 52 that was used in Example 54 was replaced with the polarizing plate of Comparative Example 38.

Similarly to Example 54, the calculated viewing angle and color variation index ΔCu′v′ and also the variation of display characteristic in response to variations in ambient humidity are shown in Table 10.

### Comparative Example 42

### <Fabrication of Liquid Crystal Display Device>

The liquid crystal display device of Comparative Example 42 was fabricated in the same manner as in Example 54, except that the polarizing plate of Example 50 that was used in Example 54 was replaced with the polarizing plate of Comparative Example 36, and the polarizing plate of Example 52 that was used in Example 54 was replaced with the polarizing plate of Comparative Example 39.

Similarly to Example 54, the calculated viewing angle and color variation index ΔCu′v′ and also the variation of display characteristic in response to variations in ambient humidity are shown in Table 10.

### Comparative Example 43

### <Fabrication of Liquid Crystal Display Device>

The liquid crystal display device of Comparative Example 43 was fabricated in the same manner as in Example 54, except that the polarizing plate of Example 50 that was used in Example 54 was replaced with the polarizing plate of Comparative Example 37, and the polarizing plate of Example 52 that was used in Example 54 was replaced with the polarizing plate of Comparative Example 40.

Similarly to Example 54, the calculated viewing angle and color variation index ΔCu′v′ and also the variation of display characteristic in response to variations in ambient humidity are shown in Table 10.

As shown in Table 10, the viewing angle characteristic of the liquid crystal display devices of Examples 54 to 55 was improved over that of liquid crystal display devices of Comparative Examples 41 to 43. Further, the variation in color occurring when the viewing angle is tilted from the front in a black display mode was also improved, and the possibility of obtaining a liquid crystal display device with small variation of characteristic in response to variations in ambient humidity was confirmed.

### Example 56

### <Fabrication of Optical Compensation Film AC3>

The surface of the optically anisotropic layer A1 fabricated in Example 44 was subjected to corona discharge treatment with a solid-state corona treatment device 6KVA (manufactured by Pillar Corp.), and an alignment film layer was then formed in the same manner as in Example 50.

The alignment film was rubbed, then the below-described reactive monomer having a chiral structure was added to 41.01 parts by mass of the below-described rod-like liquid crystal molecules, 1.35 parts by mass of photopolymerization initiator (Irgacure 907, manufactured by Chiba Geigy Co., Ltd.), and 0.45 parts by mass of photosensitizer (Kayacure DETX, manufactured by Nippon Kayaku KK) to obtain a selective reflection wavelength of 300 nm, and the coating composition was continuously coated on the alignment film surface of the optically anisotropic layer A1 that was conveyed at a speed of 20 m/min, while rotating the #2 wire bar at 391 rpm in the same direction as the conveying lo direction of the film.

The solvent was dried in the process of continuously heating from room temperature to 70° C., and then heating was performed for about 90 sec in the drying zone with a temperature of 90° C. so that air flow rate at the film surface of the rod-like liquid crystal compound layer was 1.5 m/sec and the flow was parallel to the film conveying direction. As a result, the rod-like liquid crystal compound was provided with choleric alignment.

The film was then conveyed into a drying zone with a temperature of 80° C. and irradiated for 4 sec with ultraviolet radiation at an illumination intensity of 600 mW with an ultraviolet radiation irradiation device (ultraviolet radiation lamp: output 160 W/cm, emission length 1.6 m) in a state in which the surface temperature of the film was about 80° C., thereby enhancing the crosslinking reaction and fixing the alignment of the rod-like liquid crystal compound.

The film was then naturally cooled to room temperature and coiled into a cylindrical shape to obtain a roll-like form, thereby producing an optical compensation film AC3 including the optically anisotropic layer A1 and optically anisotropic layer C3.

An optically anisotropic layer C3G composed of the rod-like liquid crystal compound was fabricated by forming the alignment film and the optically anisotropic layer C3 on the separately prepared glass substrate, instead of the optically anisotropic layer A1 subjected to corona treatment, and Re₄₅₀, Re₅₉₀, Re₆₅₀, Rth₄₅₀, Rth₅₉₀, Rth₆₅₀ of the optically anisotropic layer C3G were measured. The results are shown in Table 8.

### Rod-like Liquid Crystal Compound

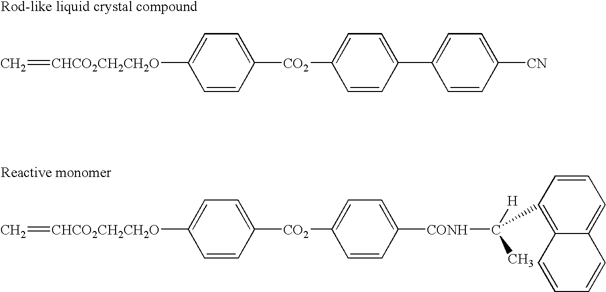

### <Fabrication of Eighth Polarizing Plate>

The eighth polarizing plate of Example 56 was fabricated in the same manner as in Example 44, except that AC1 was replaced with AC2 in the optical compensation film of Example 44. An acrylic pressure-sensitive adhesive was then also coated on the optical compensation film AC3 on the side of the optically anisotropic layer C3. Because the polarizer and the protective films for both sides of the polarizer have been fabricated in the form of rolls, the lengthwise directions of the rolled films were parallel to each other and the pasting was conducted in a continuous mode. The slow axis of the optically anisotropic layer A1 and the transmission axis of the polarizer were parallel to each other.

### Example 57

### <Fabrication of Eighth Polarizing Plate>

The eighth polarizing plate of Example 57 was fabricated in the same manner as in Example 56, except that the transparent protective film of Example 1 that was used in Example 56 was replaced with the transparent protective film of Example 12.

### Example 58

### <Fabrication of Eighth Polarizing Plate>

The eighth polarizing plate of Example 58 was fabricated in the same manner as in Example 56, except that the protective film CVL-02 used in Example 56 was replaced with a commercial triacetyl cellulose film (Fujitac TFY80UL, manufactured by FUJIFILM Corp.).

### Example 59

### <Fabrication of Eighth Polarizing Plate>

The eighth polarizing plate of Example 59 was fabricated in the same manner as in Example 56, except that the transparent protective film of Example 1 that was used in Example 56 was replaced with the transparent protective film of Example 12, and the protective film CVL-02 was replaced with a commercial triacetyl cellulose film (Fujitac TFY80UL, manufactured by FUJIFILM Corp.).

### Comparative Examples 44 to 45

### <Fabrication of Eighth Polarizing Plate>

The eighth polarizing plates of Comparative Examples 44 to 45 were fabricated in the same manner as in Example 56, except that the transparent protective film of Example 1 that was used in Example 56 was replaced with the transparent protective films of Comparative Examples 1 to 2, respectively.

### Comparative Example 46

### <Fabrication of Eighth Polarizing Plate>

The eighth polarizing plate of Comparative Example 46 was fabricated in the same manner as in Example 56, except that the transparent protective film of Example 1 that was used in Example 56 was replaced with a commercial triacetyl cellulose film (Fujitac TFY80UL, manufactured by FUJIFILM Corp.).

### Comparative Examples 47 to 48

### <Fabrication of Eighth Polarizing Plate>

The eighth polarizing plates of Comparative Examples 47 to 48 were fabricated in the same manner as in Example 56, except that the transparent protective film of Example 1 that was used in Example 56 was replaced with the transparent protective film of Example 12, and the protective film CVL-02 was replaced with a commercial triacetyl cellulose film (Fujitac TFY80UL, manufactured by FUJIFILM Corp.).

### Comparative Example 49

### <Fabrication of Eighth Polarizing Plate>

The eighth polarizing plate of Comparative Example 49 was fabricated in the same manner as in Example 56, except that the transparent protective film of Example 1 that was used in Example 56 and the protective film CVL-02 were replaced with a commercial triacetyl cellulose film (Fujitac TFY80UL, manufactured by FUJIFILM Corp.).

### Example 60

### <Fabrication of VA-Mode Liquid Crystal Display Device>

The polarizing plate fabricated in Example 56 was punched to a 26-inch-wide size, so that the absorption axis of the polarizer served as a long side.

The polarizing plate fabricated in Example 58 was punched to a 26-inch-wide size, so that the absorption axis of the polarizer served as a short side.

Front and rear polarizing plates and a phase difference plate disposed in a liquid crystal cell of a VA-mode liquid crystal TV (KDL-L26HVX, manufactured by Sony Corp.) were peeled off, and a liquid crystal display device of Example 60 was fabricated by disposing the polarizing plate fabricated in Example 56 and punched out as described above on the viewing side of the liquid crystal cell and disposing the polarizing plate fabricated in Example 58 and punched out as described above on the backlight side of the liquid crystal cell.

When the polarizing plates were disposed, they were pasted on the liquid crystal cell and then held for 20 min at a temperature of 50° C. under a pressure of 5 kg/cm² to bond the components. In this process, the polarizing plates were disposed so that the absorption axis of the polarizing plate on the viewing side (polarizing plate fabricated in Example 56) was in the horizontal direction of the panel, the absorption axis of the polarizing plate on the backlight side (polarizing plate fabricated in Example 58) was in the direction perpendicular to the panel, and the pressure-sensitive adhesive side was on the liquid crystal cell side.

The viewing angle (range in which the contrast ratio is 20 or more) was calculated for the liquid crystal display device of Example 60 fabricated in the above-described manner from the brightness measurements of black display and white display conducted by using a measurement device (EZ-Contrast 160D, manufactured by ELDIM Co., Ltd.). The viewing angle in the direction of an azimuth of 45 degree is shown, as a result of such calculations, in Table 11.

Similarly to Example 48, the color variation index ΔCu′v′ was also calculated for the liquid crystal display device of Example 60. The results are shown in Table 11.

Similar measurements were also conducted after conditioning the liquid crystal display device of Example 60 for one week at a relative humidity of 60% RH, and then similar measurements were conducted after conditioning for one week at a relative humidity of 10% RH. The results obtained in visually evaluating the variation of display characteristics in response to variations in ambient humidity are shown in Table 11.

### Example 61

### <Fabrication of Liquid Crystal Display Device>

The liquid crystal display device of Example 61 was fabricated in the same manner as in Example 60, except that the polarizing plate of Example 56 that was used in Example 60 was replaced with the polarizing plate of Example 57, and the polarizing plate of Example 58 that was used in Example 60 was replaced with the polarizing plate of Example 59.

Similarly to Example 60, the calculated viewing angle and color variation index ΔCu′v′ and also the variation of display characteristic in response to variations in ambient humidity are shown in Table 11.

### Comparative Example 50

### <Fabrication of VA-Mode Liquid Crystal Display Device>

The liquid crystal display device of Comparative Example 50 was fabricated in the same manner as in Example 60, except that the polarizing plate of Example 56 that was used in Example 60 was replaced with the polarizing plate of Comparative Example 44, and the polarizing plate of Example 58 that lo was used in Example 60 was replaced with the polarizing plate of Comparative Example 47.

Similarly to Example 60, the calculated viewing angle and color variation index ΔCu′v′ and also the variation of display characteristic in response to variations in ambient humidity are shown in Table 11.

### Comparative Example 51

### <Fabrication of VA-Mode Liquid Crystal Display Device>

The liquid crystal display device of Comparative Example 51 was fabricated in the same manner as in Example 60, except that the polarizing plate of Example 56 that was used in Example 60 was replaced with the polarizing plate of Comparative Example 45, and the polarizing plate of Example 58 that was used in Example 60 was replaced with the polarizing plate of Comparative Example 48.

Similarly to Example 60, the calculated viewing angle and color variation index ΔCu′v′ and also the variation of display characteristic in response to variations in ambient humidity are shown in Table 11.

### Comparative Example 52

### <Fabrication of VA-Mode Liquid Crystal Display Device>

The liquid crystal display device of Comparative Example 52 was fabricated in the same manner as in Example 60, except that the polarizing plate of Example 56 that was used in Example 60 was replaced with the polarizing plate of Comparative Example 46, and the polarizing plate of Example 58 that was used in Example 60 was replaced with the polarizing plate of Comparative Example 49.

Similarly to Example 60, the calculated viewing angle and color variation index ΔCu′v′ and also the variation of display characteristic in response to variations in ambient humidity are shown in Table 11.

As shown in Table 11, the viewing angle characteristic of the liquid crystal display devices of Examples 60 to 61 was improved over that of liquid crystal display devices of Comparative Examples 50 to 52. Further, the variation in color occurring when the viewing angle is tilted from the front in a black display mode was also improved, and the possibility of obtaining a liquid crystal display device with small variation of characteristic in response to variations in ambient humidity was confirmed.

TABLE 8

| Optically | | Average | | | | | | | | |
|---|---|---|---|---|---|---|---|---|---|---|
| anisotropic | Thickness | refractive | Re590 | Rth590 | Re450 | Re650 | Rth450 | Rth650 | Re650 − Re450 | Rth650 − Rth450 |
| layer | (μm) | index | (nm) | (nm) | (nm) | (nm) | (nm) | (nm) | (nm) | (nm) |
| A1 | 83 | 1.6 | 90.0 | 50.0 | 74.0 | 95.4 | 41.1 | 53.0 | 21.4 | 11.9 |
| C1 | 1.8 | 1.58 | 0.1 | 70.0 | 0.1 | 0.1 | 77.0 | 65.8 | 0.0 | −11.2 |
| C2 | 1.3 | 1.6 | 0.1 | 70.0 | 0.1 | 0.1 | 84.0 | 63.0 | 0.0 | −21.0 |
| C3 | 1.3 | 1.58 | 0.1 | 70.0 | 0.1 | 0.1 | 84.0 | 63.0 | 0.0 | −21.0 |
| Fujitac | 80 | 1.648 | 2.0 | 49.0 | 1.0 | 2.2 | 39.0 | 62.0 | 1.2 | 13.0 |
| TFY80UL | | | | | | | | | | |

TABLE 9

| Liquid crystal display | | | Variation caused |
|---|---|---|---|
| device | Viewing angle | Δcu‘v’ | by humidity |
| Example 48 | >80° | 0.02 | Small |
| Example 49 | >80° | 0.02 | Small |
| Comparative Example | >80° | 0.02 | Large |
| 32 | | | |
| Comparative Example | >80° | 0.02 | Large |
| 33 | | | |
| Comparative Example | 50° | 0.08 | Large |
| 34 | | | |

TABLE 10

| Liquid crystal display | | | Variation caused |
|---|---|---|---|
| device | Viewing angle | Δcu‘v’ | by humidity |
| Example 54 | >80° | 0.04 | Small |
| Example 55 | >80° | 0.04 | Small |
| Comparative Example | >80° | 0.02 | Large |
| 41 | | | |
| Comparative Example | >80° | 0.02 | Large |
| 42 | | | |
| Comparative Example | 50° | 0.08 | Large |
| 43 | | | |

TABLE 11

| Liquid crystal display | | | Variation caused |
|---|---|---|---|
| device | Viewing angle | Δcu‘v’ | by humidity |
| Example 60 | >80° | 0.02 | Small |
| Example 61 | >80° | 0.02 | Small |
| Comparative Example | >80° | 0.02 | Large |
| 50 | | | |
| Comparative Example | >80° | 0.02 | Large |
| 51 | | | |
| Comparative Example | 50° | 0.08 | Large |
| 52 | | | |

As described hereinabove, in accordance with the present invention, it is possible to fabricate a transparent protective film with small optical anisotropy and small wavelength dispersion of Re and Rth and, at the same time, to reduce sufficiently the variation of Re and Rth with respect to variations in ambient humidity. By using this transparent protective film, it is possible to provide optical materials such as optical compensation films and polarizing plates that excel in viewing angle characteristic and to reduce sufficiently the variation of properties of liquid crystal display devices using such optical materials in response to variations in ambient humidity in optical materials.

In accordance with the present invention, it is possible to manufacture a transparent protective film and an optical compensation film that are optically isotropic optical transparent films in which the front Re of the transparent protective film is almost zero, the angular variations of retardation are small, that is, Rth is also almost zero, these films demonstrating excellent effect in inhibiting the variation of Re and Rth in response to variations in ambient humidity. Therefore, such films can be advantageously used in a polarizing plate for a liquid crystal display device, in particular, can be advantageously used in the liquid crystal display devices of various modes of the present invention.

In the liquid crystal display device in accordance with the present invention, the liquid crystal cell can be optically compensated, contrast can be improved, and color shift depending on viewing angle can be reduced, and the liquid crystal display device can be advantageously used in cellular phones, monitors for personal computers, television sets, liquid crystal projectors, and the like.

What is claimed is:

1. A transparent protective film that satisfies the following Formulas (I) to (III) at a relative humidity of 60% RH:
0≦Re₍₆₃₀₎≦10 Formula (I)

|Rth₍₆₃₀₎|≦20 Formula (II)
ΔRth/d×80,000≦20 Formula (III).
where Re(λ) is a front retardation value (units: nm) at a wavelength λ nm that is defined as Re(λ) (nx−ny)×d; Rth(λ) is a thickness-direction retardation value (units: nm) at a wavelength λ nm that is defined as Rth(λ)={(nx+ny)/2−nz}×d; nx is a refractive index in a slow axis direction within a film plane; ny is a refractive index in a fast axis direction within the film plane; nz is a refractive index in the thickness direction of the film; d is the film thickness (units: nm); and ΔRth is a value obtained by subtracting Rth at a wavelength of 550 nm that is measured by controlling humidity for 24 h at a relative humidity of 80% from Rth at a wavelength of 550 nm that is measured by controlling humidity for 24 h at a relative humidity of 10%.

2. The transparent protective film according to claim 1, wherein the transparent protective film satisfies the following Formula (IV):
ΔRth/d×80,000≦8 tm Formula (IV).

3. The transparent protective film according to claim 1, wherein the transparent protective film comprises a compound A containing, in a molecule, at least a plurality of functional groups selected from a hydroxyl group, amino group, thiol group, and carboxyl group.

4. The transparent protective film according to claim 3, wherein the compound A contains a plurality of different functional groups in a molecule.

5. The transparent protective film according to claim 3, wherein the compound A comprises one or two aromatic rings as a mother nucleus.

6. The transparent protective film according to claim 3, wherein the compound A contains a functional group selected from a hydroxyl group, amino group, thiol group, and carboxyl group, and wherein a value obtained by multiplying by 1,000 a value obtained by dividing the number of the functional groups contained in a molecule by a molecular weight of the compound A is equal to or more than 10.

7. The transparent protective film according to claim 3, wherein the compound A comprises two aromatic rings, contains one or less hydroxyl group in one of the aromatic rings and contains three or less carboxyl groups in the other aromatic ring, the sum total of the hydroxyl group and the carboxyl groups being 2 to 6.

8. The transparent protective film according to claim 7, wherein the two aromatic rings are joined by any of the structures represented by the following General Formulas (I) to (VII): 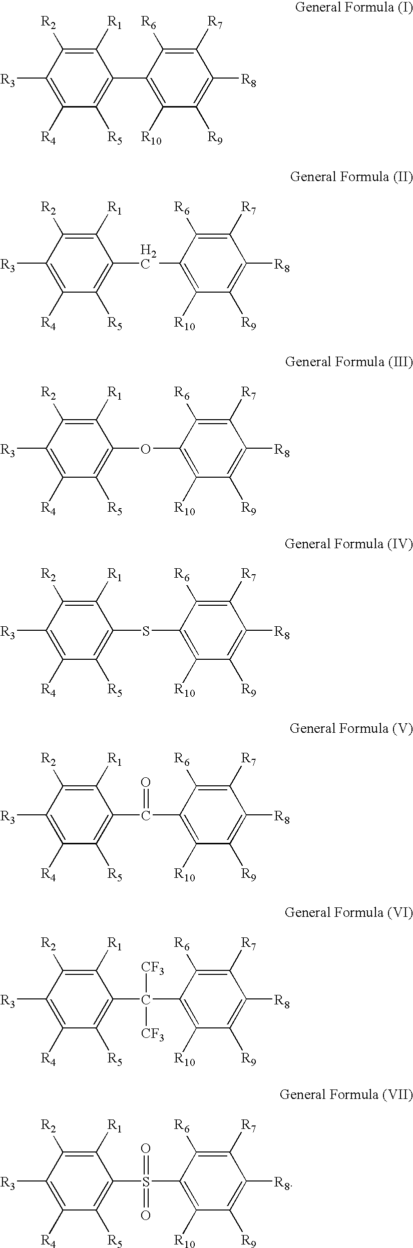
where R₁ to R₆ represent any of a hydrogen atom, alkyl group excluding an aromatic ring, hydroxyl group, amino group, thiol group, and carboxyl group.

9. The transparent protective film according to claim 3, wherein the compound A has a molecular weight of 180 or more to 500 or less.

10. The transparent protective film according to claim 1, wherein the transparent protective film is cellulose triacetate with a degree of substitution of acetyl groups in cellulose acylate resin of 2.0 to 3.0.

11. The transparent protective film according to claim 1, wherein the transparent protective film comprises a polymer obtained by polymerization of an ethylenic unsaturated monomer with a weight-average molecular weight of 500 or more to less than 10,000.

12. The transparent protective film according to claim 1, wherein the transparent protective film comprises at least one compound that reduces Re(λ) and Rth(λ) and has an octanol-water partition coefficient (value of LogP) of 0 to 7, the compound being contained at a level of 0.01 wt.% to 30 wt.% based on a cellulose acylate solid fraction.

13. An optical compensation film comprising:
a transparent support body; and
an optically anisotropic layer containing a disk-like compound subjected to hybrid alignment, the optically anisotropic layer being laminated on at least one surface of the transparent support body,
wherein the transparent support body is a transparent protective film that satisfies the following Formulas (I) to (III) at a relative humidity of 60% RH:
0≦Re₍₆₃₀₎≦10 Formula (I)

|Rth₍₆₃₀₎|≦20 Formula (II)
ΔRth/d×80,000≦20 Formula (III).
where Re(λ) is a front retardation value (units: nm) at a wavelength λ nm that is defined as Re(λ)=(nx−ny)×d; Rth(λ) is a thickness-direction retardation value (units: nm) at a wavelength λ nm that is defined as Rth(λ)={(nx+ny)/2−nz}×d; nx is a refractive index in a slow axis direction within a film plane; ny is a refractive index in a fast axis direction within the film plane; nz is a refractive index in the thickness direction of the film; d is the film thickness (units: nm); and ΔRth is a value obtained by subtracting Rth at a wavelength of 550 nm that is measured by controlling humidity for 24 h at a relative humidity of 80% from Rth at a wavelength of 550 nm that is measured by controlling humidity for 24 h at a relative humidity of 10%.

14. A polarizing plate comprising:
a polarizer; and
at least one of a transparent protective film and an optical compensation film, the optical compensation film having a transparent support body and an optically anisotropic layer containing a disk-like compound subjected to hybrid alignment, the optical compensation film being laminated on at least one surface of the transparent support body,
wherein the transparent protective film and the transparent support body satisfy the following Formulas (I) to (III) at a relative humidity of 60% RH:
0≦Re₍₆₃₀₎≦10 Formula (I)

|Rth₍₆₃₀₎|≦20 Formula (II)
ΔRth/d×80,000≦20 Formula (III).
where Re(λ) is a front retardation value (units: nm) at a wavelength λ nm that is defined as Re(λ)=(nx−ny) x d; Rth(λ) is a thickness-direction retardation value (units: nm) at a wavelength λ nm that is defined as Rth(λ)={(nx+ny)/2−nz}×d; nx is a refractive index in a slow axis direction within a film plane; ny is a refractive index in a fast axis direction within the film plane; nz is a refractive index in the thickness direction of the film; d is the film thickness (units: nm); and ΔRth is a value obtained by subtracting Rth at a wavelength of 550 nm that is measured by controlling humidity for 24 h at a relative humidity of 80% from Rth at a wavelength of 550 nm that is measured by controlling humidity for 24 h at a relative humidity of 10%.

15. A liquid crystal display device comprising:
a liquid crystal cell; and
a polarizing plate disposed on at least one surface of the liquid crystal cell,
wherein the polarizing plate comprises a polarizer and at least one of a transparent protective film and an optical compensation film, the optical compensation film having a transparent support body and an optically anisotropic layer containing a disk-like compound subjected to hybrid alignment, the optical compensation film being laminated on at least one surface of the transparent support body, and
wherein the transparent protective film and the transparent support body satisfy the following Formulas (I) to (III) at a relative humidity of 60% RH:
0≦Re₍₆₃₀₎≦10 Formula (I)

|Rth₍₆₃₀₎|≦20 Formula (II)
ΔRth/d×80,000≦20 Formula (III).
where Re(λ) is a front retardation value (units: nm) at a wavelength λ nm that is defined as Re(λ)=(nx−ny)×d; Rth(λ) is a thickness-direction retardation value (units: nm) at a wavelength λ nm that is defined as Rth(λ)={(nx+ny)/2−nz}×d; nx is a refractive index in a slow axis direction within a film plane; ny is a refractive index in a fast axis direction within the film plane; nz is a refractive index in the thickness direction of the film; d is the film thickness (units: nm); and ΔRth is a value obtained by subtracting Rth at a wavelength of 550 nm that is measured by controlling humidity for 24 h at a relative humidity of 80% from Rth at a wavelength of 550 nm that is measured by controlling humidity for 24 h at a relative humidity of 10%.

16. The liquid crystal display device according to claim 15, wherein the liquid crystal cell is a liquid crystal cell that adopts any of TN mode, OCB mode, ECB mode, VA mode, and IPS mode.
